(19) United States
(12) Patent Application Publication
(10) Pub. No.: US 2025/0210723 A1
(43) Pub. Date: Jun. 26, 2025

(54) Nickel-Hydrogen Battery Configurations for Grid-Scale Energy Storage

(71) Applicant: EnerVenue Holdings, Ltd., Fremont, CA (US)

(72) Inventors: Ge Zu, San Jose, CA (US); Jun Li, San Jose, CA (US); Wang Xiao, Fremont, CA (US); Nelson Dichter, Fremont, CA (US); Jason Trafas, Fremont, CA (US); John P. Carroll, Fremont, CA (US); Stephen Rivest, Fremont, CA (US); James T. Krill, Fremont, CA (US); Maya Venkat, Fremont, CA (US); Esteban Johnson, Fremont, CA (US); Majid Keshavarz, Fremont, CA (US)

(21) Appl. No.: 18/987,378

(22) Filed: Dec. 19, 2024

Related U.S. Application Data
(60) Provisional application No. 63/614,260, filed on Dec. 22, 2023.
(60) Provisional application No. 63/658,165, filed on Jun. 10, 2024.

(51) Int. Cl. H01M 10/28; H01M 10/34; H01M 50/107; H01M 50/342; H01M 50/46; H01M 50/474; H01M 50/486; H01M 50/533; H01M 50/636

(52) U.S. Cl. CPC H01M 10/281; H01M 10/288; H01M 10/34; H01M 50/107; H01M 50/3425; H01M 50/46; H01M 50/474; H01M 50/486; H01M 50/533; H01M 50/636; H01M 2220/10

(57) ABSTRACT

A metal-hydrogen battery is presented. The battery includes a bridgeless CPV superstack having a number K of units, each unit including a first layer and a second layer, wherein the first layer includes a number L/2 of intermediate anode-cathodes, and wherein the second layer includes an end anode and an end cathode separated by L/2−1 intermediate anode-cathodes; a pressure vessel that encloses the bridgeless CPV superstack; and electrolyte within the pressure vessel. A bridgeless CPV superstack includes K units, each unit including a first layer and a second layer, wherein the first layer includes a number L/2 of intermediate anode-cathodes, and wherein the second layer includes an end anode and an end cathode separated by L/2−1 intermediate anode-cathode.

### RELATED APPLICATIONS

This application claims priority to U.S. Provisional Application 63/614,260, entitled “Nickel-Hydrogen Battery Configurations for Grid-Scale Energy Storage,” filed on Dec. 22, 2023, and to U.S. Provisional Application 63/658,165, entitled “Nickel-Hydrogen Battery Configurations for Grid-Scale Energy Storage,” filed on Jun. 10, 2024, each of which is herein incorporated by reference in their entirety.

### TECHNICAL FIELD

This disclosure is generally related to metal-hydrogen batteries, and more particularly to a Common Pressure Vessel (CPV) configuration for metal-hydrogen batteries for grid-scale energy storage.

### BACKGROUND

For renewable energy resources such as wind and solar to be competitive with traditional fossil fuels, large-scale energy storage systems are needed to mitigate their intrinsic intermittency. To build large-scale energy storage, the cost and long-term lifetime are the utmost considerations. Currently, pumped-hydroelectric storage dominates the grid energy storage market because it is an inexpensive way to store large quantities of energy over a long period of time (about 50 years), but it is constrained by the lack of suitable sites and the environmental footprint. Other technologies such as compressed air and flywheel energy storage show some different advantages, but their relatively low efficiency and high cost should be significantly improved for grid-scale storage. Rechargeable batteries offer great opportunities to target low-cost, high-capacity and highly reliable systems for large-scale energy storage. Improving the reliability of rechargeable batteries and reducing cost of those batteries has become an important issue to realize large-scale energy storage.

One of the large contributors to the cost of producing metal-hydrogen batteries is the cost of the vessel that houses the battery and the additional costs of the connectors used in the battery stacks. Consequently, there is an interest in providing vessel and battery configurations with fewer parts that decrease the overall costs and simplifies the manufacturing of metal-hydrogen batteries.

### SUMMARY

In accordance with some embodiments of this disclosure, a metal-hydrogen battery is presented. The metal-hydrogen battery includes a bridgeless CPV superstack having a number K of units, each unit including a first layer and a second layer, wherein the first layer includes a number L/2 of intermediate anode-cathodes, and wherein the second layer includes an end anode and an end cathode separated by L/2−1 intermediate anode-cathodes; a pressure vessel that encloses the bridgeless CPV superstack; and electrolyte within the pressure vessel.

In some embodiments, each of the end anodes includes one or more layers of anode material that is connected with anode tabs. In some embodiments, each of the end cathodes includes one or more layers of cathode material connected with cathode tabs and a separator material encasing the cathode material, with the separator material including wall wicks. In some embodiments, each of the intermediate anode-cathodes includes an anode with one or more layers of anode material connected to one or more layers of cathode material by a metal sheet; and a separator material encasing the cathode material, with the separator material including wall wicks. In some embodiments, the bridgeless CPV superstack further includes a first cell plate and a second cell plate, the first cell plate and the second cell plate on either side of the K units and connected by arms. In some embodiments, the K units are compressed prior to connecting the first cell plate and the second cell plate with the arms. In some embodiments, the end anodes include anode tabs and end cathodes includes cathode tabs, and further including an anode end bridge engaged with the anode tabs of each of the K units and a cathode end bridge engaged with the cathode tabs of each of the K units. In some embodiments, each of the anode end bridge and the cathode end bridge includes a feedthrough conductor that extends through the pressure vessel.

Further, a method of providing a battery is presented in this disclosure. In some embodiments, the method includes forming a bridgeless CPV superstack of K units by alternately stacking K first layers and K second layers each separated by a separator, wherein each first layer includes L/2 anode-cathode pairs and each second layer includes L/2−1 anode-cathode pairs, an end anode and an end cathode; enclosing the bridgeless CPV superstack into pressure vessel; and adding electrolyte into the pressure vessel.

In some embodiments, the method further includes forming K end anodes, wherein each of the end anodes includes one or more layers of anode material connected with anode tabs. In some embodiments, the method further includes forming K end cathodes, wherein each of the end cathodes includes one or more layers of cathode material connected with cathode tabs and wherein a separator material encases the cathode material, with the separator material including wall wicks. In some embodiments, the method further includes forming K*(L−1) intermediate anode-cathodes, wherein each of the intermediate anode-cathodes includes an anode with one or more layers of anode material connected to a one or more layers of cathode material by a metal sheet; and wherein a separator material encases the cathode material, with the separator material including wall wicks. In some embodiments, forming the stack of K units includes providing a first cell plate on which the K first layers and the K second layers are stacked; and providing a second cell plate over the K first layers and the K second layers. In some embodiments, forming the stack of K units includes compressing between the first cell plate and the second cell plate; and connecting the first cell plate and the second cell plate with arms extending between the first cell plate and the second cell plate. In some embodiments, the K end anodes each includes an anode tab and the K end cathodes each includes a cathode tab, and further includes engaging an anode end bridge with the anode tabs of each of the K units; and engaging a cathode end bridge with the cathode tabs of each of the K units. In some embodiments, each of the anode end bridge and the cathode end bridge includes a feedthrough conductor that extends through the pressure vessel.

Additionally, a bridgeless CPV superstack is presented. The bridgeless CPV superstack includes K units, each unit including a first layer and a second layer, wherein the first layer includes a number L/2 of intermediate anode-cathodes, and wherein the second layer includes an end anode and an end cathode separated by L/2−1 intermediate anode-cathode.

In some embodiments, the bridgeless CPV superstack includes a first cell plate and a second cell plate separated by the K units. In some embodiments, the bridgeless CPV superstack includes liners between the first cell plate and the K units and between the second cell plate and the K units. In some embodiments, the end anodes and the end cathodes each include tabs and further including a cathode end bridge coupled through tabs of the end cathodes and an anode end bridge coupled through tabs of the end anodes.

Furthermore, a method of forming a bridgeless CPV superstack is included. In some embodiments, the method includes stacking K units, each unit including a first layer and a second layer, wherein the first layer includes a number L/2 of intermediate anode-cathodes, and wherein the second layer includes an end anode and an end cathode separated by L/2−1 intermediate anode-cathode.

In some embodiments, stacking K units includes stacking the K units between a first cell plate and a second cell plate. In some embodiments, the method further includes providing liners between the first cell plate and the K units and between the second cell plate and the K units. In some embodiments, wherein the end anodes and the end cathodes each include tabs and the method further includes connecting a cathode end bridge through tabs of the end cathodes and connecting an anode end bridge through tabs of the end anodes.

In some embodiments, a metal-hydrogen battery that includes an assembled cell train, the assembled cell train including an overmolded cell tray; a superstack having a number K of units, each unit including a first layer and a second layer, wherein the first layer includes a number L/2 of intermediate anode-cathodes, and wherein the second layer includes an end anode and an end cathode separated by L/2−1 intermediate anode-cathodes, and wherein each end cathode includes a cathode tab and each end anode includes an anode tab, the superstack being assembled on the overmolded cell tray; overmolded end plates separated by an overmolded cell plate being positioned over the superstack; and cell arms connecting the overmolded cell tray and the overmolded end plates and overmolded cell plate to compress the superstack; and a first bridge connected to all of the cathode tabs and a second bridge connected to all of the anode tabs.

In some embodiments, a separator is inserted between the end cathode and the anode of the intermediate anode-cathodes and between cathode material in the intermediate anode-cathodes and anode material. In some embodiments, a first layer of separators is provided between the overmolded cell tray and the superstack and a second layer of separators is provided between the superstack and the overmolded end plates and overmolded cell plate. In some embodiments, one or both of the first bridge and the second bridge includes a spring section to provide strain relief. In some embodiments, the first bridge includes a burst pressure release feedthrough. In some embodiments, the second bridge includes a fill feedthrough that allows for an annular fill.

In some embodiments, the battery includes a liner into which the assembled cell train is inserted. In some embodiments, the liner is a tube that is formed of a material having a layer of Ethyl Vinyl Alcohol (EVOH) sandwiched between polymer layers of) that impedes the transport of hydrogen. In some embodiments, the battery further includes caps on each side of the assembled cell train, wherein the caps and the assembled cell train are laser welded to the liner.

The battery further includes an electrolyte that is applied through the annular fill. In some embodiments, a feedthrough fill sleeve is applied over the fill feedthrough. In some embodiments, insulating rings are further applied over feedthroughs. In some embodiments, the battery includes a wrap around the liner and the caps.

A method of producing a battery according to some embodiments of the present disclosure includes assembling components, the components including end anodes, end cathodes, intermediate anode-cathodes, overmolded cell tray, overmolded end plates, and overmolded cell plates; assembling a cell train, the cell train being formed by stacking the end anodes, the end cathodes, and the intermediate anode-cathodes on the overmolded cell tray to form a superstack having a number K of units, each unit including a first layer and a second layer, wherein the first layer includes a number L/2 of intermediate anode-cathodes, and wherein the second layer includes an end anode and an end cathode separated by L/2-1 intermediate anode-cathodes, and wherein each end cathode includes a cathode tab and each end anode includes an anode tab, the superstack being assembled on the overmolded cell tray, and placing overmolded end plates separated by an overmolded cell plate over the superstack; compressing the cell train and securing the overmolded cell tray to the overmolded end plates and overmolded cell plate with cell arms; applying a top brace to the cell train; applying bridges to the cell train to form an assembled cell train; inserting the assembled cell train with caps into a liner; welding the caps and the assembled cell train to the liner; wrapping the liner and the assembled cell train; charging with electrolyte through an annular fill; adding a feedthrough fill sleeve; crimping feedthroughs on each of the bridges; and adding a feedthrough insulating ring.

Other embodiments are contemplated and explained herein after.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIGS. 1A, 1B, 1C, 1D, and 1E depict an individual pressure vessel (IPV) that has been previously disclosed.

FIGS. 2A and 2B illustrate a bridgeless CPV superstack according to embodiments of the present disclosure.

FIGS. 3A, 3B, 3C, and 3D illustrate components of the bridgeless CPV superstack illustrated in FIG. 2A.

FIGS. 4A and 4B illustrate a first example of cell plates and cell plate structures of a bridgeless CPV superstack according to some embodiments of the present disclosure.

FIG. 5 illustrates assembly of the components, using the cell plates illustrated in FIG. 4, of the bridgeless CPV superstack according to some embodiments of the present disclosure.

FIGS. 6A, 6B, 6C, and 6D illustrate various steps in constructing a bridgeless CPV superstack according to some embodiments of the present disclosure.

FIG. 7 illustrates a process for constructing a bridgeless CPV superstack according to some embodiments of the present disclosure.

FIGS. 8A, 8B, 8C, 8D, and 8E illustrate performance of a first example battery using the bridgeless CPV superstack illustrated in FIGS. 2A through 7.

FIGS. 9A, 9B, 9C, 9D, and 9E illustrate a second example battery using the bridgeless CPV superstack illustrated in FIGS. 2A through 7.

FIGS. 10A, 10B, 10C, 10D, 10E, 10F, and 10G illustrate a third example battery using the bridgeless CPV superstack illustrated in FIGS. 2A through 7.

FIGS. 11A, 11B, 11C, and 11D illustrate a fourth example battery using embodiments of the bridgeless CPV superstack as illustrated in FIGS. 2A through 7.

FIGS. 12A, 12B, 12C, 12D, 12E, and 12F illustrate another example end anode according to some embodiments of the present disclosure.

FIGS. 13A, 13B, 13C, 13D, 13E, 13F, and 13G illustrate another example of an end cathode with a separator pouch according to some embodiments of the present disclosure.

FIGS. 14A, 14B, 14C, 14D, 14E, 14F, 14G, 14H, 14I, 14J, 14K, 14L, 14M, and 14N illustrated another example of an intermediate anode-cathode with a separator pouch on the cathode according to some embodiments of the present disclosure.

FIGS. 15A and 15B illustrate assembly of a superstack using the electrodes illustrated in FIGS. 11A through 14M according to some embodiments of the present disclosure.

FIG. 16 illustrates assembly of a cell train according to some embodiments of the present disclosure.

FIGS. 17A, 17B, 17C, and 17D illustrate an example of a cell plate according to some embodiments of the present disclosure.

FIGS. 18A, 18B, 18C, 18D, 18E, and 18F illustrated an example of an overmolded cell plate according to some embodiments of the present disclosure.

FIGS. 19A, 19B, 19C, 19D, 19E, and 19F illustrated an example of an overmolded end cell plate according to some embodiments of the present disclosure.

FIGS. 20A, 20B, 20C, 20D, 20E, 20F, 20G, 20H, and 20I illustrated an example of an overmolded cell tray according to some embodiments of the present disclosure.

FIGS. 21A, 21B, 21C, 21D, 21E, 21F, and 21G illustrate an embodiment of formation of a cell tray according to some embodiments of the present disclosure.

FIGS. 22A, 22B, 22C, 22D, 22E, and 22F illustrate assembly of a cell train according to some embodiments.

FIGS. 23A, 23B, 23C, 23D, and 23E illustrate assembly of a cell train according to some embodiments of the present disclosure.

FIGS. 24A, 24B, 24C, 24D, 24E, and 24F illustrate a top brace that can be applied to the cell train illustrated in FIGS. 23A through 23E according to some embodiments of the present disclosure.

FIGS. 25A and 25B illustrate examples of bridges that can be applied to the cell train illustrated in FIGS. 23A through 23E according to some embodiments of the present disclosure.

FIGS. 26A, 26B, 26C, 26D, 26E, 26F, 26G, 26H, 26I, 26J, 26K, 26L, and 26M illustrate components and constructions of the example bridge illustrated in FIG. 25A.

FIGS. 27A, 27B, 27C, 27D, 27E, 27F, 27G, 27H, and 27I illustrate components and construction of the example bridge with strain relief as illustrated in FIG. 25B.

FIGS. 28A, 28B, 28C, 28D, 28E, 28F, 28G, 28H, 28I, and 28J illustrate a feedthrough that can be used with the bridges illustrated in FIGS. 25A and 25B and provide overpressure protection according to some embodiments of the present disclosure.

FIGS. 29A, 29B, 29C, 29D, 29E, 29F, 29G, and 29H illustrate a feedthrough that can be used with the bridges illustrated in FIGS. 25A and 25B and provide for annular fill of a pressure vessel according to some embodiments of the present disclosure.

FIGS. 30A, 30B, 30C, 30D, and 30E illustrate assembly of a battery structure using the components as illustrated above with respect to FIGS. 12A through 29H according to some embodiments of the present disclosure.

FIGS. 31A, 31B, 31C, and 31D illustrate an example of a liner according to some embodiments of the present disclosure.

FIGS. 32A and 32B illustrate example of an end cap according to some embodiments of the present disclosure.

FIGS. 33A, 33B, 33C, 33D, 33E, 33F, 33G, and 33H illustrate an example of the overmolded end cap illustrated in FIG. 32B.

FIGS. 34A, 34B, 34C, and 34D illustrate an example of welding the liner to the end caps.

FIGS. 35A, 35B, 35C, and 35D illustrate an example of a feedthrough fill sleeve according to some embodiments of the present disclosure.

FIGS. 36A, 36B, 36C, and 36D illustrate an example of a feedthrough insulating ring according to some embodiments of the present disclosure.

FIG. 37 illustrates a method of assembly according to some embodiments of the present disclosure.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Terms such as “top,” bottom”, “left”, “right”, “over”, “under” or other directional references are relative to the figure and are not intended to be absolute. These references should be interpreted as relative to the figure being discussed and are not intended to be limiting.

Metal-hydrogen batteries can be configured in a number of ways. In each case, the battery itself includes one or more electrode stacks, each with a series of electrodes (alternating layers of cathode material and anode material) separated by electrically isolating separators. The electrode stacks, which are saturated with electrolyte, are housed in one or more pressure vessels. The electrode stacks can provide arrays of cells (i.e., pairs of cathode and anode electrodes) that can be electrically coupled in series or in parallel. Each electrode stack can be arranged such that the cells formed in the array of electrodes are coupled in parallel. In accordance with embodiments of the present disclosure, an electrode stack that is formed by a stacked arrangement of serially coupled components, housed in a common pressure vessel (CPV), is presented.

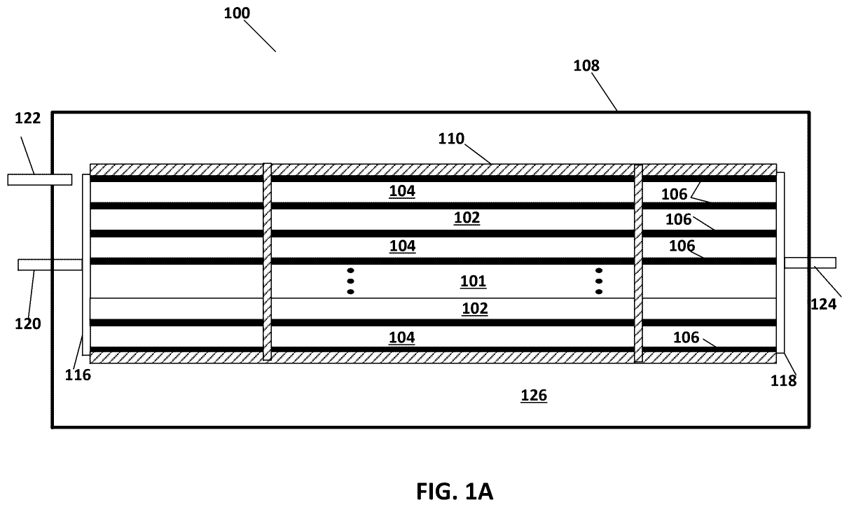

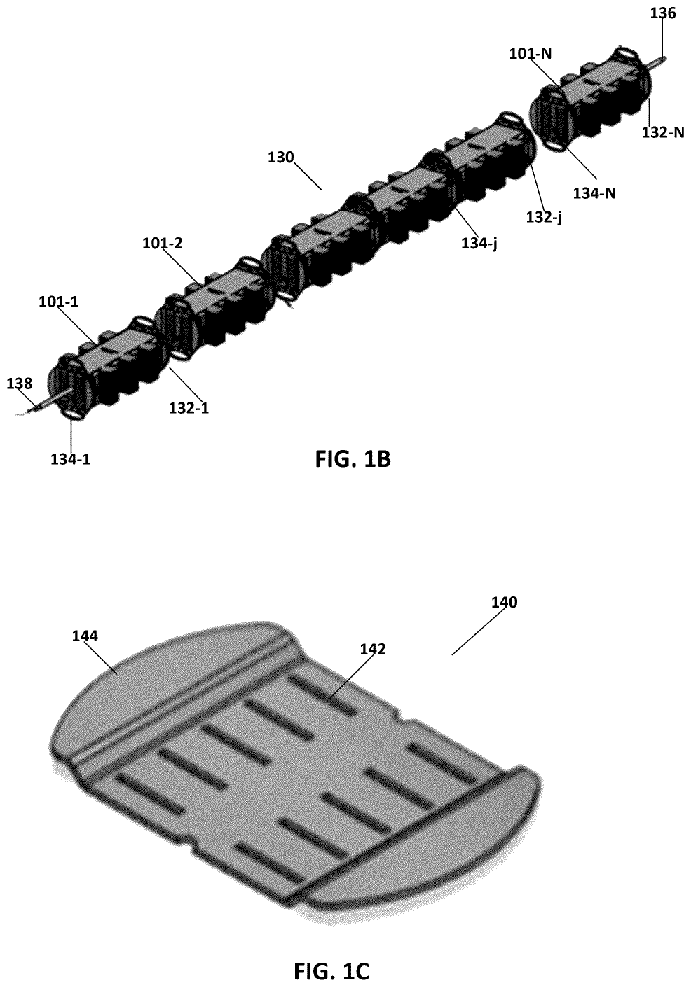

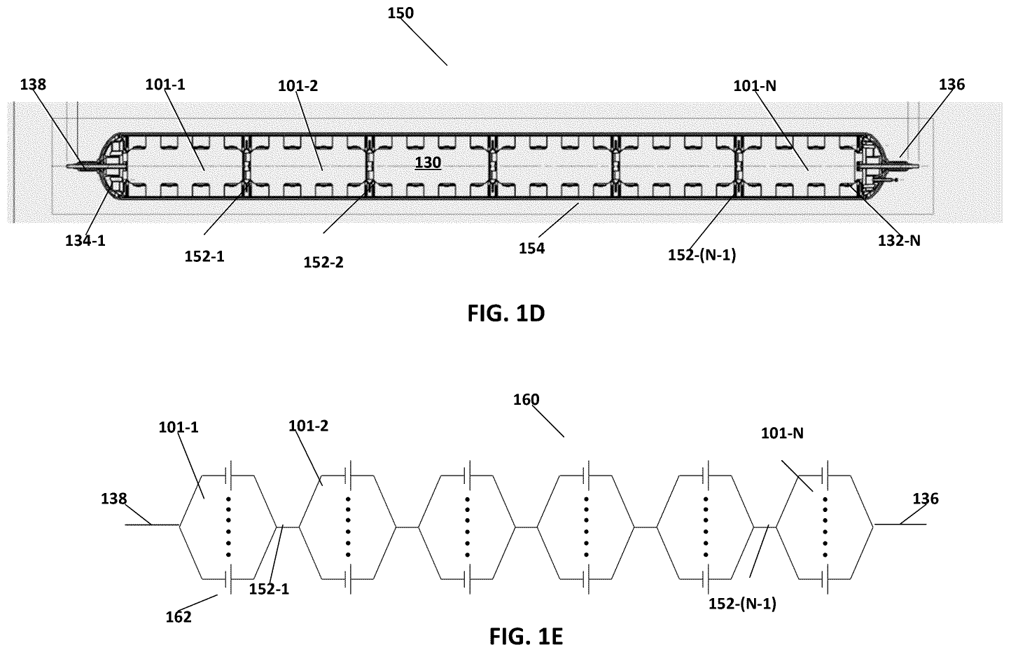

A common pressure vessel (CPV) as described here is a large format battery, where multiple electrode stacks connected in series or parallel, or both, are enclosed in a common pressure vessel. Compared to an individual pressure vessel (IPV) as illustrated in FIG. 1A, or collection of IPVs with the same energy capacity, a CPV has fewer parts (end caps, feedthroughs, fill ports, busbars, wires, BMS etc.), fewer welds and exhibits lower weight and cost. Although, series coupling the stacks illustrated in FIG. 1A below with inter-stack bridge connections can be used in a battery, embodiments of the present disclosure provide a more efficient arrangement. The CPV according to embodiments of the present disclosure includes a stack that is formed of a combination of series and parallel oriented anode/cathode combinations that eliminates the needs for inter-stack bridge connections, which further reduces the weight and the materials used in producing the battery, simplifying super stack production and enhancing the performance at the same time.

FIGS. 1A through 1D illustrate a configuration of an IPV and previous CPV, which is based on IPV, that as has been previously presented in U.S. patent application Ser. No. 17/898,098, filed on Aug. 29, 2022, entitled “Nickel-Hydrogen Battery Configurations for Grid-Scale Energy Storage,” which is herein incorporated by reference in its entirety. Embodiments of the present disclosure eliminate the bridges that serially couple a series of individual parallel oriented stacks as presented in that application.

FIG. 1A depicts a schematic depiction of an individual pressure vessel (IPV) metal-hydrogen battery 100. The metal-hydrogen battery 100 includes electrode stack assembly 101 that includes stacked electrodes separated by separators 106. The electrodes include cathodes 102 and anodes 104. Separator 106 is positioned between the cathode 102 and the anode 104. Each pair of cathode 102 and anode 104 electrodes can be considered a cell, or electrical source. The electrode stack 101 can further include a frame 110 that fixes the cathodes 102, anodes 104, and separators 106 in place. In the particular example illustrated in FIG. 1A, there is an anode 104 on both the top and bottom of stack 101, adjacent to frame 106, however other arrangements can also be formed.

The electrode stack 101 can be housed in a pressure vessel 108. Pressure vessel 108 can contain electrolyte 126 and hydrogen gas. The cathode 102, the anode 104, and the separator 106 are porous to allow electrolyte 126 to flow between the cathode 102 and the anode 104. Electrode stack 101 is saturated with electrolyte 126. In some embodiments, the separator 106 can be omitted as long as the cathode 102 and the anode 104 can be electrically isolated from each other. For example, the space occupied by the separator 106 may be filled with the electrolyte 126. The metal-hydrogen battery 100 can further include a fill tube 122 configured to exchange electrolyte or gasses (e.g., hydrogen gas) with pressure vessel 108.

As shown in FIG. 1A, electrode stack 101 includes a number of stacked layers of alternating cathode 102 and anode 104 separated by a separator 106 in an individual pressure vessel (IPV). Stack 101 includes at least one pair of cathode 102 and anode 104. Cells can be formed by pairs of cathode 102 and anode 104 layers. Although the cells in an electrode stack assembly 101 may be coupled either in parallel or in series, in the example of battery 100 illustrated in FIG. 1A the cells are coupled in parallel. In particular, each of cathodes 102 are coupled to a bridge conductor 118 and each of anodes 104 are coupled to bridge conductor 116. Although FIG. 1A illustrates that fill tube 122 is positioned on the side of anode bridge conductor 116, it may alternatively be placed on the side of cathode bridge conductor 118, or in the side wall of pressure vessel 108. Fill tube 122 may include one or more valves (not shown) or may be otherwise sealed after pressure vessel 108 is charged with operating levels of electrolyte 126.

Additionally, in the example of FIG. 1A, pressure vessel 108 is illustrated as a cylindrical vessel that contains a single electrode stack 101. In accordance with embodiments of the present disclosure, pressure vessel 108 can be any shape large enough to contain multiple electrode stacks 101 and hold the pressures involved during operation. Further, in FIG. 1A electrode stack 101 is illustrated as oriented along a length of pressure vessel 108. However, electrode stack 101 can be arranged so that the electrodes are laterally oriented instead. Consequently, electrode stack 101 can be in any shape, have any number of cells, and have any orientation relative to pressure vessel 108.

As is further illustrated in FIG. 1A, bridge conductor 116, which is coupled to anodes 104, is electrically coupled to an anode feedthrough terminal 120, which may present the negative terminal of battery 100. Terminal 120 can include an insulated feedthrough to allow terminal 120 to extend outside of pressure vessel 108, or bridge conductor 116 may be connected directly to pressure vessel 102. Similarly, cathode conductor 118, which is coupled to cathodes 102, can be coupled to a cathode feedthrough terminal 124 that represents the positive side of battery 100. Terminal 124 also passes through an insulated feedthrough to allow terminal 124 to extend to the outside of pressure vessel 108.

As discussed above, each cell included in electrode stack 101 includes a cathode 102 and an anode 104 that are separated by separators 106. Electrode stack 101 is positioned in pressure vessel 108 where electrolyte 126 can flow between cathode 102 and anode 104. As is discussed further below, cathode 102 is formed of a conductive substrate coated by a metal compound. Similarly, anode 104 is formed of a porous conductive substrate coated by a porous catalyst. Separator 106 is a porous insulator that can separate alternating layers of cathode 102 and anode 104 and allow electrolyte 126 to flow between cathode 102 and anode 104. In some embodiments, the electrolyte 126 is an aqueous electrolyte that is alkaline (with a pH greater than 7). Each of anode 104 and cathode 102 can be formed as electrode assemblies with multiply layered structures.

FIG. 1A depicts a schematic of an IPV configuration metal-hydrogen battery 100 that includes an electrode stack 101. The electrode stack 101 includes at least one layer that includes a cathode 102, an anode 104, and a separator 106 disposed between the cathode 102 and the anode 104. The layer 101 is housed in an enclosure 108. Electrolyte 126 is disposed in the enclosure 108. The cathode 102, the anode 104, and the separator 106 are porous to allow the electrolyte 126 to communicate between the cathode 102 and the anode 104. The metal-hydrogen battery 100 pressure vessel 108 further includes a fill tube 122 configured to exchange hydrogen gas and electrode 126 with the interior of enclosure 108.

In accordance with some embodiments, a configuration of battery layers that are all contained within a vessel is presented. As discussed further below, some embodiments can include Ni—H₂ cells that may include nickel-hydroxide cathode, an H₂-catalytic anode, and a porous separator saturated in 5% to 50% potassium hydroxide all sealed inside of a metal pressure vessel, although other configurations are possible as discussed above. The typical cell design contains many pairs of cathodes and anodes separated by the porous separators and each pair is connected in parallel, as is illustrated in FIG. 1A. This configuration is referred to as an individual pressure vessel, or IPV, design. The IPV design allows for high capacity but achieves only a 1.25 V nominal discharge voltage under typical conditions. The pressure vessel 108 is leak free and capable of withstanding pressure greater than 1000 psi, which is a major cost contributor for Ni—H₂ cells.

An embodiment of electrode stack 101 as illustrated above being used in an individual pressure vessel (IPV) configuration is described in more detail in U.S. patent application Ser. No. 17/830,193, entitled “Electrode Stack Assembly for a Metal Hydrogen Battery,” filed on Jun. 1, 2022, which is herein incorporated by reference. Another embodiment of electrode stack 101 is described in U.S. patent application Ser. No. 17/687,527, entitled “Electrode Stack Assembly for a Metal Hydrogen Battery,” filed on Mar. 4, 2022, which is also incorporated by reference in its entirety. These and other electrode stacks may be utilized in embodiments of this disclosure as described below.

A plurality of electrode stacks 101 as illustrated in FIG. 1A can be electrically coupled through bridges in series and housed in a CPV pressure vessel to form a CPV configuration battery. In particular, each of electrode stack 101 includes bridge conductors that are easily welded to corresponding bridge conductors of an adjacent electrode stack 101 when the stacks 101 have been aligned. These bridge conductors between adjacent stacks 101 work as bipolar plates (i.e. the anode bridge of one stack is connected to the cathode bridge of the adjacent stack). FIG. 1B illustrates a construction as using a series coupled plurality of stacks 101.

FIG. 1B illustrates alignment of N electrode stacks 101 (electrode stacks 101-1 through 101-N) as described above with respect to FIG. 1A. As illustrated in FIG. 1B, electrode stacks 101-1 through 101-N are arranged to be coupled in series to form stack arrangement 130, with the anode of one of electrode stacks 101 being coupled to the cathode of an adjacent electrode stack 101 using bridges 140. In the example illustrated in FIG. 1B, bridge 134-1 is coupled to a terminal rod 138. Bridge 132-N is coupled to a terminal rod 136.

FIG. 1C illustrates a bridge conductor 140, which is an example of one of bridge conductor 134 or bridge conductor 132. In the example embodiment illustrated here, bridge conductor 140 includes a bridge frame 142 that can be configured to mate with isolators that help isolate bridge conductor 140 from components of stack 101. Additionally, bridge frame 144 is configured to be mechanically connected (e.g., welded) to bridge frames 144 of adjacent ones of electrode stacks 101 or to a terminal rod such as the terminal rods illustrated in FIG. 1B. In some embodiments, bridge frame 144 is formed to stack against other bridge frames 144.

In the embodiment of bridge conductor 140 illustrated in FIG. 1C, slots 142 are formed in bridge conductor 140. Slots 142 are configured to accept tabs that are formed in the anode or cathode of stack 101. The tabs are inserted into slots 142 to form either bridge 134 or bridge 132 as illustrated in FIG. 1B.

As illustrated in FIG. 1B, the stack arrangement 130 can be formed by welding bridge conductors 134 to bridge conductors 132 to form a serial arrangement 130. Feedthrough conductors can be welded to bridge conductor 134-1 and to bridge conductor 132-N.

FIG. 1D illustrates a CPV configured battery 150 as illustrated in FIG. 1B. As is illustrated, N stacks 101-1 through 101-N are assembled such that bridge conductors 134 and bridge conductors 132 are welded to form inter-stack connections 152-1 through 152-(N−1), as illustrated in configuration 130 illustrated in FIG. 1B. As is illustrated, configuration 130 is enclosed in a pressure vessel 154 with feedthrough conductors 138 and 136 extending through pressure vessel 154. As shown in FIG. 1D, there are N number of series connected stacks. In the particular example illustrated in FIG. 1D, N=6.

FIG. 1E illustrates the electrical representation 160 of battery 150 as illustrated in FIG. 1D. As illustrated in FIG. 1E and discussed above with respect to FIG. 1A, each of stacks 101 include a number of cathode 102 and anode 104 pairs represented as source 162 that are coupled in parallel. The N stacks 101 are coupled in series at inter-stack connections 152 and coupled to feedthroughs 138 and 136. However, this configuration of battery 150 requires the presence of inter-stack connections 152, which require a large amount of resources to build.

In accordance with embodiments of the present disclosure, the inter-stack connections 152 are eliminated by building a bridgeless CPV superstack according to some embodiments of the present disclosure. Individual stacks 101 are not assembled. This eliminates the need for producing the inter-stack connections 152, which reduces both cost and weight of the resulting battery. Embodiments of the present disclosure eliminate the need for welding bridges together, thus reducing the production cost, increasing the production efficiency. Since now the individual electrodes are directly joined together, the overall electrical resistance of the super stack is also much lower, which boosts the energy efficiency of a resulting battery using the bridgeless CPV superstack.

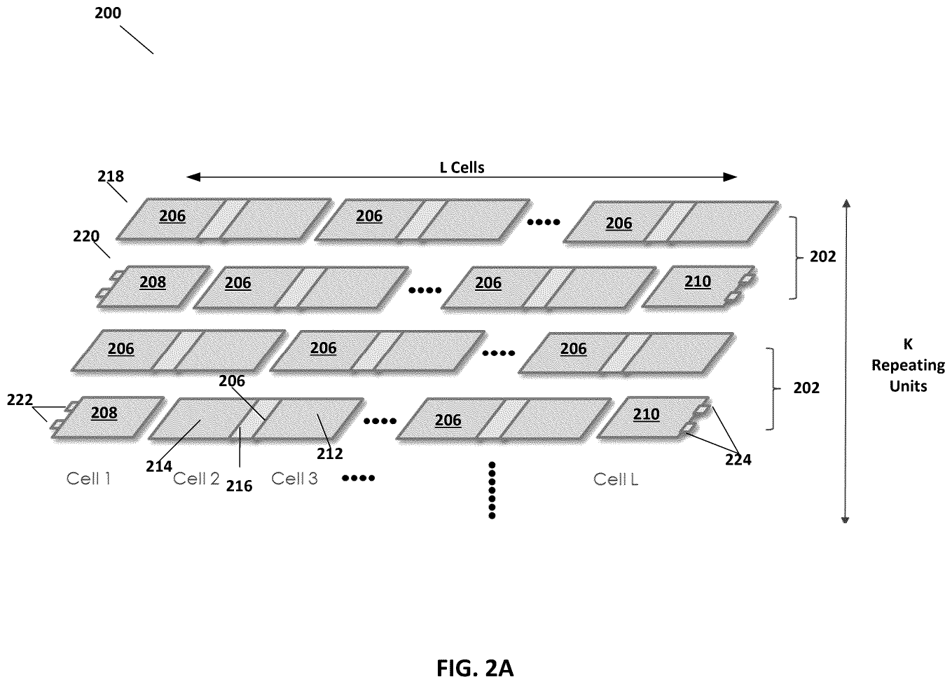

FIG. 2A illustrates a bridgeless CPV superstack 200 (also referred to as stack 200) according to some embodiments of the present disclosure. As illustrated in FIG. 2A, bridgeless CPV superstack 200 is formed with combinations of three components: an intermediate anode-cathode 206, end anode 208, and end cathode 210. Intermediate anode-cathode 206 is formed by welding an anode 212 and a cathode 214 together through a metal sheet 216. In order to prevent electrolyte bridges, which can cause short circuits between electrodes, one or more of the following approaches can be used: 1) the metal sheet 216 between anode 212 and cathode 214 is made wide enough to prevent formation of electrolyte bridges; 2) plastic tapes can be applied to the metal sheet 216 to prevent formation of electrolyte bridges; and/or 3) the electrolyte quantity can be controlled to prevent formation of electrolyte bridges.

End anode 208 includes one or more layers of anode material welded to tabs 222. Tabs 222 can engage with slots 142 of bridge conductor 140 as illustrated in FIG. 1C. Bridge conductor 140 can be connected to a feedthrough conductor which can engage with a feedthrough in the pressure vessel. Similarly, end cathode 210 includes a cathode material coupled to tabs 214, which can engage with slots 142 of a bridge conductor 140. Again, bridge conductor 140 engaging with end cathode 210 can include a feedthrough conductor that engages with a feedthrough in the pressure vessel.

As illustrated in FIG. 2A, bridgeless CPV superstack 200 can be formed in layers. A unit 202 can be formed with a first layer 218 that includes L/2 intermediate anode-cathodes 206 adjacently placed but separated by a space equivalent to the width of metal sheet 216. Second layer 220 has at one end an end anode 208 and the other an end cathode 210 with L/2−1 intermediate anode-cathodes 206 separating the end anode 208 and the end cathode 210. First layer 218 and second layer 220 are aligned such that a cathode in layer 218 is adjacent to an anode of layer 220 (e.g., end anode 208 is aligned with cathode 214 of an intermediate anode-cathode 206 and end cathode 210 is aligned with anode 212 of an intermediate anode-cathode 206) to form L cells in each of the K units. There can be K repeated units 202 that are stacked and aligned with one another in bridgeless CPV superstack 200. Four example batteries are further discussed below with example 1 having L=6 and K=20, example 2 having L=6 and K=30, example 3 having L=12 and K=25, and example 4 having L=12 and K=33. These examples are illustrated below with respect to Table 1 and some of their example characteristics.

As illustrated in FIG. 2A, L can be any even number. Further, there may be any number K of units 202 stacked to form bridgeless CPV superstack 200. As a consequence, to form bridgeless CPV superstack 200, there are K end anodes 208, K end cathodes 210, and K*(L−1) intermediate anode-cathodes 206 in the assembly. If K=20 and L=6, for example, then there will be 20 end anodes 208, 20 end cathodes 210, and 100 intermediate anode-cathodes 206 arranged as shown in FIG. 2A.

FIG. 2B illustrates an equivalent electrical depiction 230 of a bridgeless CPV superstack 200 as illustrated in FIG. 2A. As is illustrated in FIG. 2B, each stacked anode/cathode layer forms a cell or source 232. As a result of the stacking illustrated in FIG. 2A, there are L series coupled sources 232 in each unit 202. Units 202 are coupled in parallel such that we have K parallel coupled, L series connected sources 232 in bridgeless CPV superstack 200.

### Structure 1

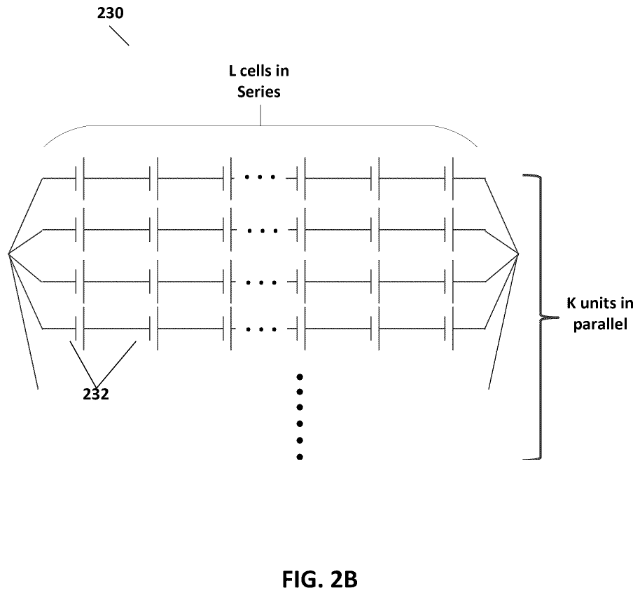

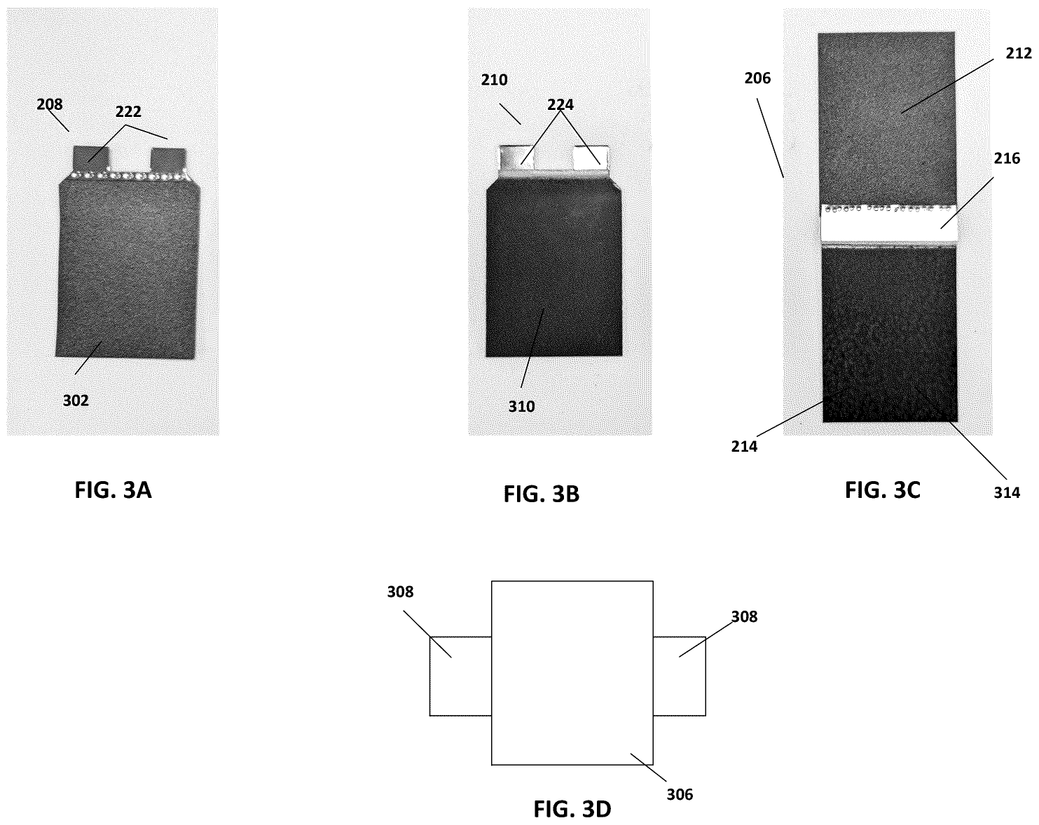

FIGS. 3A, 3B, 3C, and 3D illustrates components of a first bridgeless CPV using superstack 200 according to some embodiments. FIG. 3A illustrates an end anode 208. As illustrated, end anode 208 can be formed of multiple layers 302 of anode material. In some embodiments, multiple layers 302 can include two layers of anode material, although three or more layers may also be used. Multiple layers 302 are welded to tabs 222.

FIG. 3B illustrates end cathode 210. As illustrated in FIG. 3B, end cathode 210 includes cathode material 310 connected to tabs 224. In some embodiments, cathode material 310 is encased in separator material. Further, the separator material includes wall wicks, which can help with aligning components during assembly as well as functioning to wick electrolyte from the sidewall of a pressure vessel in the finished battery.

FIG. 3C illustrates intermediate anode-cathode 206. As is illustrated and discussed above, intermediate anode-cathode 206 includes an anode 212 welded to a cathode 214 through a metal sheet 216. Anode 212 can include the multiple layers 302 as illustrated in FIG. 3A. Cathode 214 includes a cathode material 314, which can be encased in separator material that has wall wicks. Again, the wall wicks can be helpful in alignment as well as functioning to wick electrolyte from the sidewall of a pressure vessel.

FIG. 3D illustrates a separator pouch 306 according to some embodiments of the present disclosure. Separator pouch 306 is formed of a separator material and can be placed over cathode material 310 of end cathode 210 or cathode material 314 of anode-cathode 206 to provide separator in the cells that are formed in stack 200. As is illustrated in FIG. 3D, separator pouch 306 may include wall wicks 308. As discussed above, wall wicks 308 can help with aligning components during assembly as well as to wick electrolyte from the sidewalls of a pressure vessel. In some embodiments, separator material can be placed loosely between cathode material of end cathode 210 and anode material 212 of anode-cathode 206, between cathode material 314 of anode-cathode 206 and anode material 212 of anode-cathode 206, or between cathode material 314 of anode-cathode 206 and anode material 302 of end anode 208 to provide separation in the cells that are formed in stack 200 and separator pouch 306 is not formed.

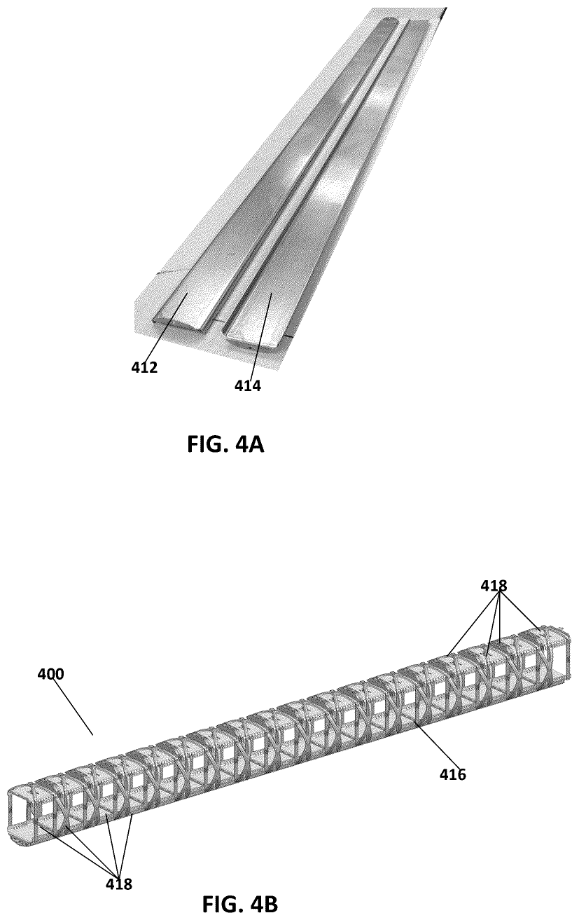

FIG. 4A illustrates cell plates 412 and 414 that are components used in constructing bridgeless CPV superstack 200 battery according to some embodiments. As discussed further below, in assembly bridgeless CPV superstack 200 is enclosed between cell plates 412 and 414. In FIG. 4A, cell plates 412 and 414 illustrate both sides of the cell plates, with cell plate 414 illustrating a “bottom” orientation while cell plate 412 illustrating a “top” orientation. In particular, cell plates 412 and 414 can be identical and oriented according to use. FIG. 4B illustrates another structure 400 in which superstack 200 can be assembled. As illustrated in FIG. 4B, cell plates are assembled and braced with braces 416 to provide for further structural integrity. Further, structure 400 can be assembled with individual cell plate components 418 that are held together with braces 416 and cell plate arms, as is discussed further below.

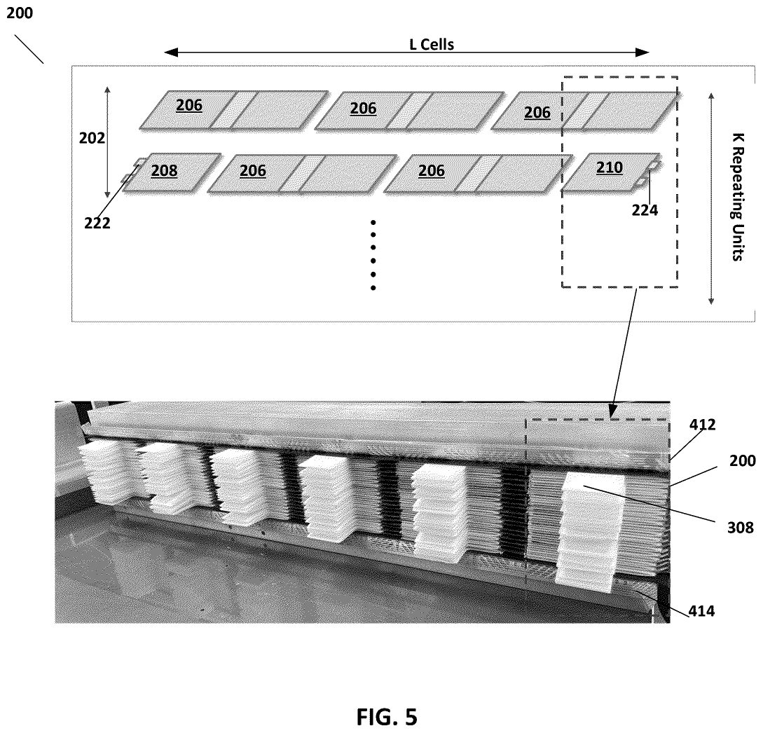

FIG. 5 illustrates assembly of the components of a battery with bridgeless CPV stack 200. As illustrated, assembly and alignment are accomplished in a way that all components are aligned well to form the stack. In particular, the components of stack 200 are positioned between cell plates 412 and 414 and the L cells are aligned with each other. As illustrates, wall wicks 308 can assist in alignment of each unit 202 of the K repeating units of bridgeless CPV superstack 200.

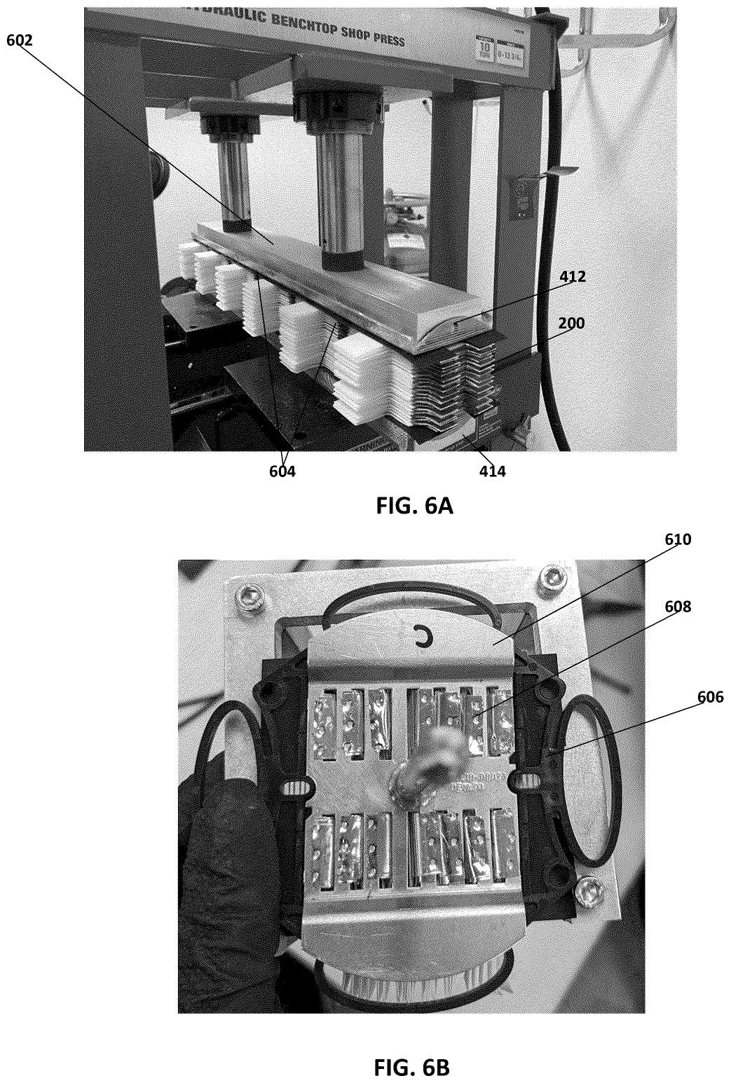

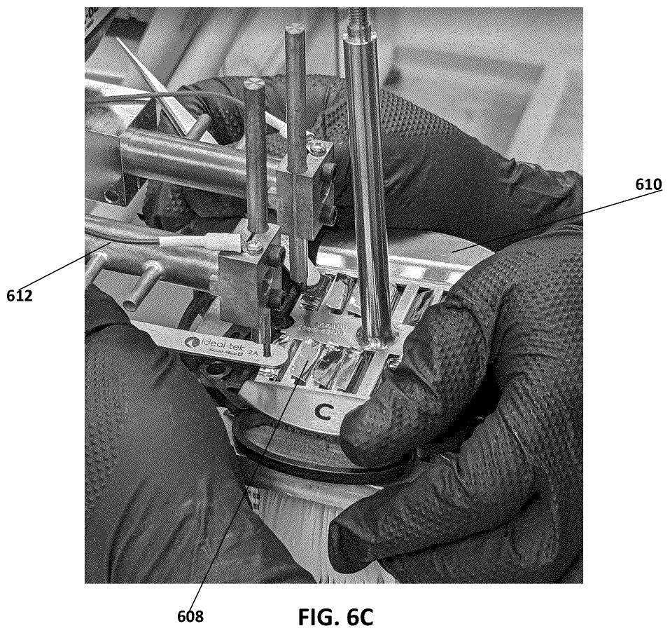

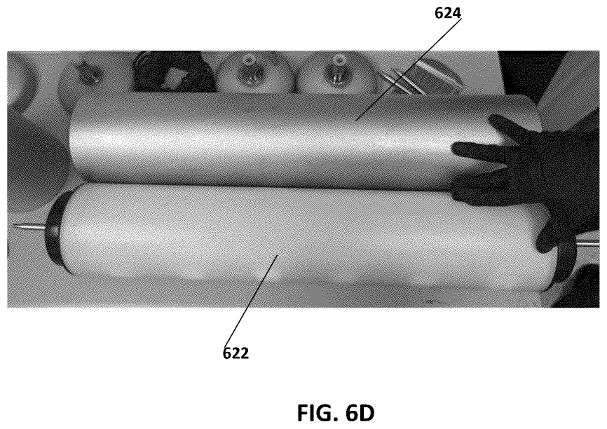

FIGS. 6A through 6D illustrate assembly of the stack and assembly into a battery according to some embodiments. As shown in FIG. 6A, once stack 200 is assembled as illustrated in FIG. 5, the resulting structure with stack 200 is inserted into a press 602 and pressure is applied to compress stack 200. Once compressed, arms 604 are welded to mechanically connect cell plates 412 and 414, rigidly fixing compression of stack 200. Arms 604 can be welded to cell plate 414 prior to assembly so that arms 604 can help keep stack 200 aligned during transport to press 602.

FIG. 6B illustrates insertion of an end bridge 610 to engage with tabs 608. An isolator 606 may be included between stack 200 and end bridge 610. Tabs 608 refers to tabs 222 or tabs 224, depending on the orientation of stack 200. In FIG. 6C, tabs 608 are welded to end bridge 610 with a welder 612. An end bridge 610 is assembled in this fashion on each side of stack 200.

FIG. 6D illustrates the assembled bridgeless CPV superstack 200 as illustrated in FIGS. 6A-6C inserted into liner tube 622, which in turn can be placed in metallic pressure vessel 624. The pressure vessel into which bridgeless CPV superstack 200 is inserted can be any material of sufficient strength to withstand the pressures created and prevent the gasses and liquid contained in the pressure vessel from escaping. In some cases, the pressure vessel can be metallic however in others the pressure vessel can be a wrapped plastic, epoxy material, or fiberglass composite.

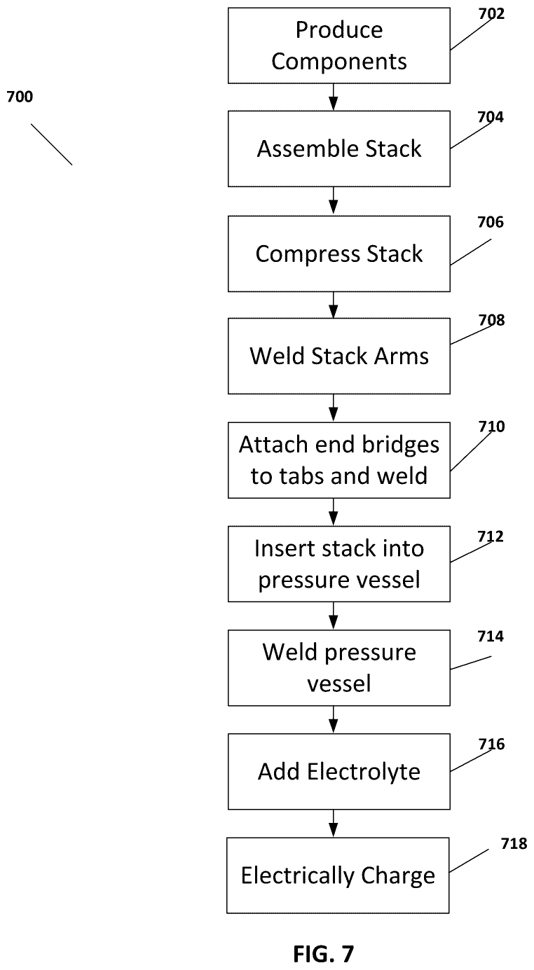

FIG. 7 illustrates a procedure 700 for forming a battery according to some embodiments of the present disclosure. As illustrated in FIG. 7, procedure 700 starts in step 702 by producing the individual components. In particular, end anodes 208 as illustrated in FIG. 3A, end cathodes 210 as illustrated in FIGS. 3B and 3C, intermediate anode-cathodes 206 as illustrated in FIG. 3D, end bridges 402 and 404 as illustrated in FIG. 4, liners 410 as illustrated in FIG. 4, and cell plates 412 and 414 as illustrated in FIG. 4. As discussed further above, there needs to be K end anodes 208, K end cathodes 210, K*(2L−1) intermediate anode-cathodes 206, one each of end bridges 402 and 404, two liners 410, and one each of cell plates 412 and 414. Once all of the components are acquired, procedure 700 can be executed following step 704.

In step 704, bridgeless CPV superstack 200 is assembled as is illustrated in FIG. 5. In particular, end anode 208, end cathode 210, and intermediate anode-cathode 206 components are layered on cell plate 414 as illustrated in FIG. 5 using the wall wicks 308 as placement indicators. Once the K-number of layered units 202 are arranged cell plate 412 is placed on the top. In some embodiments, liners may be placed between cell plates 412 and 414 and the components of stack 200.

In step 706, assembled stack 200 inserted into press 602 as is illustrated in FIG. 6A and stack 200 is compressed. In step 708, arms 604 are welded such that cell plates 412 and 414 are rigidly connected, rigidly fixing bridgeless CPV superstack 200 in place.

In step 710, as illustrated in FIG. 6B, an end bridge 610 is engaged with tabs from assembled bridgeless CPV superstack 200. As shown, the tabs are inserted through the slots of end bridge 610 and folded. It should be noted that multiple tabs can be inserted through a single slot of end bridge 610. As shown in FIG. 6C, the tabs are welded to the end bridge 610. One end bridge 610 is attached to each side of assembled bridgeless CPV superstack 200 in step 710.

In step 712, assembled stack 200 are placed into a pressure vessel, which as illustrated in FIG. 6D can include an inner liner 622 and an outer container 624, such that feedthrough conductors 406 and 408 extend through feedthroughs in the pressure vessel. Pressure vessel is then welded and sealed in step 714 to form a finished battery.

In step 716, the battery electrolyte can be added to the battery. This can be accomplished through a fill tube by alternately filling and draining the pressure vessel with electrolyte until the appropriate amount of electrolyte remains in the battery, or fill optimized amount of KOH at once without draining. The charged battery will be such that stack 200 uptakes the right amount of electrolyte and there is a balance of liquid phase ionic transport and hydrogen gas diffusion throughout the electrodes during cycling of the battery. In step 718, the battery can then be electrically charged and operated in a charge/discharge cycle.

As discussed above, four example batteries that have been assembled and characterized is discussed below. In example 1, the battery includes stack 200 with L=6 and K=20. In example 2, the battery includes stack 200 with L=6 and K=30, placed in the same sized pressure vessel as is the battery of example 1. In Example 3, the battery includes stack 200 with L=12 and K=25. In Example 4, the battery includes stack 200 with L=12 and K=33. As is discussed below, each of these example batteries exhibited stable operation throughout multiple cycles of the battery. Table 1 summarizes four examples of the CPV with difference cells (L) and units (K).

TABLE I
Tested Examples

| Example | 1 | 2 | 3 | 4 |
|---|---|---|---|---|
| Number of Cells/unit (L) | 6 | 6 | 12 | 12 |
| Number of units (K) | 20 | 30 | 25 | 33 |
| Average Charge Voltage (V) | 8.7 | 8.7 | 17.4 | 17.4 |
| Average Discharge Voltage (V) | 7.8 | 7.8 | 15.6 | 15.6 |
| Energy Capacity (KWh) | 0.4 | 0.6 | 1.5 | 1.8 |

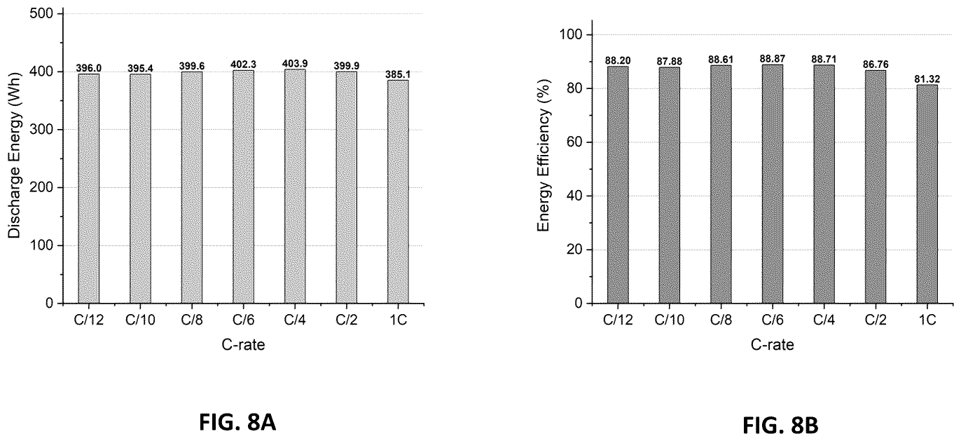

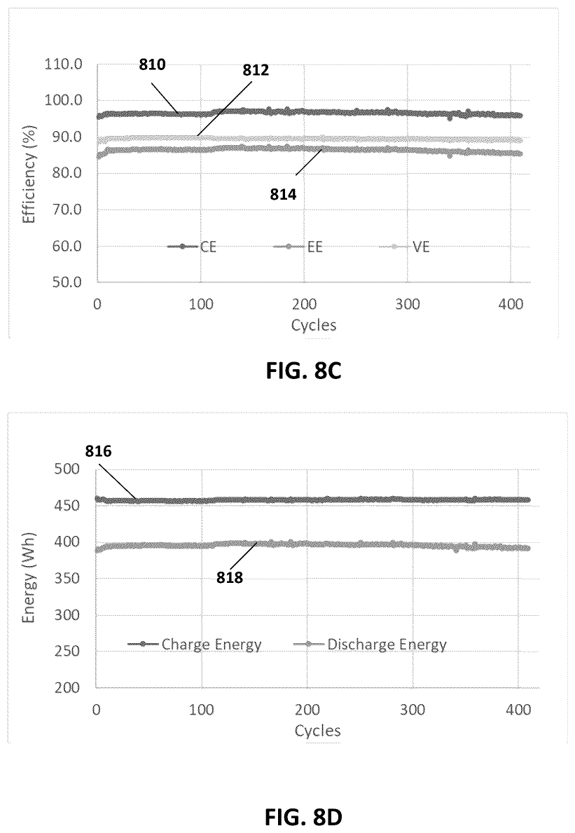

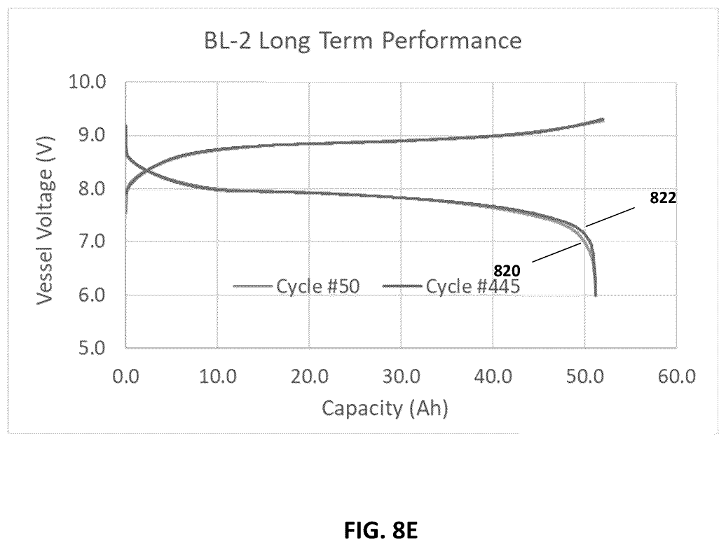

FIGS. 8A through 8E illustrate performance of a battery according to FIGS. 2A through 7 formed according to Example 1 in Table 1. FIGS. 8A and 8B illustrates discharge energy (in Watt-hours) versus C-ratings in a battery of Example 1 (L=6, K=20). The C-rating is a measurement of current in which the battery is charged and discharged, measured against the capacity of the fully charged battery. As shown, FIG. 8A shows the discharge energy versus C-rates of C/12, C/10, C/8, C/6, C/4, C/2, and 1C. FIG. 8B shows energy efficiencies for the same set of C-rates. Data was taken at a battery temperature of 30° C.

FIG. 8C illustrates the efficiency characteristics of the Example 1 battery with CPV stack 200 (L=6, K=20) as described above. The coulomb efficiency (CE) 810, the voltage efficiency (VE) 812, and the energy efficiency (EE) 814 are illustrated against the number of cycles of the battery (i.e. charge/discharge cycles). The battery was continuously cycled at C/2 and at room temperature. As is illustrated in FIG. 8C, the resulting battery is very stable.

FIG. 8D illustrates energy capacities for the battery with bridgeless CPV stack 200 (L=6, K=20) as described above. The charge energy 816 and the discharge energy 818 also exhibit stability over repeated cycles. Again, the battery was continuously cycled at C/2 and at room temperature.

FIG. 8E illustrates the long-term performance of the battery with CPV stack 200 (L=6, K=20) as described above. In particular, FIG. 8E shows the voltage vs. capacity performance at cycle #50 820 with that of cycle #445 822. The charge/discharge cycles were performed continuously at C/2. As is illustrated, there are very few differences between these performance characteristics over 400 cycles, indicating very stable long-term performance.

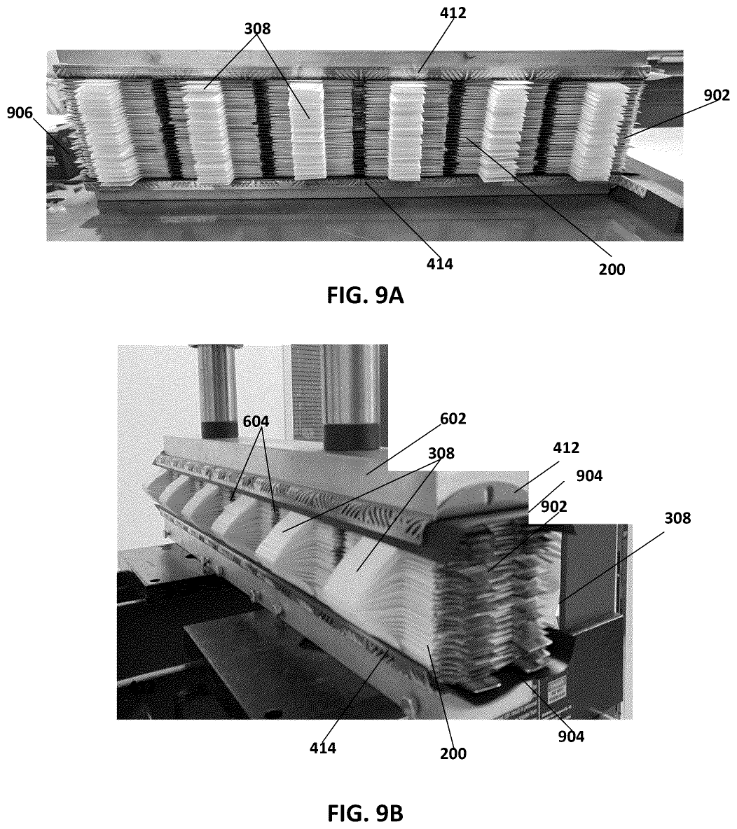

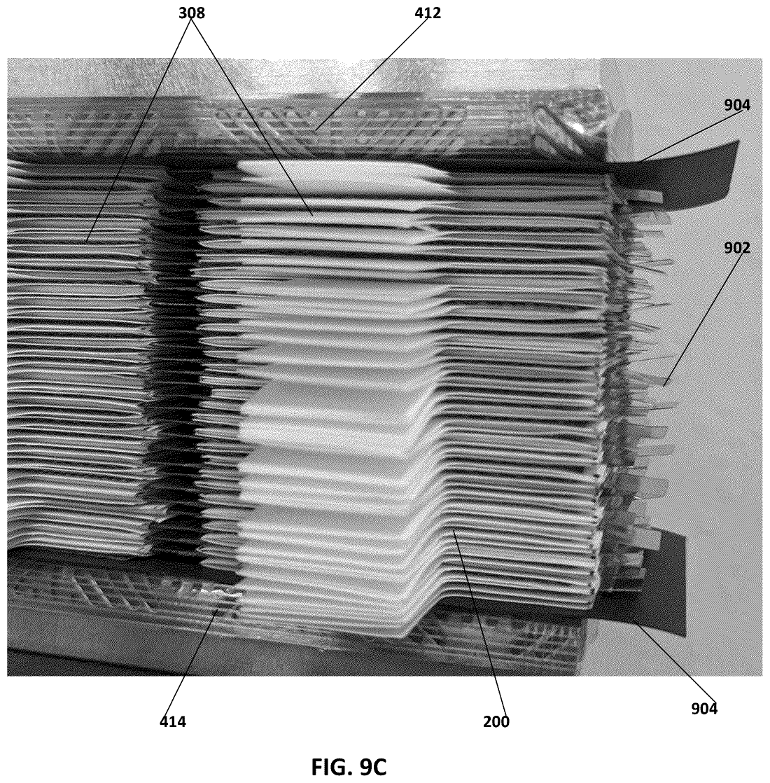

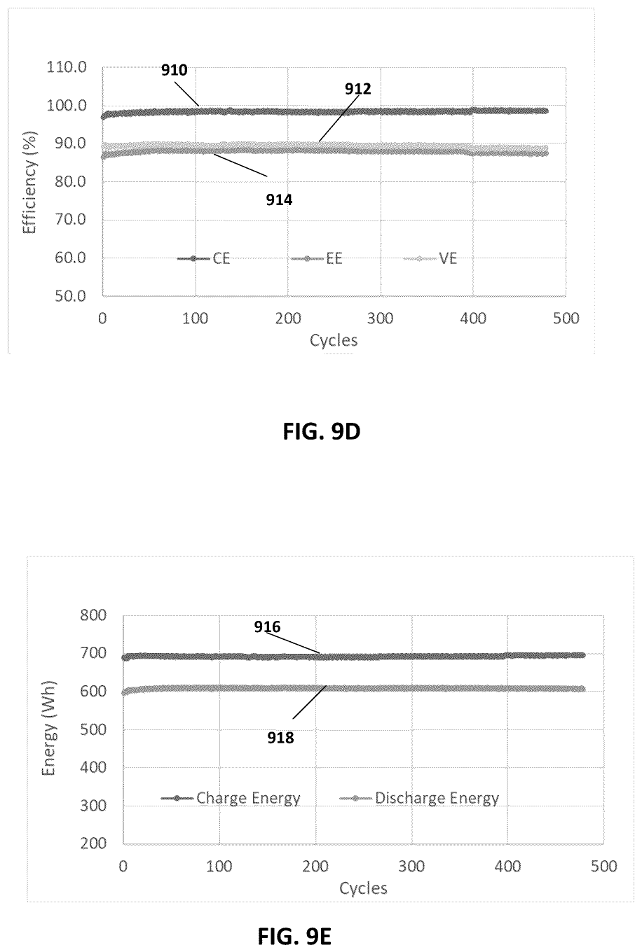

FIGS. 9A through 9C illustrate another example of stack 200, Example 2 (L=6, K=30 Example 2 has similar characteristics as that of example 1 illustrated in Table 1, except for the results of increasing K from 20 to 30, which provides 50% more capacity than that in the battery of Example 1. FIG. 9A illustrates a side view of an assembled stack 200 with L=6 and K=30 as illustrated in FIG. 5. As illustrated, bridgeless stack 200 includes cell plates 412 and 414. Wall wicks 308 are illustrated, as discussed with FIG. 3D. Further, tabs 902 and 906, which are tabs 222 of end anode 208 as illustrated in FIG. 3A or tabs 224 of end cathode 210 as illustrated in FIGS. 3B and 3C, are illustrated.

FIG. 9B illustrates stack 200 as illustrated in FIG. 9A in press 602 as illustrated in FIG. 6A. FIG. 9B also further illustrates tabs 902 and shows end plates 412 and 414. In particular, bridgeless stack 200 can be compressed in press 602 with end plates 412 and 414. FIG. 9C further shows one end of stack 200 which further illustrates the placement of a liner 904 positioned between cell plates 412 and 414 and components of stack 200 and tabs 902.

FIGS. 9D and 9E illustrate further characteristics of the Example 2 battery produced with stack 200 with L=6 and K=30 as shown in FIGS. 9A through 9C. FIG. 9D illustrates the efficiencies as a function of number of cycles for the battery with the L=6, K=30, stack 200 as illustrated in FIGS. 9A through 9B. FIG. 9D illustrates the CE 910, VE 912, and EE 914 for the example battery. FIG. 9E shows charge energy 918 and discharge energy 918 for the example battery using stack 200 as illustrated in FIGS. 9A through 9C. Data within FIGS. 9D and 9E was taken by continuously cycling at charging rate C/2 and room temperature.

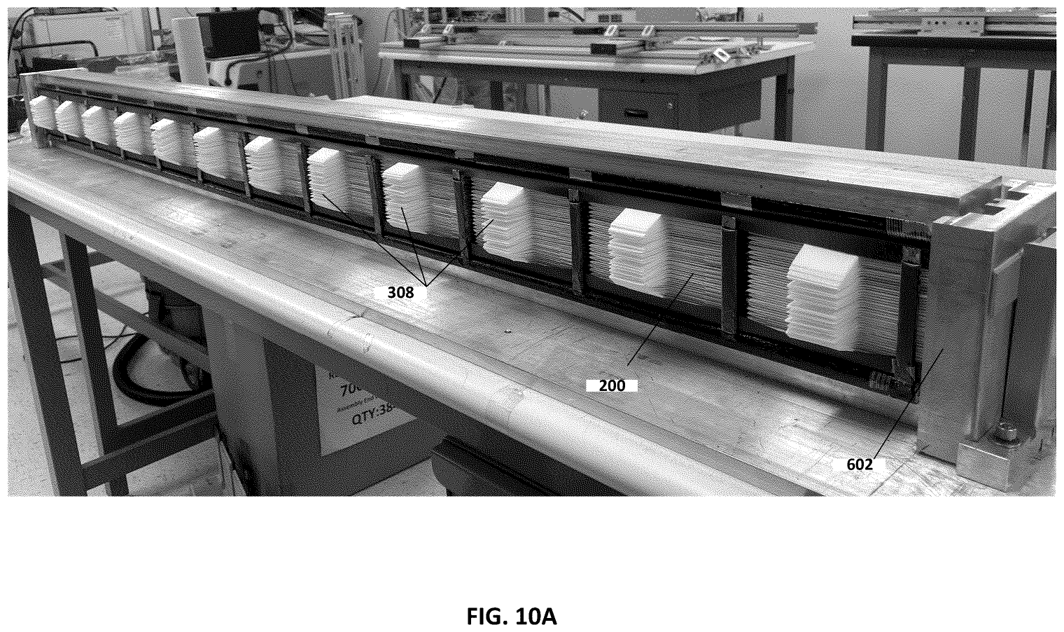

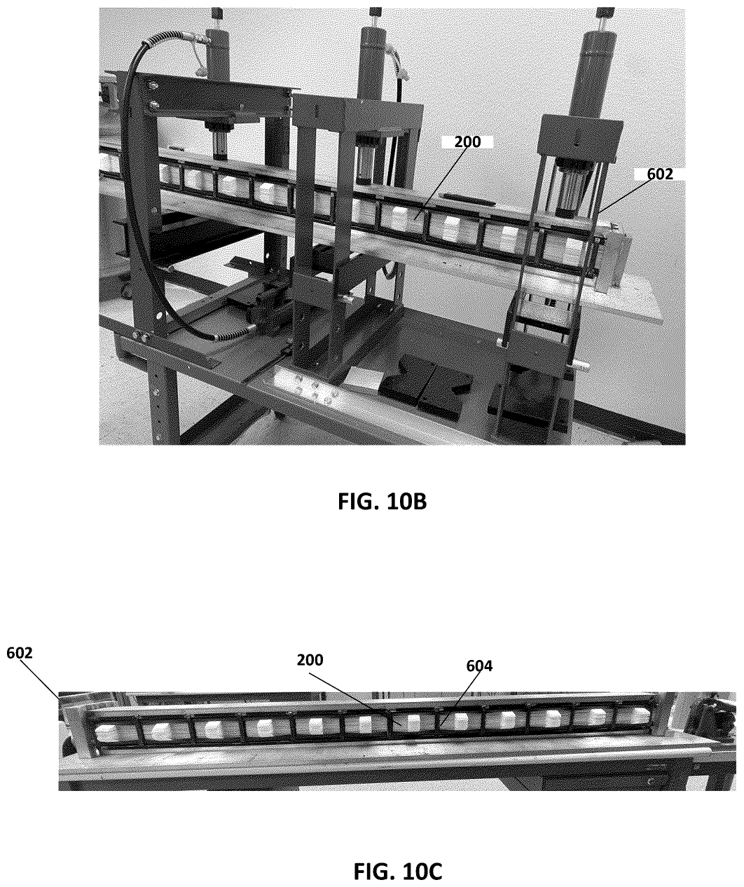

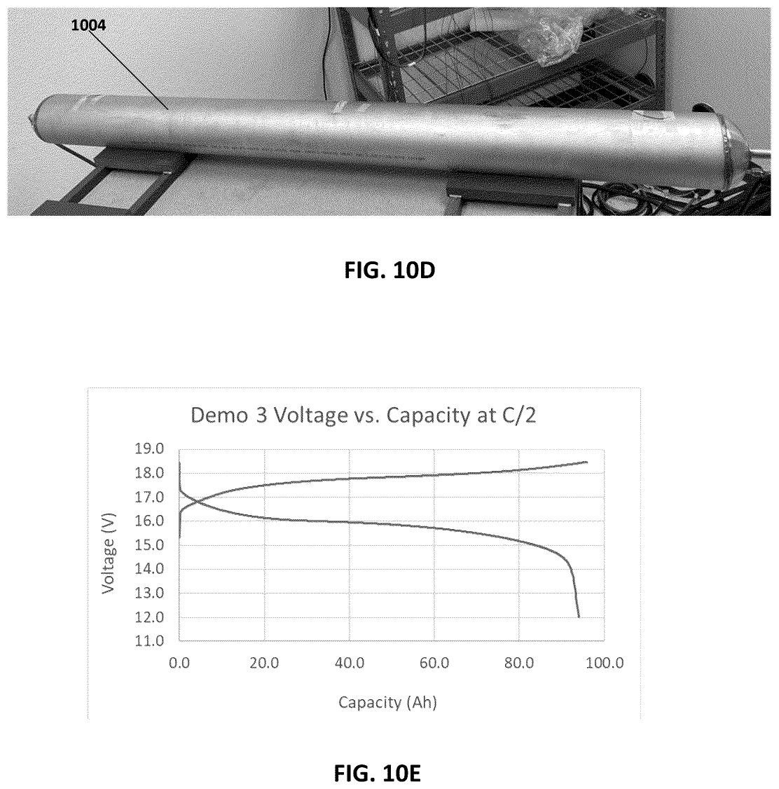

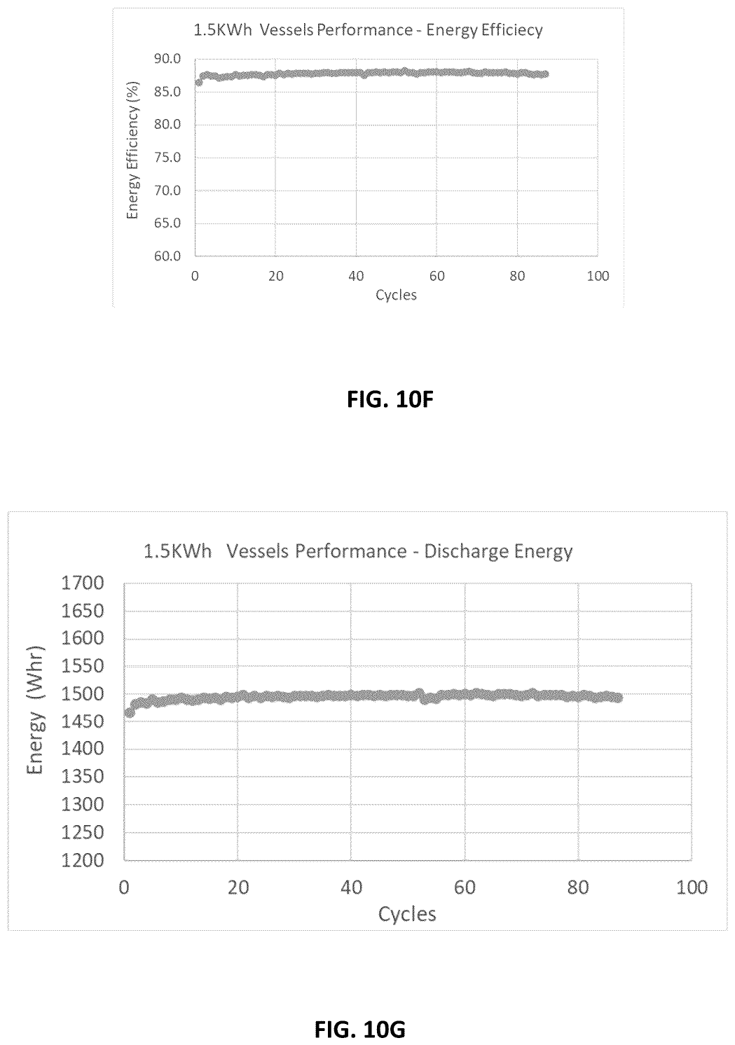

FIGS. 10A through 10G illustrates a third example, Example 3, where L=12 and K=25. FIG. 10A illustrates a bridgeless CPV superstack 200 according to Example 3 placed into a part of press 602 prior to compression. FIG. 10B illustrates compression in press 602 of bridgeless CPV superstack 200 according to Example 3.

FIG. 10C illustrates bridgeless CPV superstack 200 after it has been pressed in press 602 and the welding of arms 604 have been completed. End plate 610 is installed and welded as described above. FIG. 10D illustrates the finished battery with stack 200 inserted into pressure vessel 1004 and pressure vessel 1004 sealed, welded. Electrolyte can then be injected into pressure vessel 1004 and the resulting battery tested.

FIG. 10E illustrates the voltage vs capacity charge/discharge characteristics of the battery of example 3 at C/2. FIG. 10F illustrates energy efficiency as a function of number of cycles for the battery of example 3. FIG. 10G illustrates discharge energy as a function of number of cycles for the battery of example 3. Table 2 below illustrates the characteristics described in FIGS. 10E through 10G.

TABLE 2
Example 3 battery characteristics (stack 200
having L = 12 and K = 25)

| CPV Battery characteristics | Characteristic |
|---|---|
| CE | 98% |
| VE | 89% |
| EE | 87% |
| Charge capacity | 96 Ah |
| Discharge Capacity | 94 Ah |
| Charge Energy | 1704 Wh |
| Discharge Energy | 1482 Wh |

As shown in FIGS. 10A through 10G, the battery with stack 200 of Example 3 is also very stable over time. Consequently, each of the batteries produced with example bridgeless CPV superstack 200 according to the present disclosure provide batteries having fewer internal parts, especially lacking internal bridges, and perform very well.

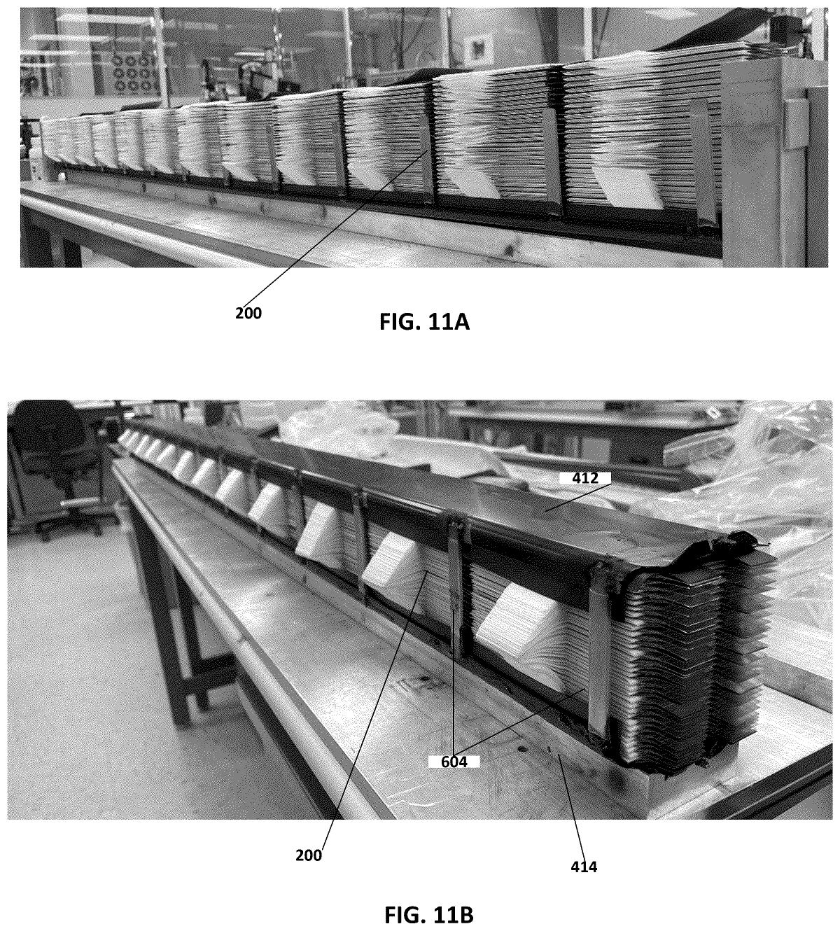

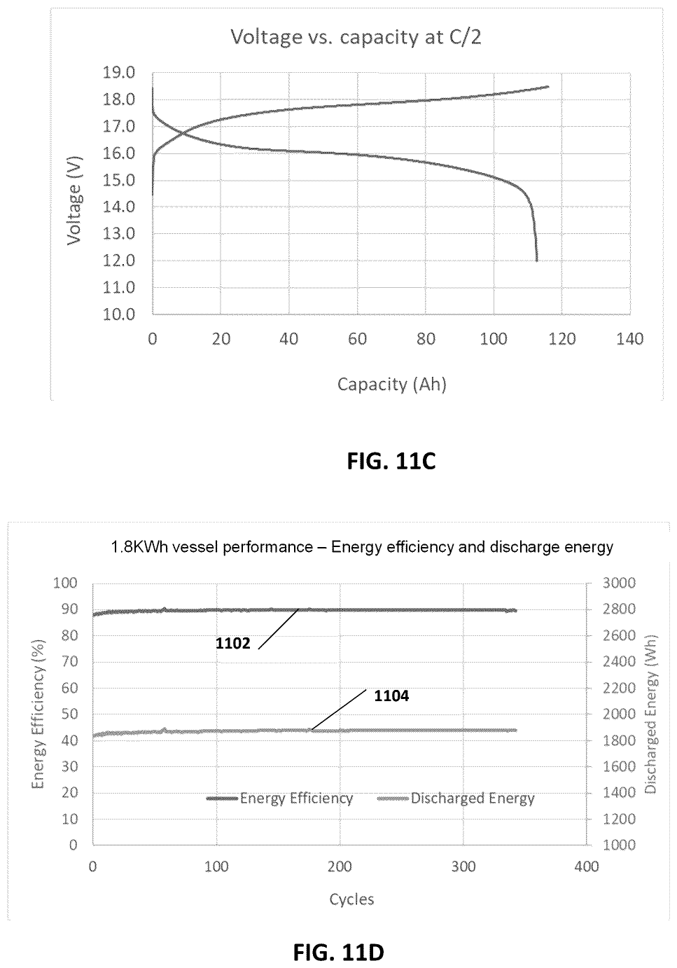

FIGS. 11A through 11D illustrates a fourth example, Example 4, where L=12 and K=33. FIG. 11A illustrates bridgeless CPV superstack 200 before it has been compressed. FIG. 11B illustrates bridgeless CPV superstack 200 that has been compressed and welded together through cell plates 412 and 414 and arms 604. As is discussed above, the assembled and welded bridgeless CPV superstack 200 is finished by adding end plates, the assembly placed in a pressure vessel, and an appropriate quantity of electrolyte added to form the battery.

FIG. 11C illustrates the voltage vs capacity charge/discharge characteristics of the battery of example 3 at C/2. FIG. 11D illustrates round trip energy efficiency 1102 as a function of number of cycles for the battery of example 4. FIG. 11D also illustrates discharge energy 1104 as a function of number of cycles for the battery of example 4. Table 3 below illustrates the characteristics described in FIGS. 11C through 11D.

TABLE 3
Example 4 battery characteristics (stack 200
having L = 12 and K = 33)

| | |
|---|---|
| Charge Medium | 17.8 |
| voltage (V) | |
| Discharge Medium | 15.9 |
| voltage (V) | |
| Round trip Energy | 90% |
| Efficiency | |
| Discharge Energy (KWh) | 1.87 |

Consequently, in all four examples illustrated the resulting battery demonstrates high efficiencies. Further, the resulting battery is stable over a large number of cycles. In particular, batteries formed according to embodiments of the present disclosure exhibit high stability and high efficiencies. Further, production of these batteries uses fewer components and eliminates the need for multiple bridges between the components.

### Structure 2

Some embodiments of a battery use a different structure than that shown above as Structure 1. In some embodiments, advantages of structure 2 include components with lighter weight, better hydrogen containment, strain relief, fewer components, and other benefits. Accordingly, each of the following individual components are sized to work consistently together in formation of a battery. Benefits of these components are further discussed below as the components themselves are described.

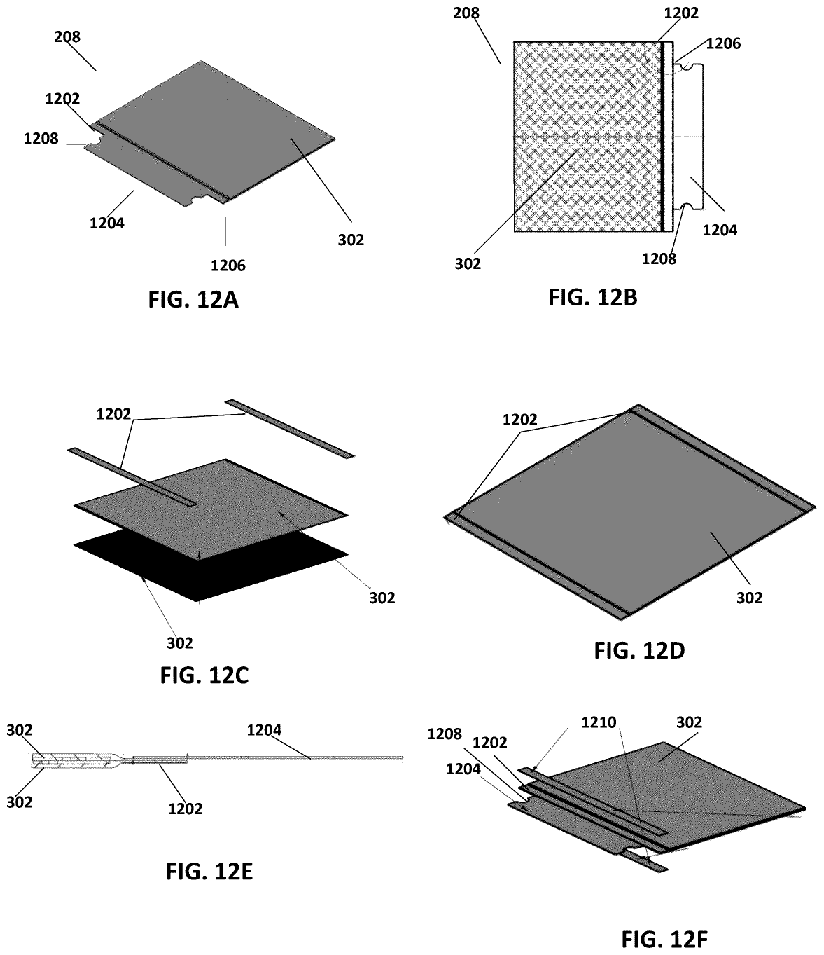

FIGS. 12A through 12F illustrate an example end anode 208 and its assembly according to some embodiments. End anode 208 includes a single tab 1204 that, as is further discussed below, will engage with corresponding slots of a bridge conductor. In some embodiments, tab 1204 may include multiple individual tabs that can engage corresponding slots of a bridge conductor. As illustrated, end anode 208 includes anode layers 302, which may be multiple layers of anode material. In some embodiments, anode layers 302 can be embossed to provide further channels for electrolyte flows. As is illustrated, metal strips 1202 can be used to weld the layers of anode material together and to tab 1204. Further, tab 1204 can include indents 1208 which aid in allowing tab 1204 to bend once inserted through a slot of a bridge, which is discussed further below. Additionally, a tape strip 1206 can cover the material of tab 1204 close to anode layers 302 for further isolation.

FIGS. 3C and 3D illustrates an example with two anode material layers 302 positioned with respect to metal strips 1202 and welded together. Where layers 302 are embossed, the surfaces that are embossed are combined together. Tab 1204 can be welded to one of metal strips 1202 as is illustrated in the cross-sectional illustration of FIG. 12E. As shown in FIG. 12F, insulating tape 1210 can be applied to each side of strip 1202 and tab 1204 to cover the welds. The insulating tape 1210 extends the full length and end anode 208.

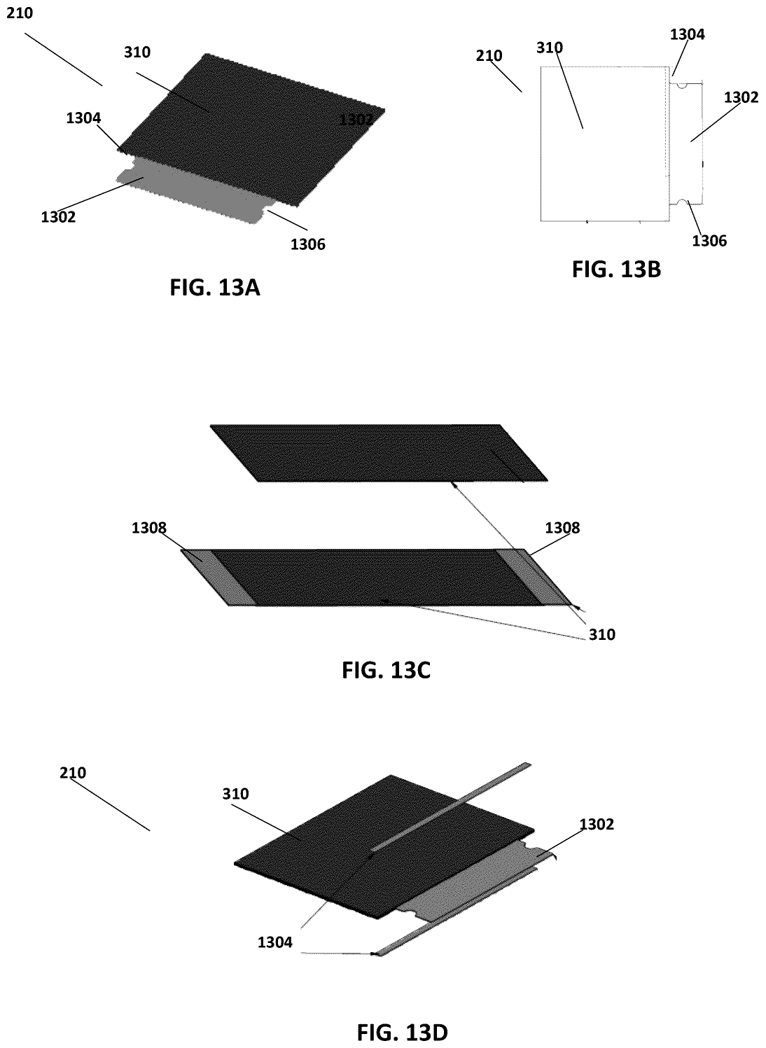

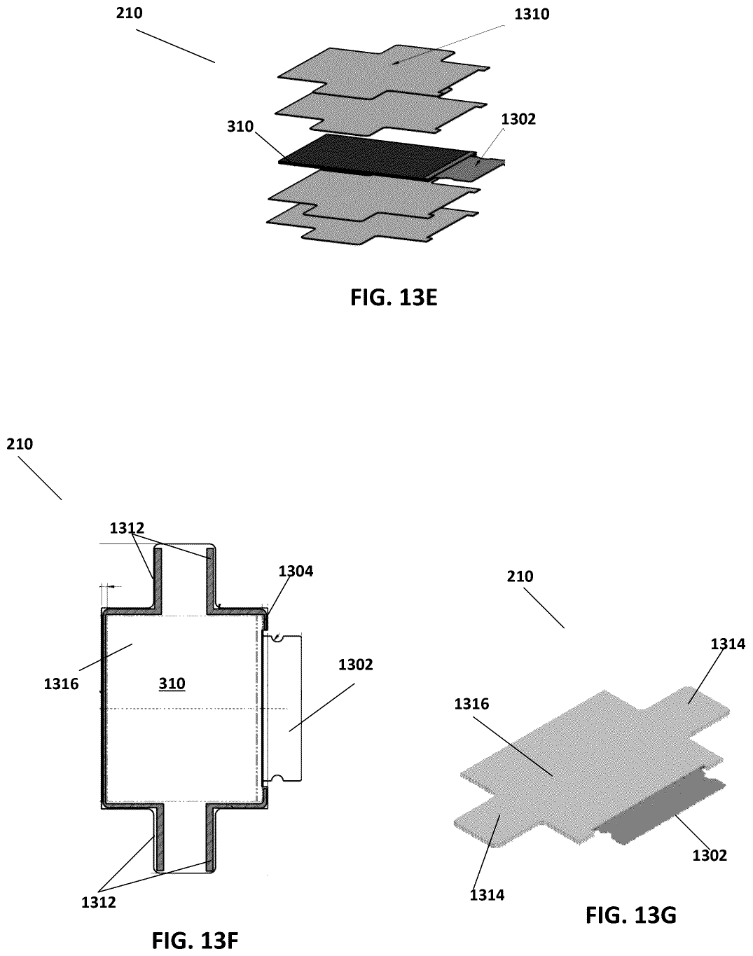

FIGS. 13A through 13D illustrate end cathode 210. As illustrated in FIGS. 13A and 13B, end cathode 210 includes cathode material 310 connected to a single tab 1302. Additionally, in some embodiments, tab 1302 may include multiple tabs that engage with slots of a bridge. As is further illustrated in FIGS. 13A and 13B, tab 1302 can include notches 1306. In some embodiments, a tape 1304 is applied on either side of tab 1302.

FIG. 13C illustrates assembling cathode material 310 with metallic strips 1308. As illustrated, two layers of cathode material 310 is welded on each side with strips 1308. FIG. 13D illustrates welding tab 1302 to metallic strips 1308. Further, tape 1304 can be applied to either side of the tabs 1302.

FIGS. 13E through 13G illustrate encasing end cathode 210 into a separator pouch 1310. In some embodiments, separator material can be placed loosely around cathode 210 instead of forming a separator pouch 1310 and therefore separator pouch 1310 is not formed. As shown in FIG. 13E, two separators 1310 are applied on either side of cathode material 310 as shown. As shown in FIG. 13F, separators 1310 are joined at joins 1312 to form pouch 1316 as illustrated in FIG. 13G. Further, separator pouch 1316 include wicks 1314 to wick electrolyte from the sidewall of a pressure vessel in the finished battery. Consequently, separator layers 1310 are sized to fully encase cathode material 310 while also forming wicks 1314. Further, separator layers 1310 may include notches 1318 that help to form around tab 1302, forming the joint 1312 as illustrated in FIG. 13F. As shown in FIG. 13F, in some embodiments the ends of wicks 1314 may be left open to facilitate electrolyte flow.

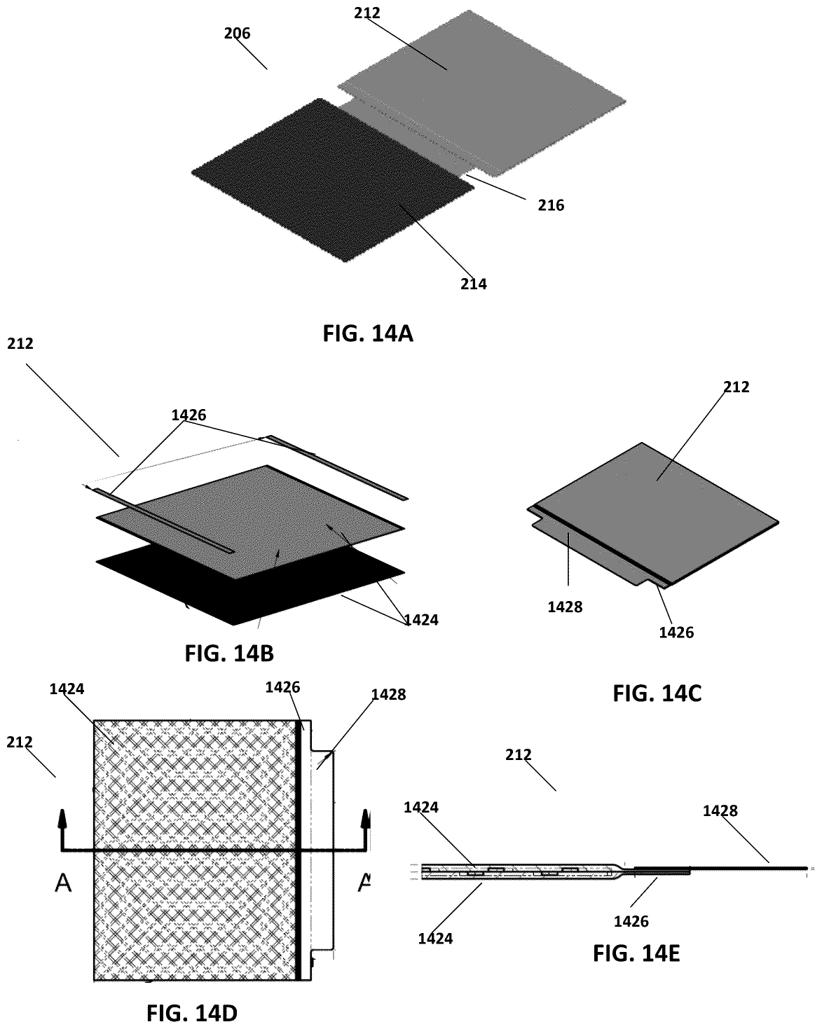

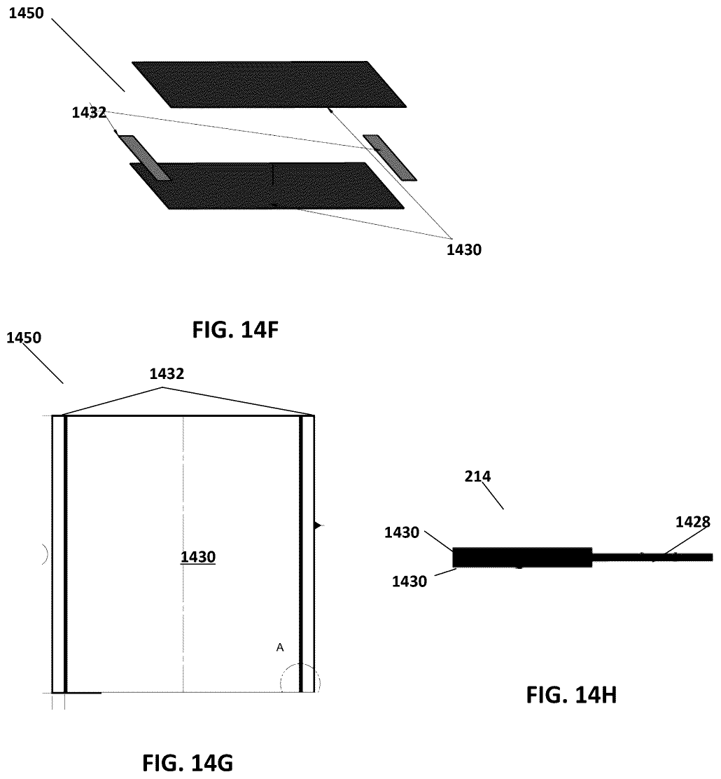

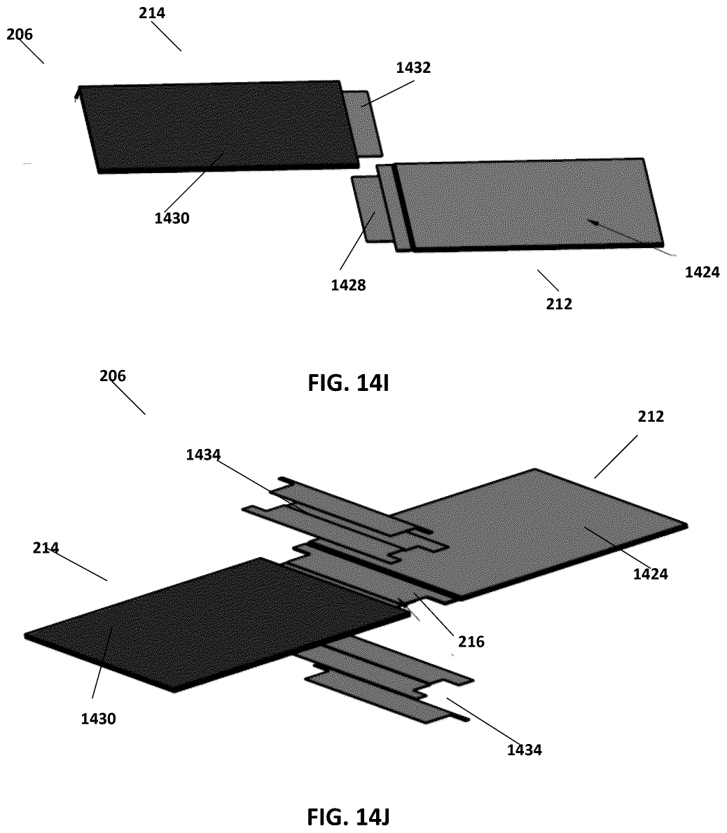

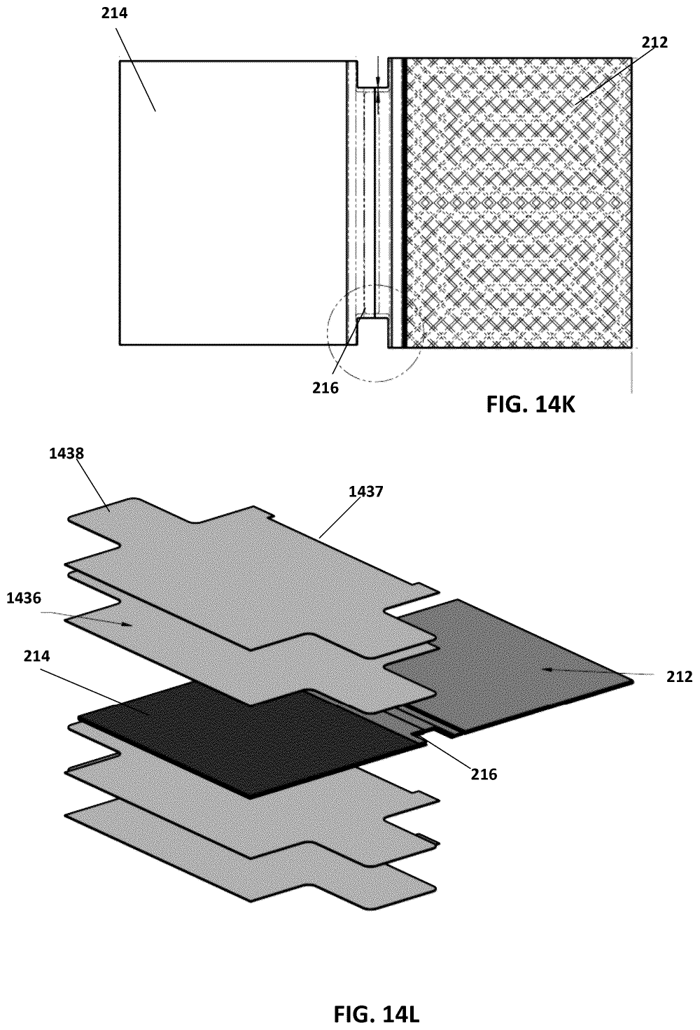

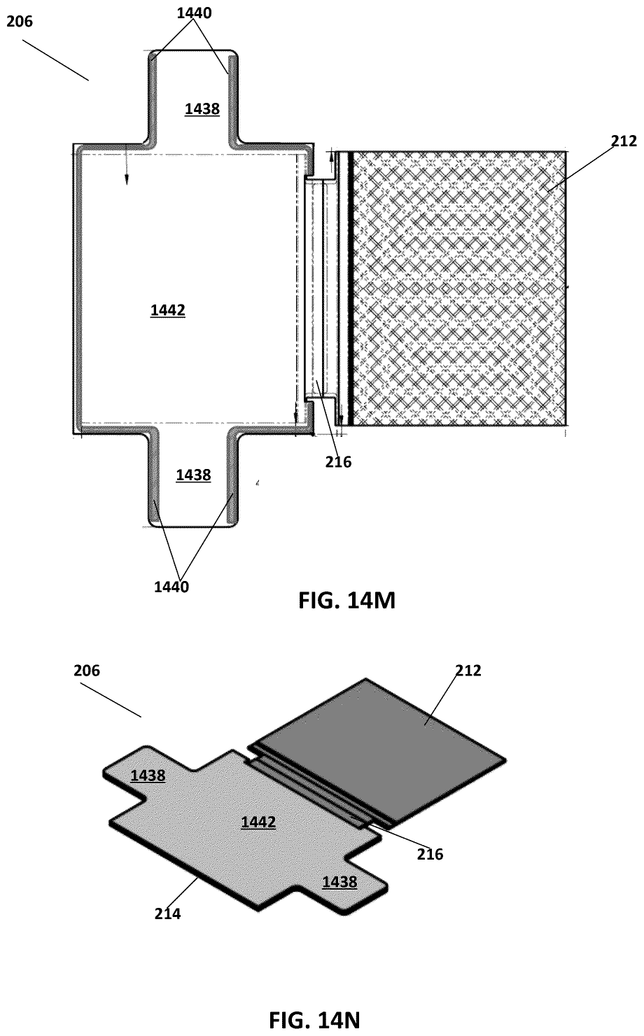

FIGS. 14A through 14N illustrate an example of intermediate anode-cathode 206. As is illustrated in FIG. 14A and discussed above, intermediate anode-cathode 206 includes an anode 212 welded to a cathode 214 through a metal sheet 216. Anode 212 can include the multiple layers 302 as illustrated in FIGS. 3A and 12A through 12F. Cathode 214 includes a cathode material 314, which can be encased in separator material that has wall wicks. Again, the wall wicks can be helpful in alignment as well as functioning to wick electrolyte from the sidewall of a pressure vessel.

FIGS. 14B through 14E illustrate preparation of anode 212 according to some embodiments. As illustrated in FIG. 14B, anode layers 1424 are positioned and welded to metal strips 1426. As discussed previously, anode layers 1424 may be patterned and the patterned surfaces positioned adjacent to one another in anode 212, as is illustrated in FIGS. 14B and 14C. FIG. 14C also illustrates a tab 1428 that is welded to metal strip 1426 to form anode 212. This structure is further illustrated in the planer view of anode 212 in FIG. 14D and the cross-section view along the line A-A illustrated in FIG. 14E.

FIGS. 14F through 14H illustrate preparation of cathode 214 according to some embodiments. FIG. 14F illustrate the cathode layer material 1450 from which cathode 214 is formed. As illustrated in FIG. 14F, cathode layers 1430 are positioned and welded to metallic strips 1432. A planar view of the resulting cathode material is illustrated in FIG. 14G. A cross sectional view of the resulting cathode 214 cut from cathode material 1450 is illustrated in FIG. 14H.

FIGS. 14I through 14K illustrate assembly of intermediate anode-cathode 206 according to some embodiments. As illustrated in FIG. 120, cathode 214 and anode 212 are positioned such that metallic strip 1432 is welded to tab 1428 to form metal sheet 216. In FIG. 14J, tape 1434 can be applied to metal sheet 216 to provide insulation between anode material 1424 and cathode material 1430. FIG. 14K illustrates a planar view of the resulting intermediate anode-cathode 206.

FIGS. 14L through 14N illustrate providing a separator pouch 1442 for cathode 214 of intermediate anode-cathode 206 as illustrated in FIG. 14K. As discussed above, in some embodiments, separator material is loosely stacked around cathode 214 instead of forming a separator pouch 1442. As shown in FIG. 14L, separator material 1436 is positioned about cathode 214. As illustrated, multiple layers of separator material 1436 is cut large enough to form wicks 1438 and positioned to enclose cathode 214. In some embodiments, separator 1436 can include notches 1437 shaped to fit metallic sheet 216. As shown in FIG. 14M, the multiple layers of separator material 1436 are then joined with joints 1440 to form a pouch 1442 with wicks 1438. In some embodiments, separator material 1436 and separator material 1310 may be the same. As shown in FIG. 14M, joints 1440 are formed to the shape of metallic sheet 216. FIG. 14N illustrates the resulting pouched intermediate anode-cathode 206 according to some embodiments.

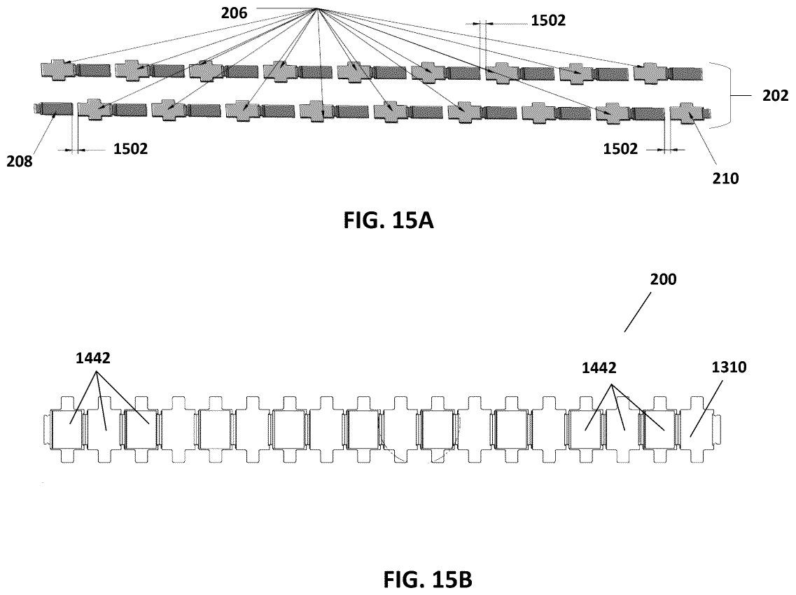

FIGS. 15A and 15B illustrate assembly of a superstack 200 with K repeated units 202. As shown in FIG. 15A, repeated unit 202 is formed by spacing and stack intermediate anode-cathodes 206 with end anodes 208 and end cathodes 210 appropriately. As shown in FIG. 15A, for example, a first layer of unit 202 includes all intermediate anode-cathodes 206 spaced with a spacing 1502 that is substantially the width of metallic sheet 216 of intermediate anode-cathodes 206. The second layer includes an end anode on one end and an end cathode 210 on the opposite end with intermediate anode-cathodes 206 spaced in between. FIG. 15B illustrates a top view, illustrating that separator pouches 1442 and separator pouch 1310 of unit 202 are equally spaced.

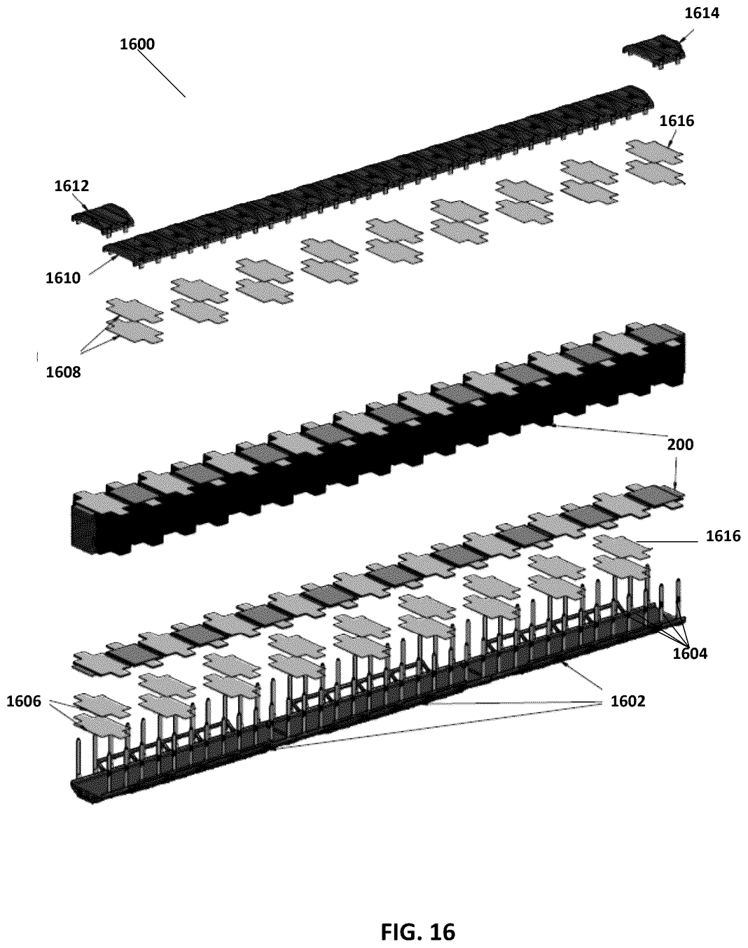

FIG. 16 illustrates construction of a cell train 1600 according to some embodiments. As shown in FIG. 16, cell train 1600 includes a cell tray 1602, onto which cell plate arms 1604 have been welded. Separators 1606 are positioned onto cell tray 1602 in each position. As shown in FIG. 16, separators 1606 are stacked two deep to cover the complete surface of the bottom of cell tray 1602. Separators 1606 can be the same separators described above as separators 1310 used to form pouch 1316 of end cathode 210 or separators 1436 that form pouch 1442 of intermediate anode-cathode 206. As illustrated in FIG. 16, separators 1606 includes notches 1616, which in some embodiments are each positioned to correspond with cathode pouches, e.g. pouches 1316 or 1442.

As is further illustrated in FIG. 16, electrode stack 200 is layered into cell tray 1602 as discussed above with respect to FIGS. 15A and 15B. In some embodiments, the electrodes are produced as discussed with FIGS. 12A through 14N. As indicated in FIG. 16, two more layers of separators 1608 are placed over electrode stack 200. Again, separators 1608 can be the same separators as separators 1310 or 1436 described above. Again, each of separators 1608 includes notches 1616 that are aligned with those of separators 1310 and 1436 in electrode stack 200.

As is further illustrated in FIG. 16, a cell plate 1610 is positioned over separators 1608. End plates 1612 and 1614 are also provided over separators 1608 on opposite sides of cell plate 1610. Once assembled, cell train 1600 can be placed in a press and compressed to a particular pressure and arms 1604, which had been welded to cell tray 1602, can be welded under pressure to end plates 1612 and 1614 and cell plate 1610. In some embodiments, cell plate 1610 can be separated plates that are individually connected under pressure.

In some embodiments, cell tray 1602, cell plate 1610, and end plates 1612 and 1614 can be overmolded components. In accordance with the overmolding process, cell tray 1602, cell plate 1610, and end plates 1612 are formed by injection molding a material over a sufficiently rigid substrate. The rigid substrate can be any substance with sufficient structural integrity and corrosion resistance, for example stainless steel, aluminum, copper, nickel, other metallic material, or other sufficiently rigid material. Stainless steel, for example, offers good rigidity and corrosion resistance, however any sufficiently rigid and corrosion resistant material that can be easily joined with other materials during assembly can be used. A wide variety of insulating materials can be used for the injection molding material. For example, acrylonitrile Butadiene Styrene (ABS), Nylon, high-density polyethylene (HDPE), low-density polyethylene (LDPE), polycarbonate (PC), polyoxymethylene (POM), Acrylic Poly (methyl methacrylate) (PMMA), Thermoplastic polyurethane (TPU), thermoplastic rubber (TPR), Polypropylene (PP), or other suitable material. Alternatively, a rigid composite or high-performance polymers can be used, e.g. Garolite and polysulfone.

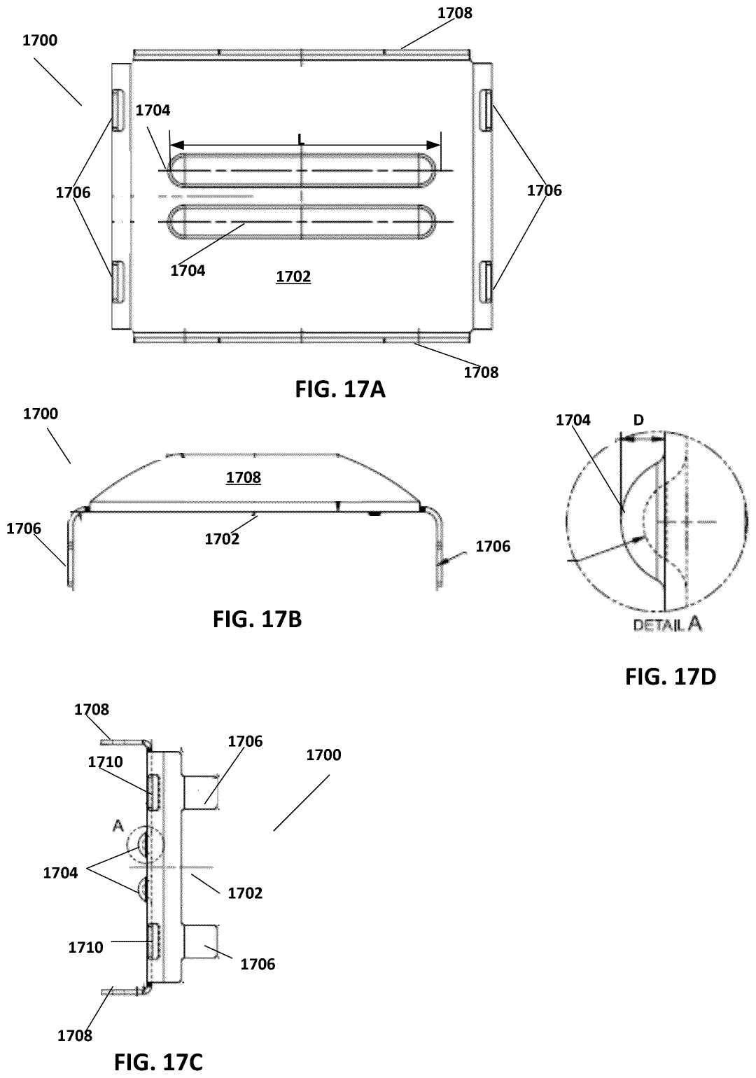

FIGS. 17A through 17D illustrates an example of a base cell plate 1700 according to some embodiments. Base cell plate 1700 can be used as a substrate in an overmolding process to produce various components of cell train 1600 as illustrated in FIG. 16. As shown in FIGS. 17A through 17D, base cell plate 1700 can be formed of a metal, for example stainless steel.

FIG. 17A illustrates a planar view of base cell plate 1700. As shown in FIG. 17A, base cell plate 1700 includes a base 1702, which is sized accordingly to accommodate an intermediate anode-cathode 206 as discussed above. As illustrated, tabs 1706 are formed on two sides of base 1702. Tabs 1706 are vertically oriented with respect to base 1702 and include two taps 1706 on each side. As is discussed further below, tabs 1706 will be used to construct cell train 1600 with arms 1604 being eventually connected to tabs 1706.

FIG. 17A also illustrates supports 1708 which are extended vertically opposite the direction of tabs 1706 and positioned on opposite sides than that of tabs 1706. In other words, tabs 1706 are positioned two on each of one set of opposite sides of base 1702 while supports 1708 are positioned on the other set of opposite sides of base 1702. As shown in FIG. 16, base cell plate 1700 is oriented in cell train 1600 such that tabs 1706 are along the side (i.e. oriented in the direction between the cathode and anode of intermediate anode-cathode 206) while supports 1708 are oriented perpendicular to the direction defined by intermediate anode-cathode 206.

FIG. 17A further illustrates that features 1704 can be formed in base 1702. Feature 1704 is formed in the material of base 1702 that function to provide additional strength to base cell plate 1700. As shown in FIG. 17A, feature 1704 can be two parallel elongated indentations made in base 1702.

FIG. 17B illustrates a side view of base cell plate 1700 from the view of supports 1708. As illustrated in FIG. 17B, supports 1708 are shaped partially in a hemispherical shape to eventually mate with a liner as is discussed further below. Additionally, tabs 1706 are illustrated as extending from the sides of base 1702. It should be noted that base cell plate 1700 can be formed from a single sheet of metallic material or may be formed as individual components that are welded to base 1702.

FIG. 17C illustrates a side view of base cell plate 1700 as illustrated in FIG. 17A from the view of tabs 1706. As illustrates, base cell plate 1700 shows two separated tabs 1706 that are extended through base 1702. Tabs 1706 can be coupled to a mount 1710 to facilitate stacking and improve ease of handling and packaging. Supports 1708 extend from base 1702 in a direction opposite that of tabs 1706 and positioned on sides of base 1702 that opposite the side from which tabs 1706 extend. Further, features 1704 are illustrated extending from the bottom of base 1702 (on the side from which supports 1708 extend) and run parallel with supports 1708. As illustrated in FIGS. 17A through 17D, tabs 1706 and supports 1708 extend at right angles from base 1702. FIG. 17D illustrates a cross section of features 1704, illustrating a semicircular indent in base 1702, that as shown in FIG. 17A extend at least partially across base 1702.

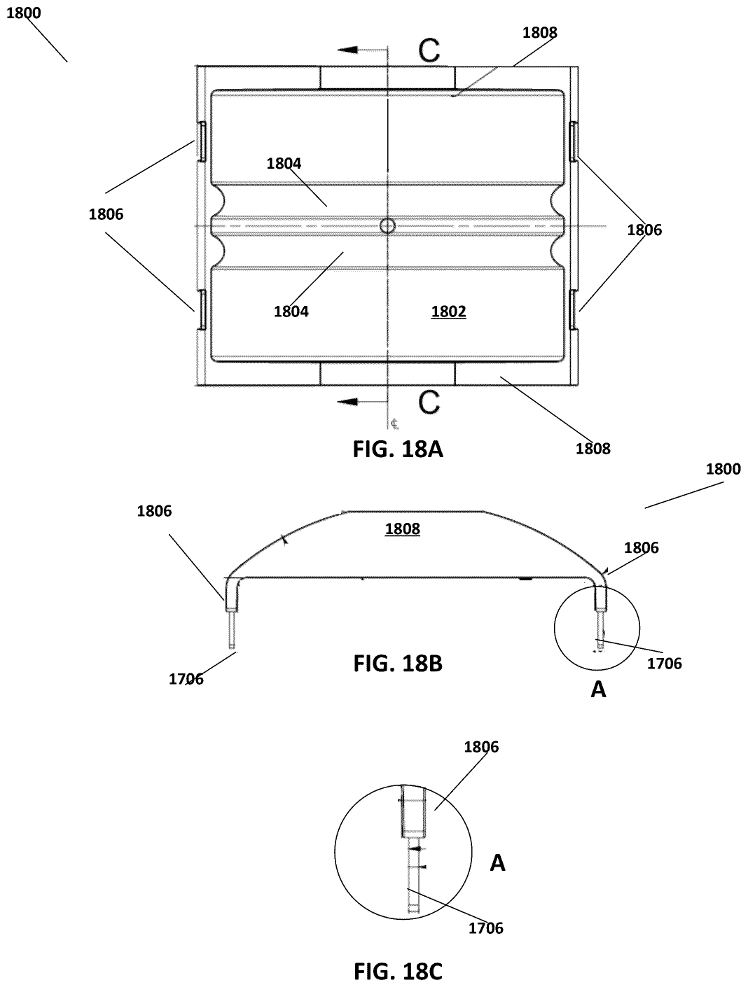

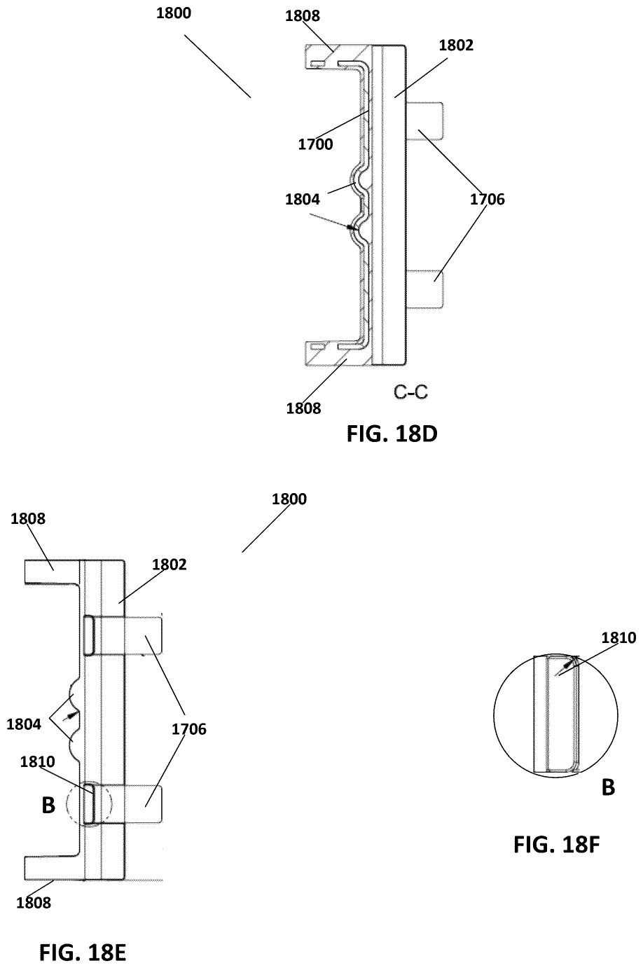

FIGS. 18A through 18F illustrate an example of an overmolded cell plate 1800. As discussed above, overmolded cell plate 1800 can be formed by injection molding using cell plate 1700 as a substrate. As such, many of the features illustrated in cell plate 1700 are continued into overmolded cell plate 1800.

FIG. 18A illustrates a planar view of an example overmolded cell plate 1800 according to some embodiments. The features illustrated in overmolded cell plate 1800 can be formed by injection molding over cell plate 1700. In some examples, the injection molding material is HDPE. Molding thickness can be adjusted to result in an appropriately sized overmolded cell plate 1800.

As illustrated in FIG. 18A, overmolded cell plate 1800 includes a base 1802, features 1804, tabs 1806, and supports 1808. FIG. 18B illustrates a side view of overmolded cell plate 1800 in the direction of supports 1808 and illustrates side support 1808 and tabs 1806. As is illustrated, supports 1808 are shaped in a curved fashion with a flat top that conforms to support 1708 as illustrated in FIG. 17B. The injection molding over tabs 1706 to form 1806 is arranged to leave a length of tabs 1706 exposed to be used for attachment of further supports. This is also shown in FIG. 18C, which illustrates one of tabs 1806 (shown in circle A of FIG. 18B) and the exposed nature of a length of tab 1706.

FIG. 18D illustrates a cross-sectional view of overmolded cell plate 1800 along the direction C-C as illustrated in FIG. 18A. Consequently, cell plate 1700 is illustrated. Further, features 1804 are filled by injection molding to provide for a flat base 1802 on which components of stack 200 can be supported.

FIG. 18E illustrates a side view of overmolded cell plate 1800 looking at tabs 1802. As such features 1804 are illustrated along with the resulting flat base 1802. Supports 1808 are also illustrated, along with the mount 1810, which is shown in more detail in FIG. 18F. Mount 1810 is overmolded from mount 1710 that is used to connect tab 1706 and can help to facilitate stacking and ease handling and packaging.

Multiple ones of overmolded cell plate 1800 can be positioned in series (with supports 1808 adjacent to one another) to form cell plate 1610 as illustrated in FIG. 16. As such, during a compression step each overmolded cell plate 1800 in cell plate 1610 can be individually compressed to a prescribed pressure.

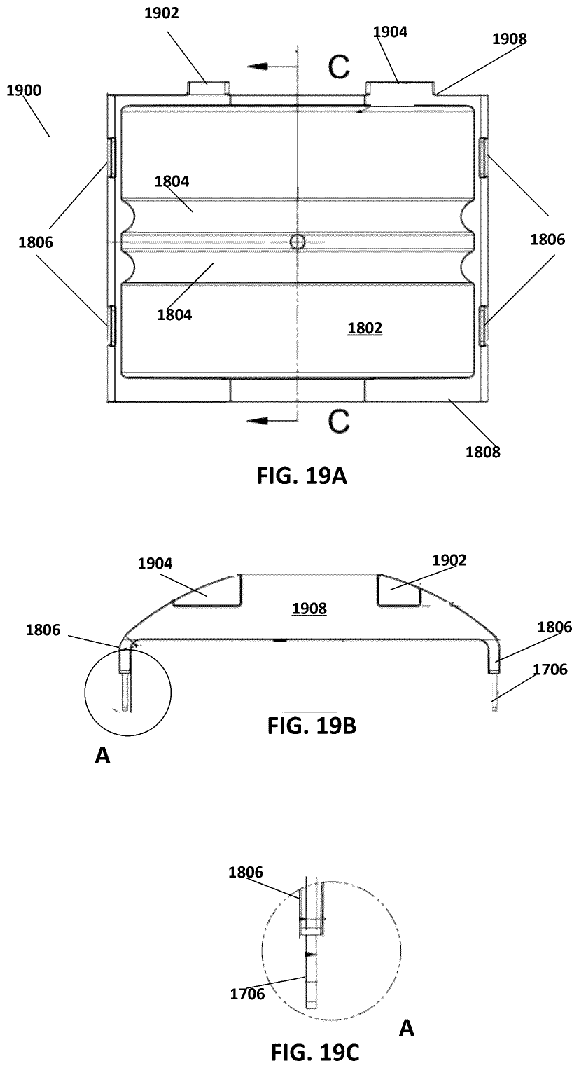

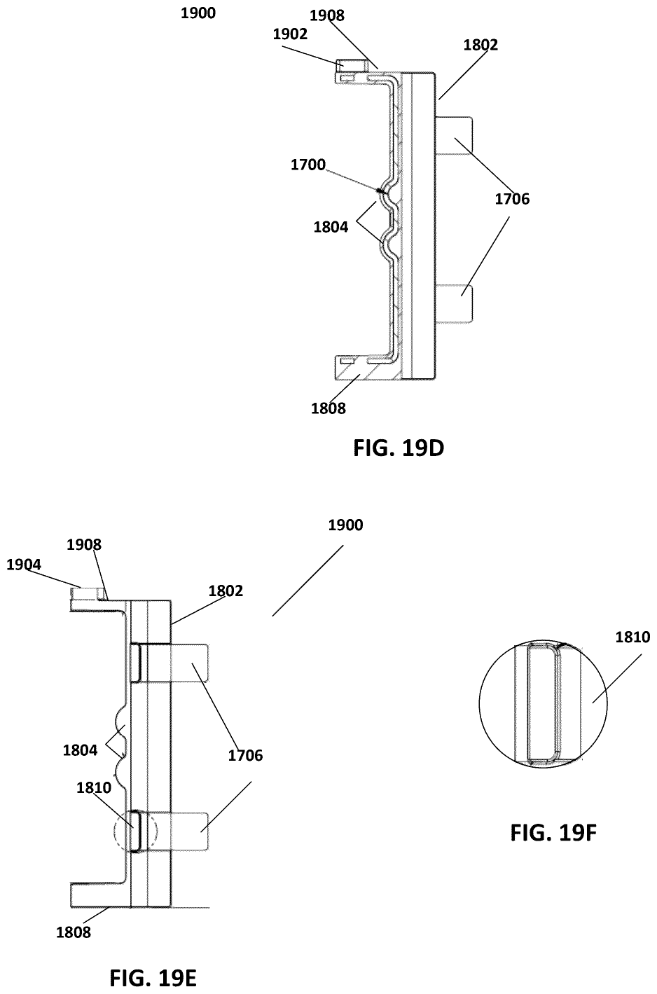

FIGS. 19A through 19F illustrate an example of overmolded end cell plate 1900 according to some embodiments. End cell plate 1900 can be as end plates 1612 and 1614 as illustrated in FIG. 16. As is illustrated, overmolded end cell plate 1900 includes cell plate 1700 as a substrate in the overmolding process. As is further illustrated in FIGS. 19A through 19F, overmolded end cell plate 1900 include most of the elements of cell plates 1800 as illustrates in FIGS. 18A through 18F. However, one of supports 1808 in cell plate 1800 is replaced with a support 1908 having protrusions 1902 and 1904 as illustrated in FIG. 19A. Protrusions 1902 and 1904 assist in aligning the resulting cell train 1600 with bridge structures.

FIG. 19A illustrates a planar view of overmolded end cell plate 1900, which includes tabs 1806, features 1804, base 1802, and one support 1808. Overmolded end cell plate 1900 however includes support 1908 opposite support 1808. Support 1908 includes protrusions 1902 and 1904. Protrusions 1902 and 1904 in some embodiments may be substantially the same, however in some embodiments they are different sizes to accommodate better alignment when assembled with cell plate 1610 as illustrated in FIG. 16. This asymmetry can also facilitate the use of material handling cassettes in which cell plate 1900 can be reliably inserted in a defined direction.

FIG. 19B illustrates a side view of overmolded end cell plate 1900 looking at support 1908. As illustrated, protrusions 1904 and 1902 are extending from the surface of cell plate 1908 and are different sizes. FIG. 19B illustrates that, in the overmolding process, tabs 1806 are not fully overmolded so that tab 1706 from cell plate 1700 is exposed. FIG. 19D illustrates a cross-sectional view of overmolded end cell plate 1900 as illustrated by cut C-C in FIG. 19A. FIG. 19D further illustrates protrusion 1902. FIGS. 19E and 19E further illustrate a side view of overmolded end cell plate 1900, illustrating protrusion 1904.

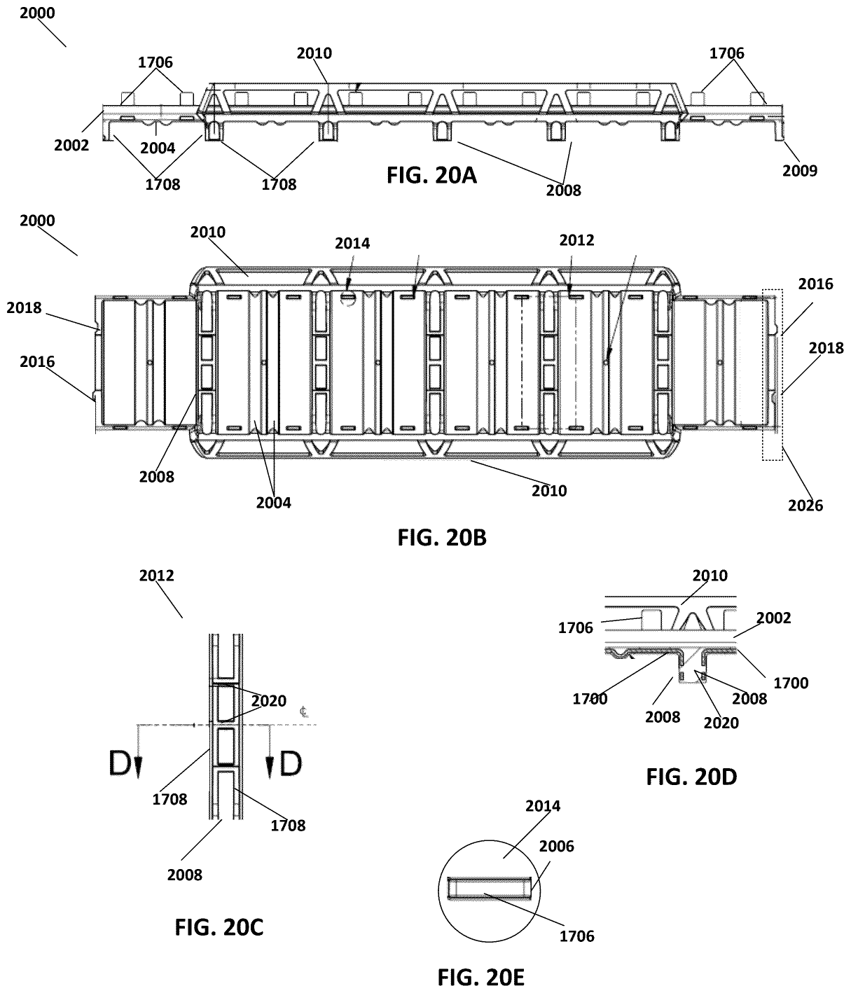

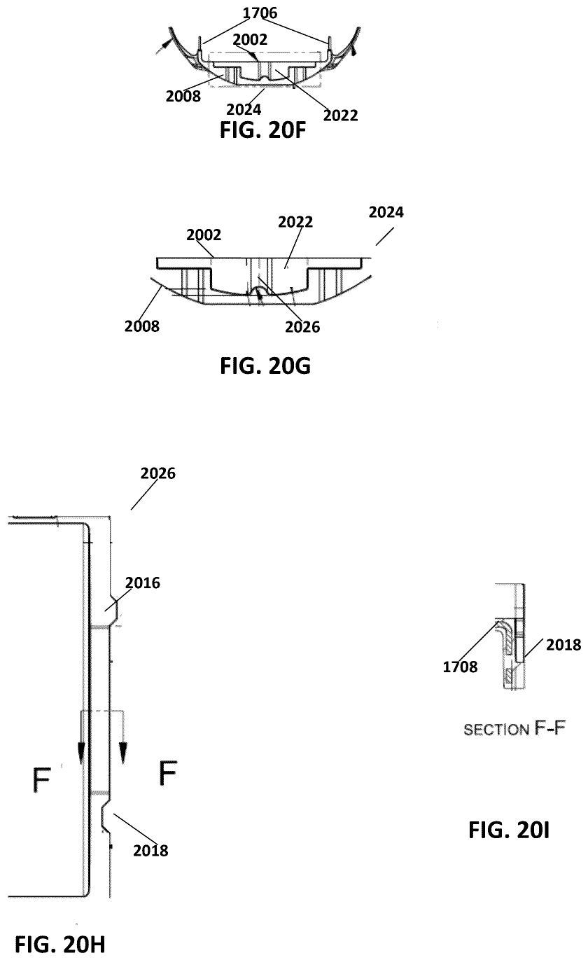

FIGS. 20A through 20I illustrate an example of an overmolded cell tray 2000. Overmolded cell tray 2000 may be utilized as cell tray 1602 as illustrated in FIG. 16. As illustrated in FIG. 20A, overmolded cell tray 2000 includes a number of cell plates 1700 arranged such that supports 1708 of adjacent cell plates are separated by an appropriate distance corresponding to the separation between adjacent electrodes in stack 200 as illustrated in FIG. 16. Injection molding, for example with HDPE, is then used to overmolded the arrangement of cell plates 1700 to form overmolded cell tray 2000. As illustrated in FIG. 20A, cell tray 200 includes overmolded supports 2008, features 2004, structure 2010, with exposed tabs 1702.

FIG. 20A illustrates a side view of overmolded cell tray 2000 while FIG. 20B illustrates a planar view of the bottom (i.e. looking at supports 2008) of cell tray 2000. As is illustrated, cell tray 2000 includes exposed tabs 1706, supports 1708 with pairs of adjacent supports 2008 being connected through the overmolding. A support structure 2010 is provided to hold the array of cell plates 1700, after overmolding. Each end of cell tray 2000 includes a lone overmolded support 2009 that is formed with support 1708 from cell plate 1700. The ends are further provided with structures 2016 and 2018, which are provided for alignment with further components. As is further illustrated, a flat base 2002 is provided by overmolding over features 1704 to form features 2004 to support electrode stack 200 as illustrated in FIG. 16.

Overmolded support structure 2010 provides structural support and can be curved and provide structural support between adjacent ones of cell plates 1700. The curvature is provided to fit within a liner, which is discussed further below. Portions of support structure 2010 are joined to the overmolding on each of cell plates 1700. It is further noted that structure 2010, although affixed to the overmolding on cell plates 1700 on the ends of overmolded cell tray 200, does not extend the full length of cell tray 2000 and leaves both ends of overmolded cell tray 2000 open.

FIG. 20C further illustrates the supports 2008, specifically at portion 2012 indicated in FIG. 20B. As illustrated in FIG. 20C, support 2008 is formed with two adjacent supports 1708 with overmolded separators 2020. The separation formed is consistent with the width of metallic sheet 216 in the intermediate anode-cathode 206. FIG. 20D illustrates a cross-sectional view along the direction D-D as illustrated in FIG. 20C. As illustrated, adjacent cell plates 1700 are overmolded to form support 2008 with separator 2020. Further, support structure 2010 is illustrated and formed as part of base 2002. Further, tabs 1702 remain exposed. FIG. 20E illustrates portion 2014 as illustrated in FIG. 20B, showing tab 1706 as extending through to the bottom of overmolded cell tray 2000 and being overmolded to form tab 2006, which facilitates tacking and improves the ease of handling and packaging.

FIGS. 20F and 20G illustrate an end view of overmolded cell tray 2000. As illustrated, a mounting structure 2022 includes a mounting hole 2026. This structure facilitates the mounting of end conductors as is further illustrated below.

FIG. 20H illustrates an end view 2026 of overmolded cell tray 2000 as illustrated in FIG. 20B. FIG. 20H illustrates with more detail structures 2016 and 2018 that can be formed. As illustrated, structure 2016 can be a protrusion and structure 2018 can be an indentation. As is further discussed below, the location of structures 2016 and 2018 are reversed on opposite sides of overmolded cell tray 2000 so that multiple overmolded cell trays 2000 can be aligned to form a cell train 1600 as illustrated in FIG. 16. FIG. 20I illustrates a cross-sectional view along the direction F-F as illustrated in FIG. 20H.

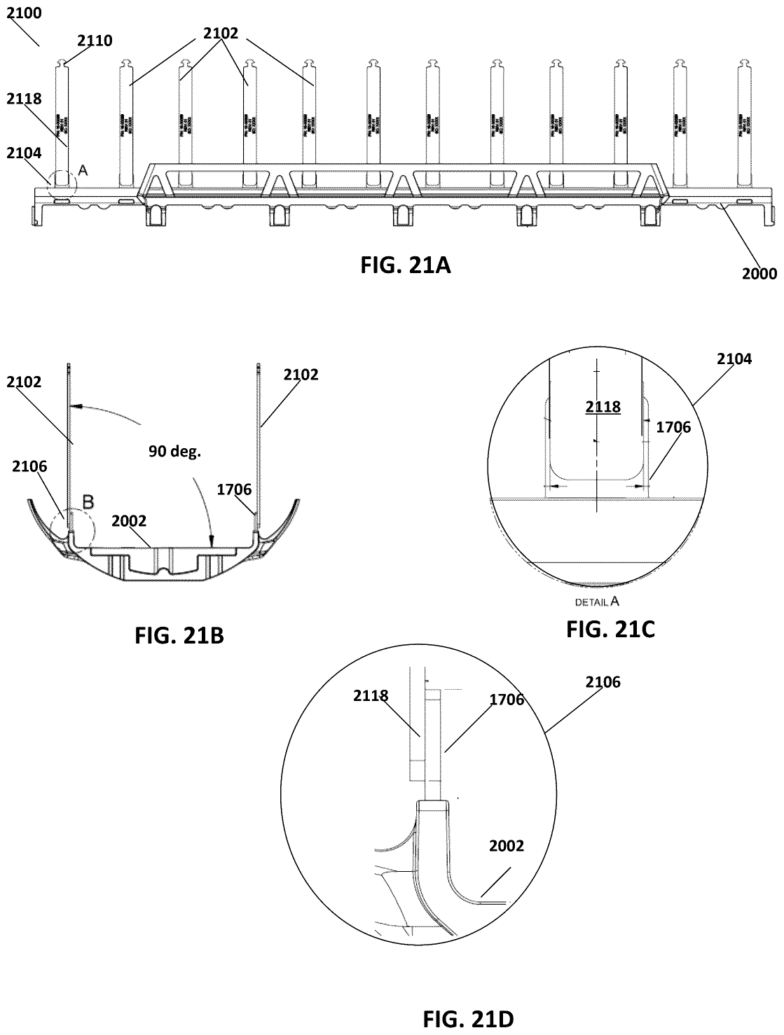

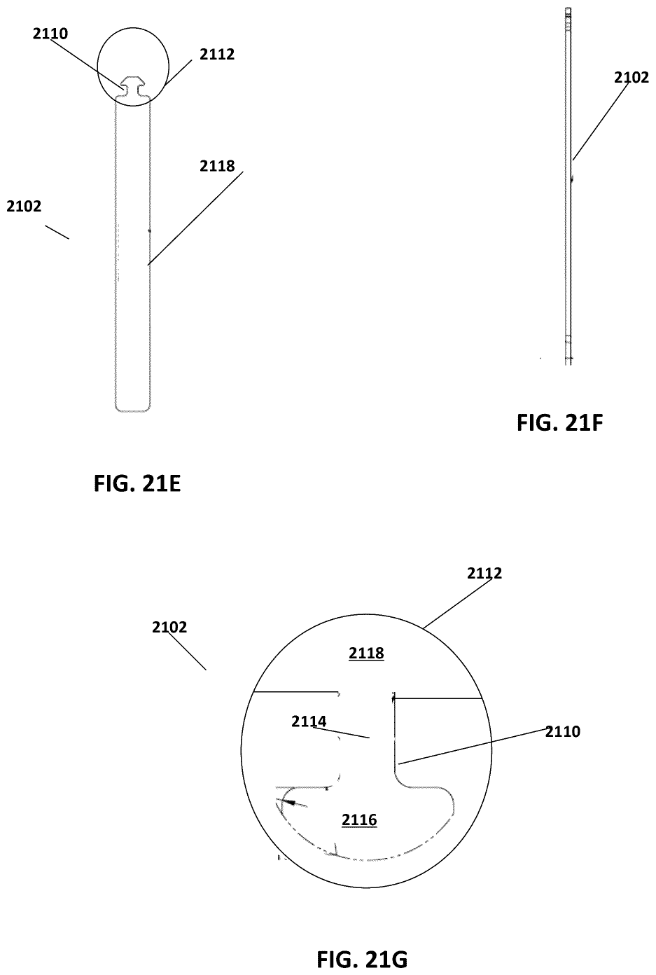

FIGS. 21A through 21G illustrate an example of formation of a cell tray 2100 according to some embodiments. As illustrated in FIG. 21A, a plurality of cell plate arms 2102 are welded to tabs 1706 of overmolded cell tray 2000 as described above in FIGS. 20A through 20H. Cell plate arms 2102 are described below with respect to FIGS. 21E through 21G. As shown in FIG. 21E, cell plate arm 2102 includes a shaft portion 2118 and a tip 2110. As shown in FIG. 21A, cell plate arm 2102 is welded to each of exposed tabs 1706 by the shaft portion 2118. Each of cell plat arms 2102 are aligned to be parallel.

FIG. 21B illustrates an end view of cell tray 2100. As is illustrated in FIG. 21B, each of cell plate arms 2102 is welded to tab 1706 such that it extends perpendicularly from the surface of base 2002. FIG. 21C illustrates portion 2104 as illustrated in FIG. 21A and illustrates that the width of shaft portion 2118 is slightly smaller than the width of tab 1706 and that shaft portion 2118 is welded centered onto tab 1706. FIG. 21D illustrates a view 2106 as illustrated in FIG. 21B and further illustrates how shaft portion 2118 is welded to tab 1706 on the side of tab 1706 opposite the base 2002 of overmolded cell tray 2000.

FIGS. 21E through 21G further illustrate an example of cell plate arm 2102. As discussed above, and further illustrated in FIG. 21E, cell plate arm 2102 includes a shaft portion 2118 and a tip 2110. FIG. 21F illustrates that cell plate arm 2102 can be formed from a plate of metallic material, for example stainless steel. FIG. 21G further illustrates view 2112 illustrated in FIG. 21E. View 2112 further illustrates tip 2110. As shown in this example, tip 2110 includes a narrow shaft 2114 that couples shaft portion 2118 to a semicircular connector 2116. Tip 2110 is used, as discussed below, to connect further components.

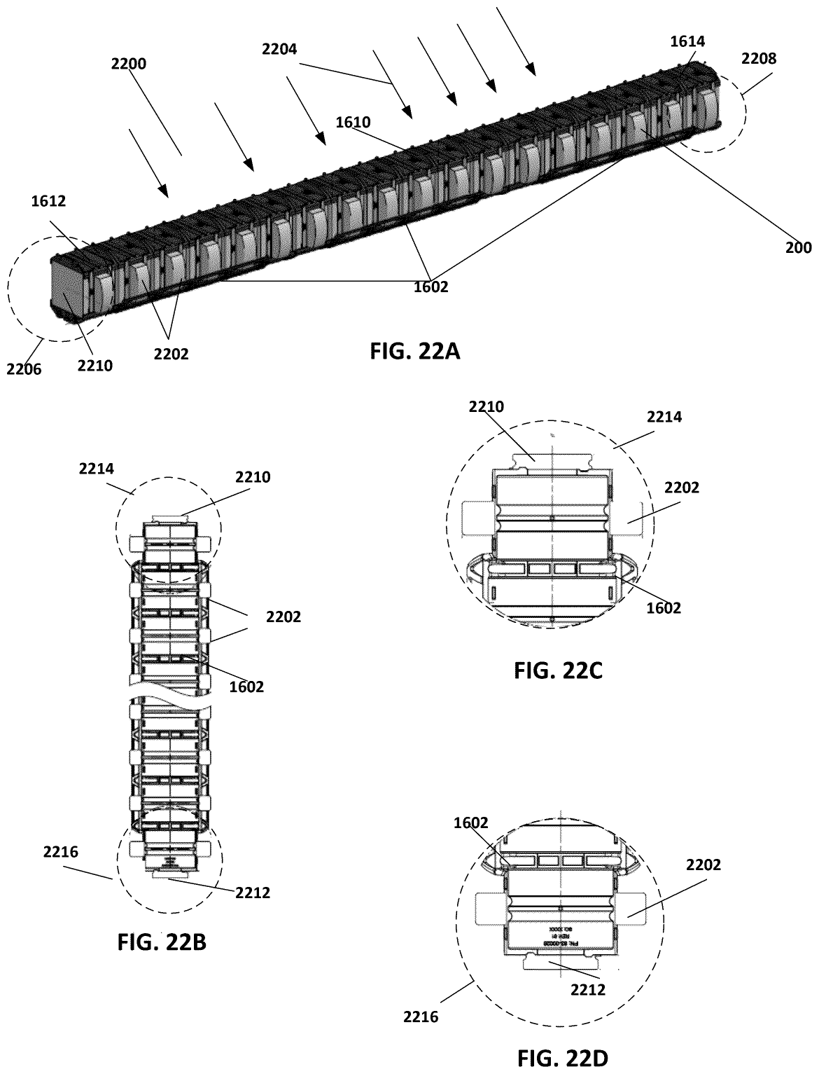

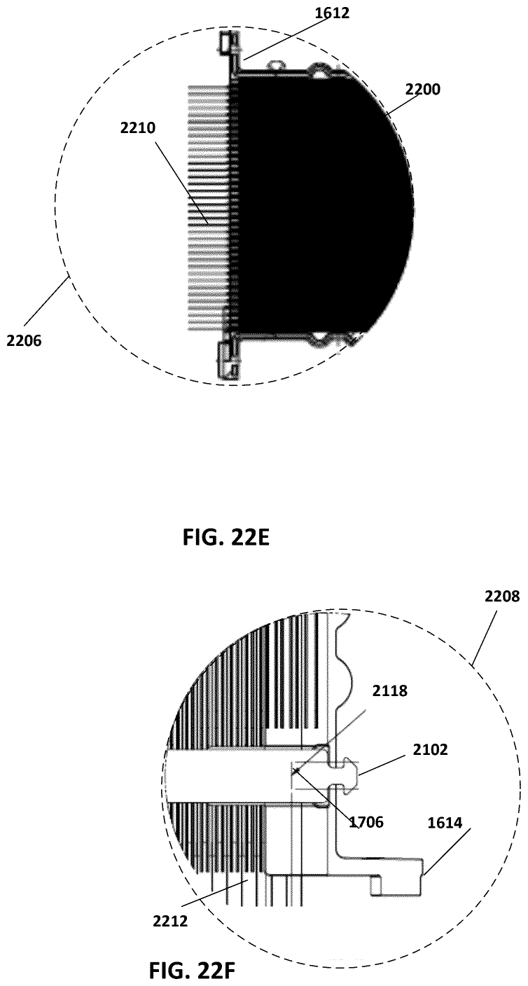

FIGS. 22A through 22F illustrate assembled cell train 2200, which is the completion of cell train 1600 as illustrated in FIG. 16. As illustrated in FIG. 22A, cell train 2200 includes a cell tray 1602, which can be one formed from one or more cell trays 2100 as illustrated in FIGS. 21A through 21G using the overmolded cell trays 2000 as illustrated in FIGS. 20A through 20I. Cell train 2200 also includes end plates 1612 and 1614 positioned on either end as well as cell plate 1610. As discussed above, each of end plates 1612 and 1614 can be overmolded end plate 1900 as illustrated in FIGS. 19A through 19C. Further, cell plate 1610 can be formed from positioning one or more overmolded cell plates 1800 as illustrated in FIGS. 18A through 18F. Some embodiments may use all metallic parts instead of the overmolded components as described here.

As is further illustrated, superstack 200 is arranged on cell train 1602 along with extra layers of separators 1606 and 1608 as illustrated in FIGS. 15A and 15B and FIG. 16. As discussed, superstack 200 includes intermediate anode-cathodes 206, end anodes 208, and end cathodes 210 as described above.

Each end anode 208 includes a single tab 1204 which each end cathode 210 includes a single tab 1302. The cathode portion of intermediate anode-cathodes 206 and end cathodes 210 all include a separator pouch with wicks 1438 and 1314, respectively. Wicks 2202 as illustrated in FIG. 22A are stacked ones of wicks 1438 and 1314 along with wicks that are formed on separators 1606 and 1608.

Once all of the components are stacked as illustrated in FIG. 22A, cell train 2200 is placed into a press and pressure is applied for compression. Cell plate arms 2102 then align with tabs 1706 that are exposed on overmolded end plates 1900 and on overmolded cell plates 1800 and welded into place under pressure P or compressed to a particular thickness, as is further discussed below with respect to FIG. 22F. As is indicated in FIG. 22A, each of end plates 1612 and 1614 and the individual parts of cell plate 1610 can be separately or collectively pressed with a specified force 2204 or to a specified height.

FIG. 22B illustrates a planar view from the top of cell tray 1602 of cell train 2200. As illustrated in FIG. 22B, tabs 2210 is illustrated on one side while tabs 2212 are illustrated on the other side. One of tabs 2210 and 2212 are the stacked ones of end cathode tabs 1302 or end anode tabs 1204 as discussed above. FIG. 22C further illustrates area 2214 illustrated in FIG. 22B. As illustrated, tabs 2210 is a single tab structure as discussed above. FIG. 22D further illustrates area 2216 illustrated in FIG. 22B. Again, tabs 2212 can be single tab structures, or in some embodiments tabs 2212 can include multiple individual tabs. FIG. 22E illustrates area 2206 as illustrated in FIG. 22A and further illustrates the stacking of tabs 2210.

FIG. 22F illustrates area 2208 as illustrated in FIG. 22A. As illustrated in FIG. 22F shaft portion 2118 of cell arm 2102 is welded to tab 1706 of end cell plate 1614. Further, tabs 2212 are illustrated.

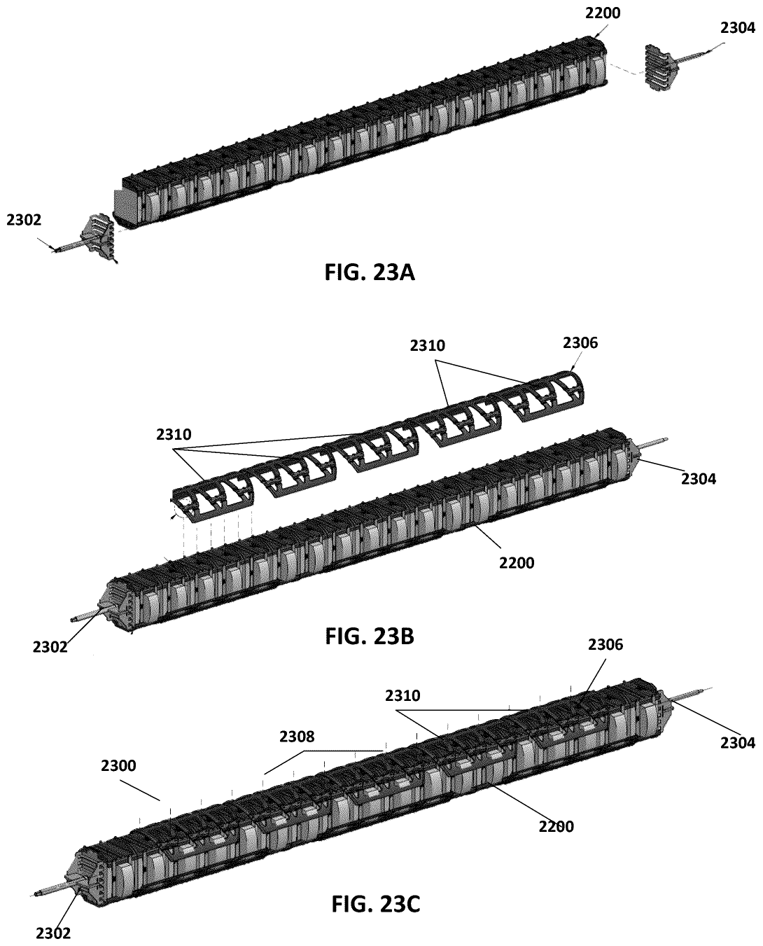

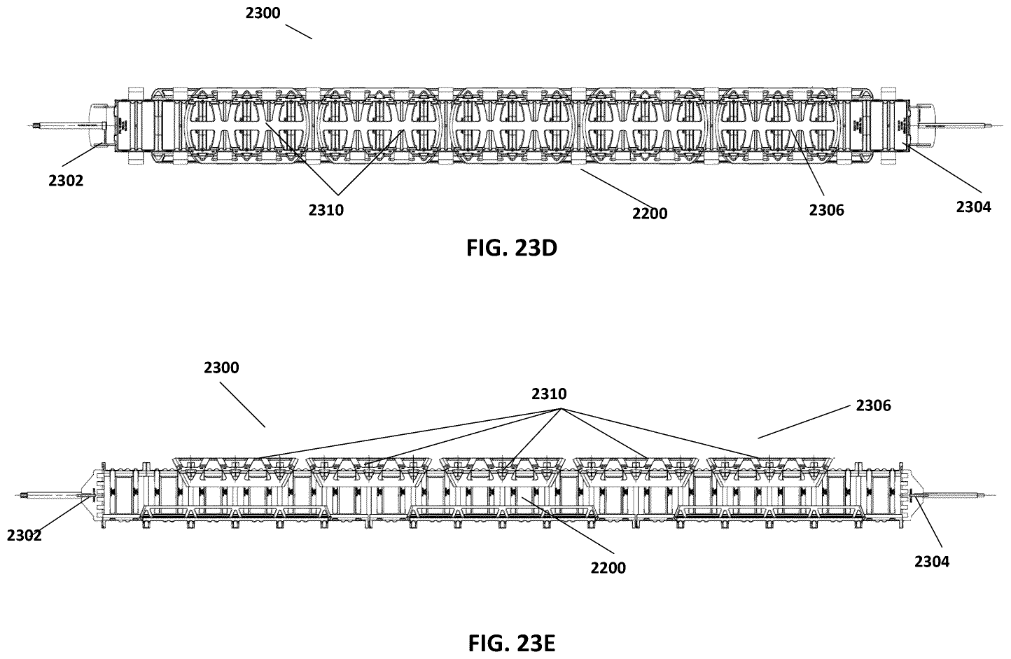

FIGS. 23A through 23E illustrates the assembled cell train 2300 according to some embodiments of the present disclosure. As illustrated in FIG. 23A, bridges 2302 and 2304 are attached to cell train 2200. Cell train 2200 was described with respect to FIGS. 22A through 22F. As is discussed previously, tabs 2210 and 2212 on cell train 2200 are extended through slots of bridges 2302 and 2304, respectively, and welded into place. Bridges 2302 and 2304 can be fixed to cell train 2200. Bridges 2302 and 2304 are discussed further below.

FIG. 23B illustrates installation of a top brace 2306 according to some embodiments. Top brace 2306 can be formed from one or more split top braces 2310, which will be discussed below. FIG. 23C illustrates top brace 2306 attached to cell train 2200. In some embodiments, pins 2308 can be inserted through top brace 2306 to further attach to cell train 2200. FIGS. 23D and 23E illustrate line drawings of a top view and side view, respectively, of assembled cell train 2300.

The frame structure of cell train 2200, illustrated in FIGS. 23A, 23D, and 23E, using overmolded parts as described above provides advantage over the frame structure 400 as illustrated in FIG. 4B. First, the resulting battery structure requires far fewer parts for assembly, reducing the overall costs. In some cases, the number of parts is reduced from 214 to 98. Further, overall assembly is much simplified. Additionally, there is increased electrical isolation between stack 200 and the frame structure of cell train 2200. Additionally, the inner diameter of the cell train 2200 can be increased resulting in a reduction in internal pressure, the accommodation of a larger superstack 200, and further increases the clearance between the majority of cell train 2200 and the walls of a liner of the pressure vessel.

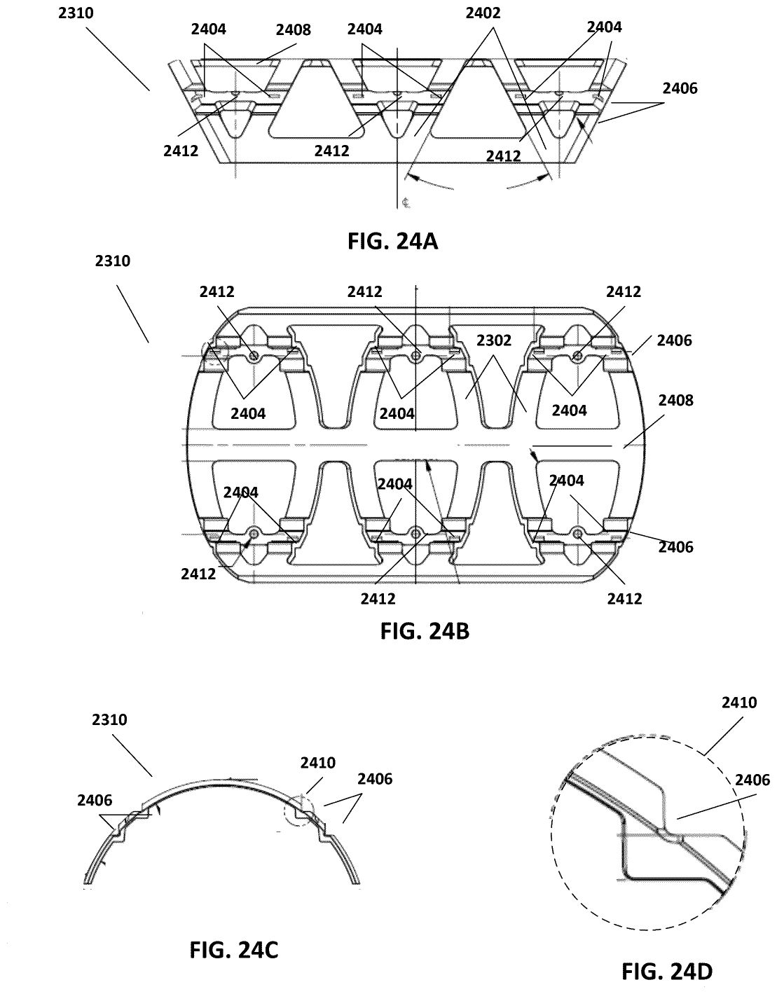

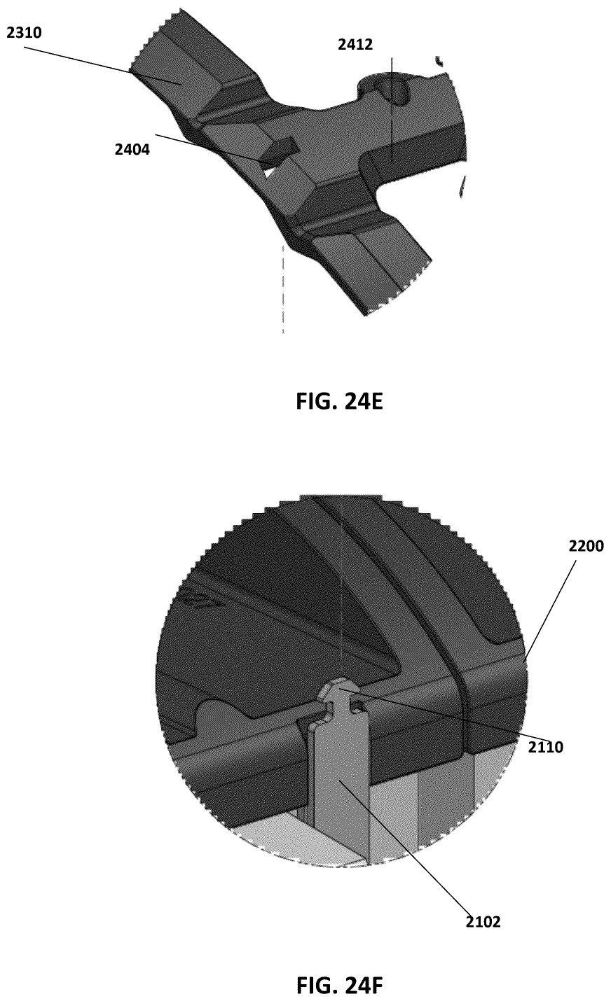

FIGS. 24A through 24F illustrates a split top brace 2310 that can be attached to adjacent tips 2110 of cell plate arms 2102 on the cell plate 1610 of cell train 2200 as illustrated in FIGS. 23A through 23E. Split top brace 2310 can be formed by injection molding using any suitable material, for example HDPE. FIG. 24A illustrates a side view of split top brace 2310 and FIG. 24B illustrates a top view of split top brace 2310.

As shown in FIGS. 24A and 24B, split top brace 2310 is a structural support formed with support structures 2402 that can have angled supports and a top and side braces 2408. Further, mounting structures 2404 are formed to engage with tips 2110 of cell plate arms 2102. Additional mounting structure 2412 are also formed to accommodate pins 2308, which may be screws, as shown in FIG. 23C. Further, handling structures 2406 can be formed that allows for subsequent convenient handling of the combination of cell train 2200 with top brace 2306, which is formed from one or more split top braces 2310 as illustrated in FIG. 23B.

FIG. 24C illustrates an end view of split top brace 2310 and further illustrates handling structures 2306. FIG. 24D illustrates in further detail the area 2410 illustrated in FIG. 24C. As shown, handling structures 2406 provide for indents in the surface of split top brace 2310 that allow easy gripping (using the structures on both sides of split top brace 2310) and handling with split top brace 2310.

FIGS. 24E and 24F illustrate attaching split top brace 2310 to cell train 2200. As illustrated in FIGS. 24E and 24F, mounting structures 2404 engages with tips 2110 of cell plate arms 2102 to fix each of split top braces 2310 to cell train 2200.

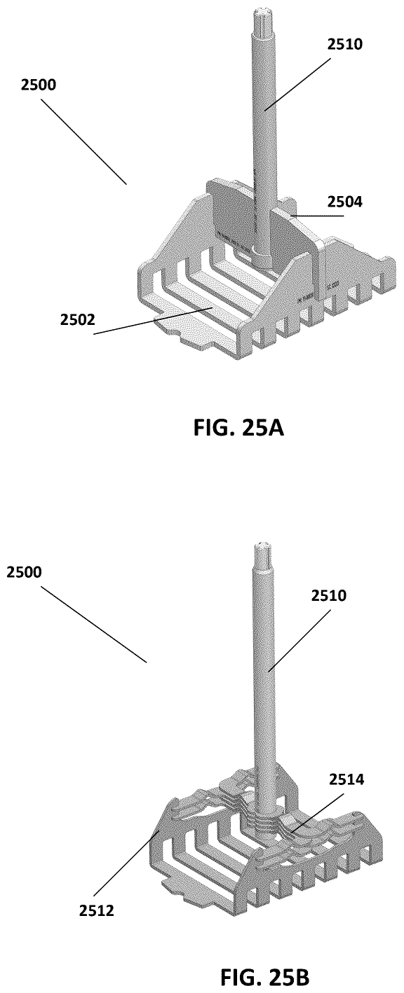

FIGS. 25A and 25B illustrate examples of bridge 2500 according to some embodiments of the present disclosure. The example of bridge 2500 illustrated in FIG. 25A is a rigidly fixed structure while the example of bridge 2500 in FIG. 25B is spring loaded to provide strain relief to the resulting battery as charge-discharge cycles of assembled cell train 2300 causes expansion and contraction of the structure. Further, in either examples of bridge 2500, the components can be adapted to allow for annular fill, as discussed below, or pressure blow-out in case of overpressure of the pressure vessel in which cell train 2300 is placed. Bridges 2302 and 2304 can each be a bridge 2500 as illustrated in FIGS. 25A and 25B. For example, both of bridges 2302 and 2304 can be an example of bridge 2500 as illustrated in FIG. 25A. In some examples, one or both of bridges 2302 and 2304 can be the example of bridge 2500 with strain relief as illustrated in FIG. 25B. Further, one of bridges 2302 and 2304 can be sized and configured to accommodate an annular fill and one of bridges 2302 and 2304 can be sized and configured to accommodate a pressure release.

In the example of bridge 2500 illustrated in FIG. 25A, bridge 2500 includes a base 2502, a crossbar 2504 engaging with base 2502, and a feedthrough 2510 that is mounted on crossbar 2504. In the example of bridge 2500 illustrated in FIG. 25B, feedthrough 2510 is mounted to a spring section 2514, which is mounted to a base 2512.

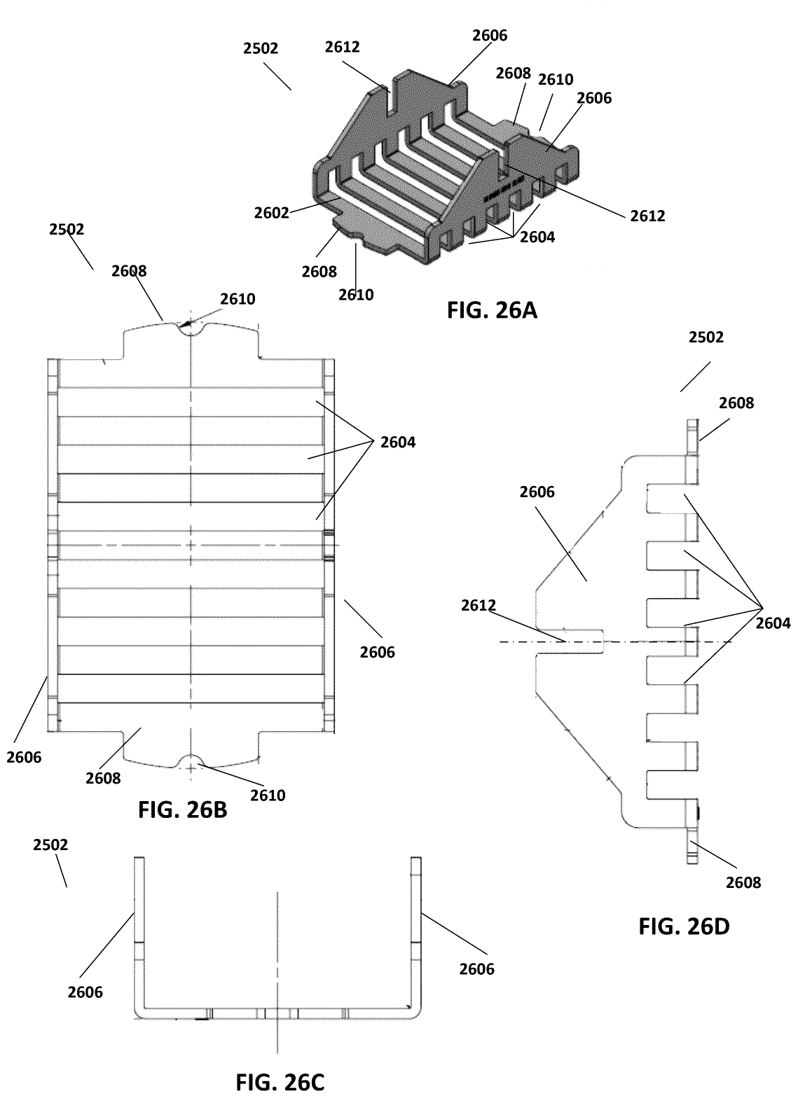

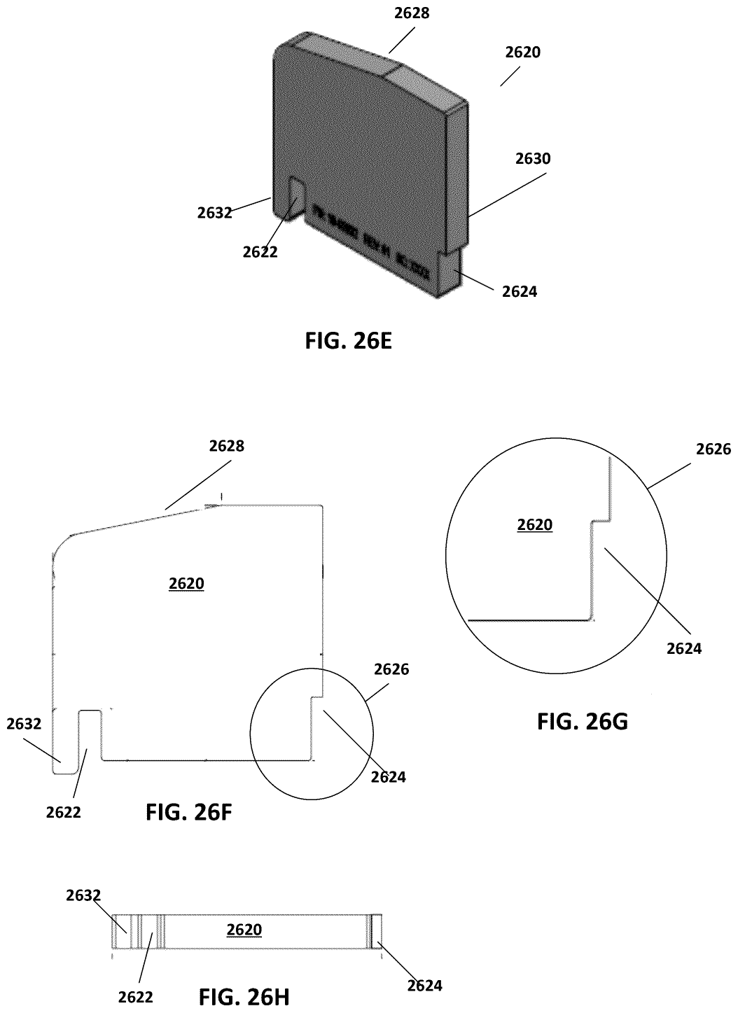

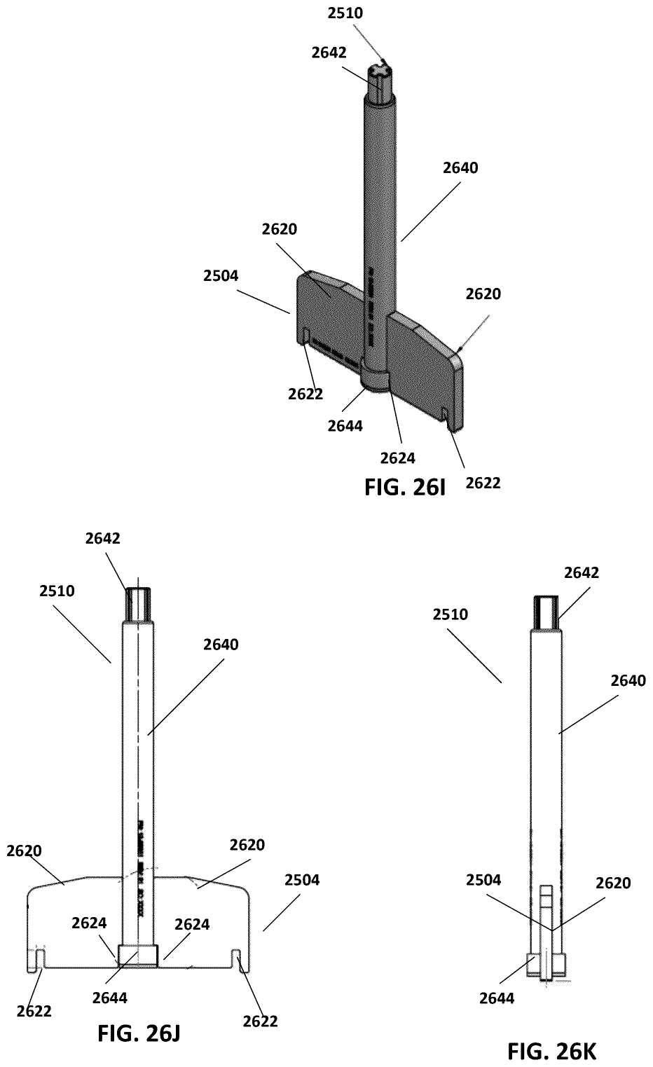

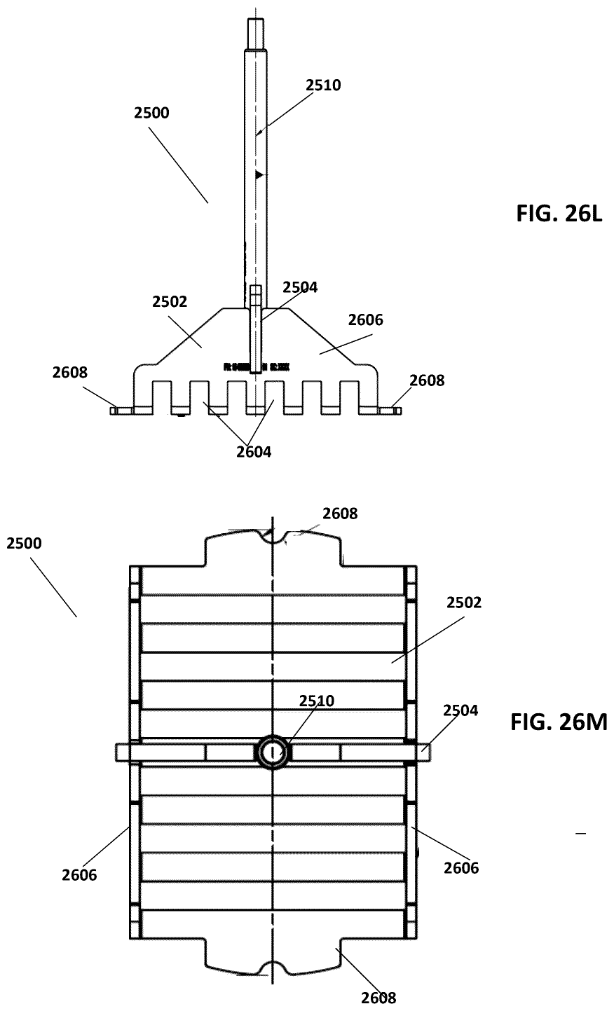

FIGS. 26A through 26M illustrate the components and construction of the example of bridge 2500 that is illustrated in FIG. 25A. FIGS. 26A through 26D illustrate an example of base 2502. FIGS. 26E through 26H illustrates an example of crossbar 2504. FIGS. 26I through 26K illustrates formation of crossbar 2504 with feedthrough 2510. FIGS. 26L and 26M illustrates attachment of crossbar 2504 and feedthrough 2510 with base 2502 to form this example of bridge 2500.

FIG. 26A illustrates an example of base 2502 of bridge 2500 as illustrated in FIG. 25A. As shown in FIG. 26A, base 2502 includes a support 2602 with two sidewalls 2606 attached to opposed sides of support 2602. Slots 2604 are formed in support 2602 and partially into sidewalls 2606. On the sides of support 2602 without sidewalls 2606, mounts 2608 are formed. Mounts 2608 includes an indent 2610. Mount 2608 and indent 2610 are configured to mechanically attach base 2502 with the ends of cell train 2200, for example with screws. Slots 2604 are configured to receive one or more tabs 2210 or 2212 as illustrated in FIG. 22A. In particular, slots 2604 receives one of tabs 2210 or tabs 2212 (depending on the side of cell train 2200 where bridge 2500 is being mounted). Each of slots 2604 can receive one or more individual tabs and the tabs are welded to support 2602 during the mounting process.

Sidewalls 2606 extend perpendicularly from support 2602 and in a direction away from cell train 2200 when bridge 2500 is mounted. Sidewalls 2606 include slots 1612 that receives crossbar 2504 as illustrated in FIG. 26A. In some embodiments, crossbar 2504 can be welded onto sidewalls 2606.

FIG. 26B illustrates a planar view of the example of base 2502 as illustrated in FIG. 26A. FIG. 26C illustrates a view along the edge of base 2502 as illustrated in FIG. 26A. FIG. 26D illustrates a view towards a sidewall 2606 of base 2502 as illustrated in FIG. 26A. The number of slots 2604 and the physical sizes of aspects of base 2502 are configured to cooperate with the dimensions of cell train 2200 and the number of tabs in cell train 2200. Base 2502 can be formed from a single piece of material of thickness sufficient to provide the appropriate stiffness. Base 2502 can be formed of any conducting material sufficient to conduct current into and out of cell train 2200. For example, base 2502 can be formed of stainless steel, carbon steel, or any other appropriate material.

FIGS. 26E through 26H illustrate a component 2620 of crossbar 2504 as illustrated in FIG. 25A. As is illustrated in FIG. 26E, component 2620 includes a slot 2622 that engages with slots 2612 of base 2502 as illustrated in FIG. 26A. Further, the edge adjacent to slot 2622 may be extended with a further tip 2632, allowing further structural support when engaged with slot 2612 of base 2502. Component 2620 can have a top edge that can be shaped to conserve material. An edge 2630 can be configured to engage with feedthrough 2510. Further, on edge 2630, a notch 2624 may be formed to conform with the shape of feedthrough 2510 and any protrusions such as burst disks or guards. FIG. 26F illustrates a planar view of component 2620 further illustrating slot 2622 and notch 2624. FIG. 26G indicates area 2626 and further illustrates slot 2624. It should be noted that notch 2626 is adapted to receive feedthrough 2510 and the dimensions (width and length) will vary depending on the characteristics of feedthrough 2510. In some embodiments, there is no need for a notch 2626. FIG. 26H illustrates an edge view of component 2620. Component 2620 can be formed of any conducting material that is sufficient to carry the current in cell train 2200 and provides sufficient stiffness for bridge 2500. In some embodiments, component 2620 can be formed of stainless steel, carbon steel, or any other appropriate material.

FIGS. 26I through 26K illustrate connecting components 2620 with feedthrough 2510 to form crossbar 2504. As illustrated in FIG. 26I, two of components 2620 are attached to feedthrough 2510 in opposing fashion so that slots 2622 on each of components 2620 will engage the corresponding slot 2612 of base 2502 to form crossbar 2504. As is clarified in FIG. 26I, feedthrough 2510 includes an inner conductor 2642 that is provided within a feedthrough sheath 2640. An end 2644 is then attached to sheath 2640 opposite exposure of internal conductor 2642. In some embodiments, end 2644 has a diameter greater than that of sheath 2640, however in some cases end 2640 may be of a diameter equal to or less than that of sheath 2640. Notch 2624 on each of components 2620 are arranged to accommodate end 2644 so that if the diameter of end 2644 is greater than that of sheath 2640, notch 2624 exists to accommodate. In some embodiments, components 2620 can be welded to sheath 2640 of feedthrough 2510. FIG. 26J illustrates a planar cross-sectional view of crossbar 2504 and feedthrough 2510 as illustrated in FIG. 26I. FIG. 26K illustrates an edge view of crossbar 2504 and feedthrough 2510 as illustrated in FIG. 26I.

FIGS. 26L and 26M illustrate assembly of the example of bridge 2500 illustrated in FIG. 25A. As illustrated, crossbar 2504, which is formed by welding components 2620 on either side of feedthrough 2510, is mounted on base 2502 such that slots 2622 of components 2620 are engaged with slots 2612 of base 2502 and welded into place. FIG. 26M illustrates a planar view of bridge 2500 as illustrated in FIG. 26L.

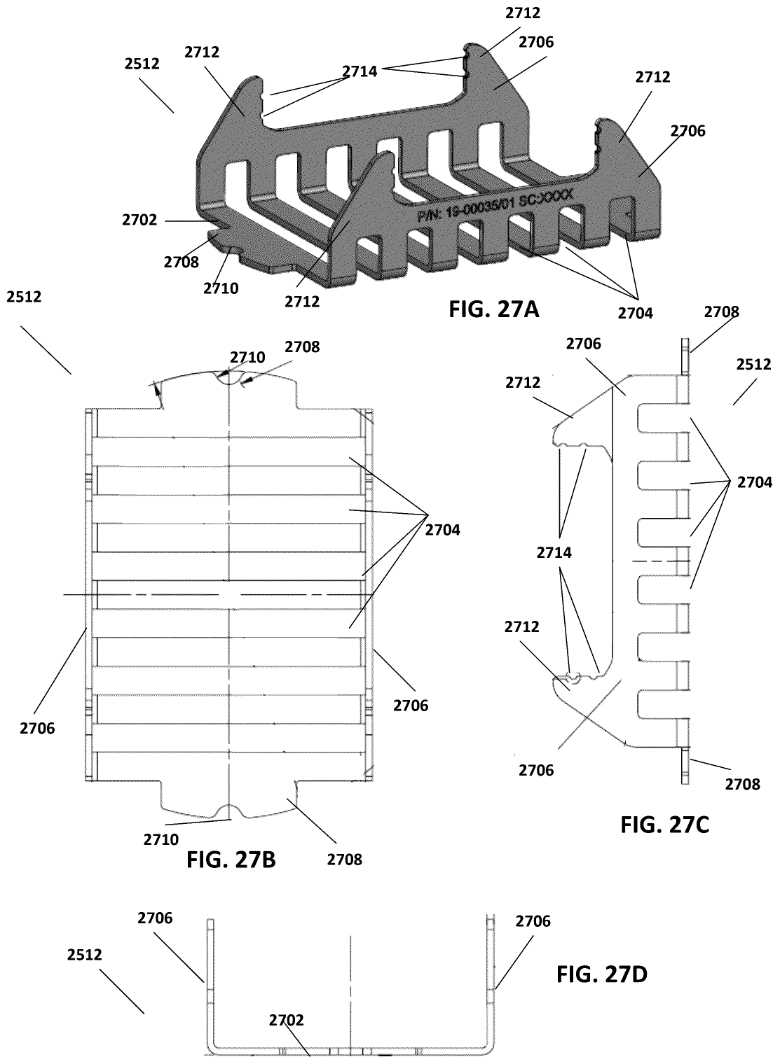

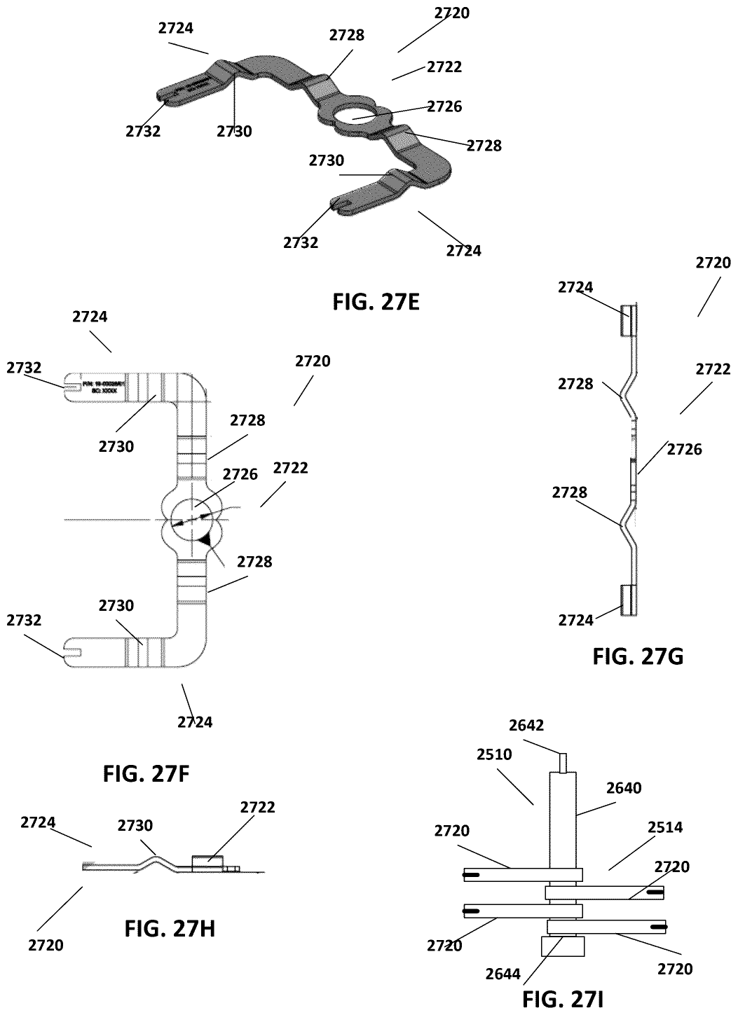

FIGS. 27A through 27I illustrates the example of bridge 2500 as illustrated with FIG. 25B. As illustrated in FIG. 25B, bridge 2500 can include a spring section 2514 that provides strain relief when cell train 2200 is mounted within a pressure vessel. As illustrated in FIG. 25B, bridge 2500 includes a base 2512 and a spring section 2514. Spring section 2514 is connected with feedthrough 2510 and connects feedthrough 2510 with base 2512. FIGS. 27A through 27D illustrates an example of base 2512 that is consistent with bridge 2500 as illustrated in FIG. 25B. FIGS. 27E through 27H illustrates a spring leaf 2720 while FIG. 27I illustrates formation of spring section 2514 with multiple ones of spring leaf 2720.

As shown in FIG. 27A, base 2512 includes a support 2702 with two sidewalls 2706 attached to opposed sides of support 2702. Slots 2704 are formed in support 2702 and partially into sidewalls 2706. On the sides of support 2702 without sidewalls 2706, mounts 2708 are formed. Mounts 2708 includes an access 2710. Mount 2708 and access 2710 are configured to mechanically attach base 2512 with the ends of cell train 2200, for example with screws or welding (e.g., to electrode tabs). Slots 2704 are configured to receive one or more tabs 2210 or 2212 as illustrated in FIG. 22A. In particular, slots 2704 receive one of tabs 2210 or tabs 2212 (depending on the side of cell train 2200 where bridge 2500 is being mounted). Each of slots 2704 can receive one or more individual tabs and the tabs are welded to support 2702 during the mounting process.

Sidewalls 2706 extend perpendicularly from support 2702 and in a direction away from cell train 2200 when bridge 2500 is mounted. Sidewalls 2706 include ears 2712 that form an opening. Inside the opening form by ears 2712 are structures 2714 that can receive spring section 2514. In some embodiments, spring section 2514 can be welded onto structures 2714.

FIG. 27B illustrates a planar view of base 2512 and provides further clarity to mounts 2708. FIG. 27C illustrates a side view of base 2512 and further illustrates the formation of slots 2704. FIG. 27D illustrates an end view of base 2512. Base 2512 can be formed in a single piece using a conducting material of sufficient strength, conductivity, and chemical resistance. For example, base 2512 can be formed of stainless steel, mild steel, or other conducting metallic material.

FIGS. 27E through 27H illustrate a spring leaf 2720 that can be used to form spring section 2514. Spring leaf 2720 is U shaped with two arms 2724 extending at a right angle from a central portion 2722. Central portion 2722 includes a hole 2726 in its center that is configured to receive feedthrough 2510. Consequently, the diameter of hole 2726 matches the cross-sectional diameter of feedthrough 2510. Additionally, a bent portion 2728 is formed on either side of hole 2726. As illustrated in FIG. 27G, which shows a side view of central portion 2722, bent portion 2728 is formed as a triangular section that aids in the spring action of spring leaf 2720. Each of arms 2724 also includes a triangular shaped bent portion 2730, as is further illustrated in the side view of FIG. 27H. Furthermore, as is illustrated in the planar view illustrated in FIG. 27F, the ends of arms 27624 include slots 2732 that are configured to engage with ears 2712 and structures 2714 of base 2512 as illustrated in FIGS. 27A and 27C.

As shown in FIG. 27I, spring section 2514 is formed from a number of opposing spring leafs 2720. As illustrated in FIG. 27I, spring leafs 2720 are arranged in opposition to one another (i.e. with arms 2724 directed in opposite directions). Feedthrough 2510 is inserted into hole 2726 of each spring leaf 2720 and welded in place. The number of pairs of spring leaf 2720 used to form spring section 2514 will determine the resulting spring constant of spring section 2514. As shown in FIG. 25B, slots 2732 of the pairs of spring leaf 2720 are then engaged with and welded to ears 2712 using structures 2714.

Feedthrough 2510 can take multiple forms and may have different functions. Assembled cell train 2200 includes two bridges 2302 and 2304 (one electrically coupled to all of the end anodes and one electrically coupled to all of the end cathodes), each with a feedthrough 2510. The two feedthroughs provide the primary function of electrically connecting assembled cell train 2300 outside of the pressure vessel in which it is housed. However, each of the feedthroughs 2510 may be sized and configured for secondary functions, which are further discussed below. As discussed above, bridge 2500 is tailored to accommodate the particular feedthrough 2510 that is being used. In some embodiments according to the present invention, assembled cell train 2300 includes a feedthrough 2510 configured to facilitate an annular fill and the other feedthrough 2510 is configured to accommodate a pressure burst. As discussed below, these two configurations, although structurally very similar, may have different diameters, may have different end units 2644, and the internal conductor may be configured differently. These features are further discussed below. In some embodiments, one of bridges 2302 or 2304 is configured to provide a pressure relief for over pressure while the other of bridges 2302 or 2304 is configured to allow for an annular fill. These two configurations have different dimensions and configurations.

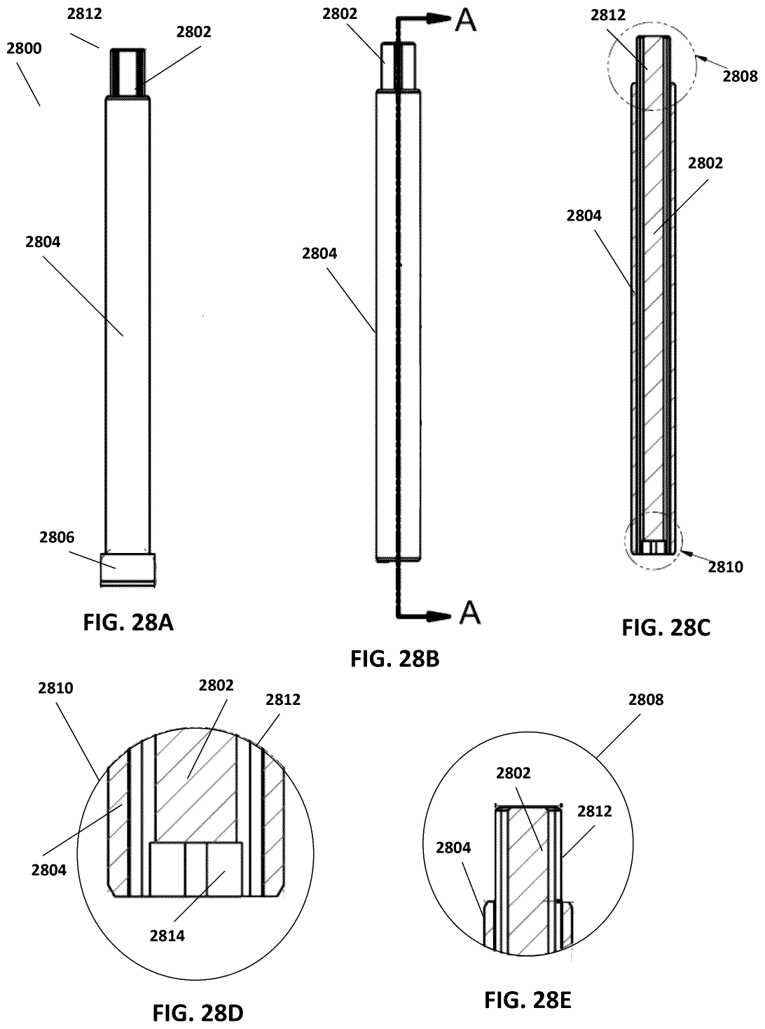

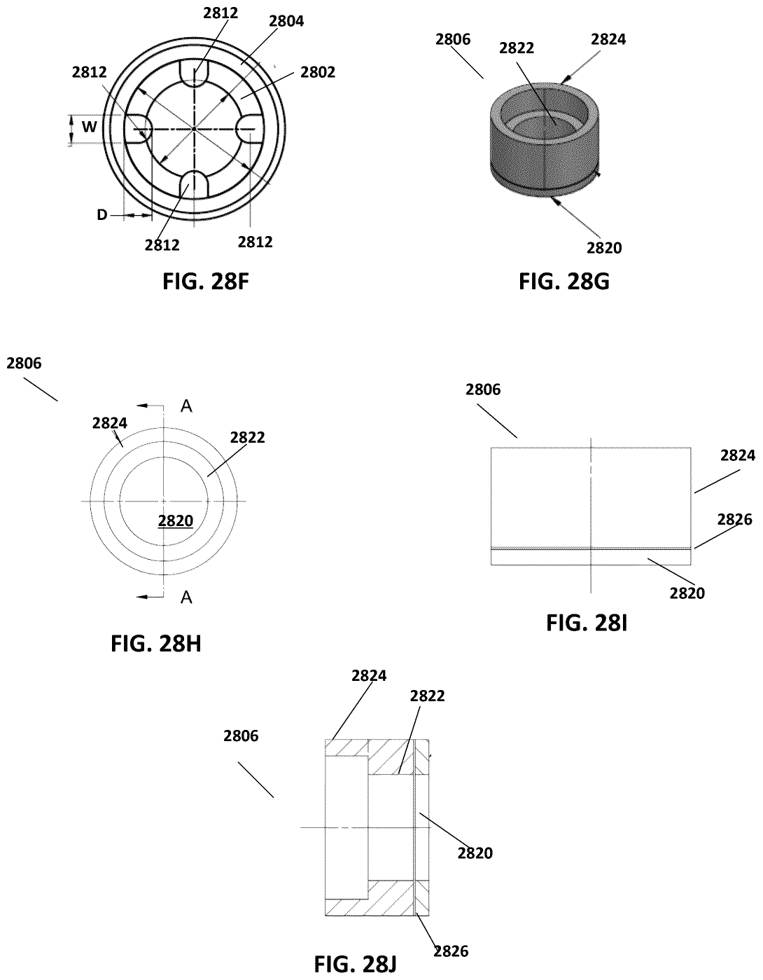

FIGS. 28A through 28J illustrates a feedthrough 2800 that can be used as feedthrough 2510 as illustrated in FIGS. 25A or 25B. Feedthrough 2800 provides a pressure burst function that, in the event that a pressure vessel becomes over pressured, allows for release of pressure. As illustrated in FIG. 28A, feedthrough 2800 includes a conductor 2802 extending through a cladding sheath 2804. A burst disk 2806 is fixed over the base of cladding sheath 2804. Conductor 2802 extends from sheath 2804 so that it is exposed to provide for electrical connection outside of a pressure vessel. Further, conductor 2802 includes grooves 2812 formed in its surface along its length to allow gas flow from burst disk 2806 along conductor 2802.

Conductor 2802 can be formed of any conductor, for example copper, while cladding sheath 2804 can be formed of another conductor, for example carbon steel. The outer diameter of conductor 2802 is arranged with respect to the inner diameter of cladding sheath such that, when combined, a tight seal is formed between conductor 2802 and cladding sheath 2804. In some embodiments, conductor 2802 can be combined with cladding sheath 2804 in a thermal process that heats cladding sheath 2804, cools conductor 2802, and inserts conductor 2802 through cladding sheath 2804. The resulting structure provides a tight fit between conductor 2802 and cladding sheath 2804 after the temperature equalizes. Cladding sheath 2804 also provides corrosion resistance to conductor 2802.

FIG. 28B illustrates the combined conductor 2802 and cladding sheath 2804. FIG. 28C illustrates a cross-sectional view along the A-A direction indicated in FIG. 28B. The cross-sectional view illustrated in FIG. 28C illustrates that conductor 2802 fills the interior of cladding sheath 2804, except for grooves 2812.

FIG. 28D further illustrates area 2810 illustrated in FIG. 28C, which is the base of the combined conductor 2802 and cladding sheath 2804 structure illustrated in FIG. 28B. As illustrated in FIG. 28D, a small chamber 2814 is formed when conductor 2802 does not extend completely to the bottom of cladding sheath 2804. Chamber 2814 accommodates burst disk 2806.

FIG. 28E illustrates area 2808 as illustrated in FIG. 28C. As illustrated in FIG. 28E, conductor 2802 extends through the top of cladding sheath 2804 to provide direct access to conductor 2802 when feedthrough 2800 extends through the pressure vessel.

FIG. 28F illustrates a view from the top of the combined cladding sheath 2804 and conductor 2802 structure as illustrated in FIG. 28B. As is further illustrated in FIGS. 28D and 28E, edges of cladding sheath 2804 can be beveled to reduce sharp edges. As is illustrated in FIG. 28f, grooves 2812 are formed into conductor 2802. There may be any number of grooves, which extend along the length of conductor 2802. In the example illustrated in FIG. 28F, there are four grooves 2812 each having a width W and depth D that are equally spaced around the circumference of conductor 2802.

FIG. 28G illustrates an example of burst disk 2806. As shown in FIG. 28A, burst disk 2806 is attached to the bottom of cladding sheath 2804 (i.e. the end of cladding sheath 2804 opposite where conductor 2802 is extended). As illustrated in FIG. 28G, burst disk 2806 is formed from a disk housing 2824, disk flange 2822, and a disk cap 2820. Disk housing 2824, disk flange 2822, and disk cap 2820 can be formed of any material, for example carbon steel.

FIG. 28H illustrates a top view of disk housing 2824. FIG. 28H also illustrates disk housing 2824, disk flange 2822 inserted within disk housing 2824. Disk cap 2820 is coupled with disk flange 2822 and disk housing 2824. FIG. 28I illustrates a side view of burst disk 2806 and, in particular, a weld 2826 between disk cap 2820 and disk housing 2824. FIG. 28J illustrates a cross-sectional view along the A-A direction as indicated in FIG. 28H. FIG. 28J further illustrates disk cap 2820 welded with weld 2826 to both disk flange 2822 and disk housing 2824. Disk cap 2820 is capable of bursting and allowing pressure through when the pressure differential across disk cap 2820 becomes above a threshold value.

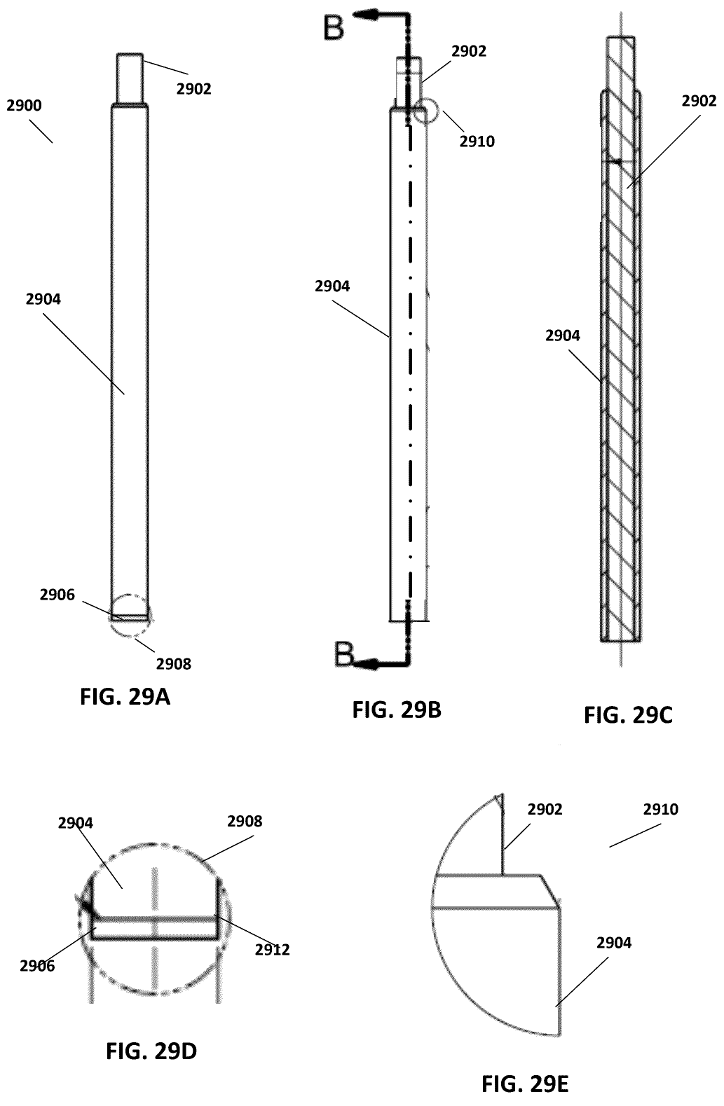

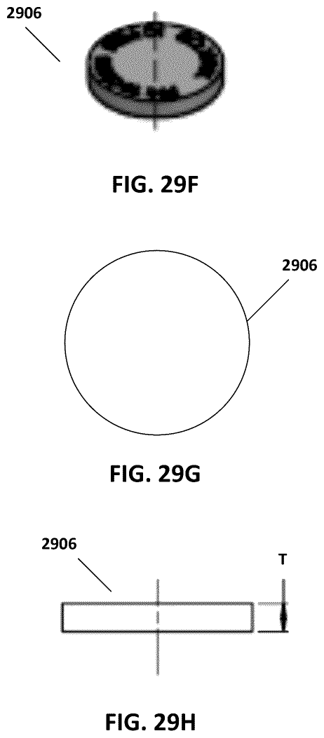

FIGS. 29A through 29H illustrates a feedthrough 2900 that can be used as feedthrough 2510 as illustrated in FIGS. 25A or 25B. As illustrated in FIG. 29A, feedthrough 2900 includes a conductor 2902 extending through a cladding sheath 2904. A feedthrough guard 2906 is fixed to the base of cladding sheath 2904. Conductor 2902 extends from sheath 2904 so that it is exposed to provide for electrical connection outside of the pressure vessel.

Conductor 2902 can be formed of any conductor, for example copper, while cladding sheath 2904 can be formed of another conductor, for example carbon steel. The outer diameter of conductor 2902 is arranged with respect to the inner diameter of cladding sheath 2904 such that, when combined, a tight seal is formed between conductor 2902 and cladding sheath 2904. In some embodiments, conductor 2902 can be combined with cladding sheath 2904 in a thermal process that heats cladding sheath 2904, cools conductor 2902, and inserts conductor 2902 through cladding sheath 2904. The resulting structure provides a tight fit between conductor 2902 and cladding sheath 2904 when the temperature equalizes.

FIG. 29B illustrates the combined conductor 2902 and cladding sheath 2904. FIG. 29C illustrates a cross-sectional view along the B-B direction indicated in FIG. 29B. The cross-sectional view illustrated in FIG. 29C illustrates that conductor 2902 fills the interior of cladding sheath 2904.

FIG. 29D illustrates the connection of feedthrough guard 2906 with cladding sheath 2904 in area 2908 as indicated in FIG. 29A. As illustrated, feedthrough guard 2906 can be welded at weld 2912 to cladding sheath 2904.

FIG. 29E illustrates area 2910, where conductor 2902 extends from cladding sheath 2904. As illustrated, the edges of cladding sheath 2904 can be beveled.

FIGS. 29F, 29G, and 29H illustrate feedthrough guard 2906. Feedthrough guard 2906 can be a disk of the same diameter as that of cladding sheath 2904. Feedthrough guard 2906 can be formed of an conducting material, for example carbon steel. In some embodiments, feedthrough guard 2906 can be a cup, in which case its diameter can be larger than that of cladding sheath 2904.

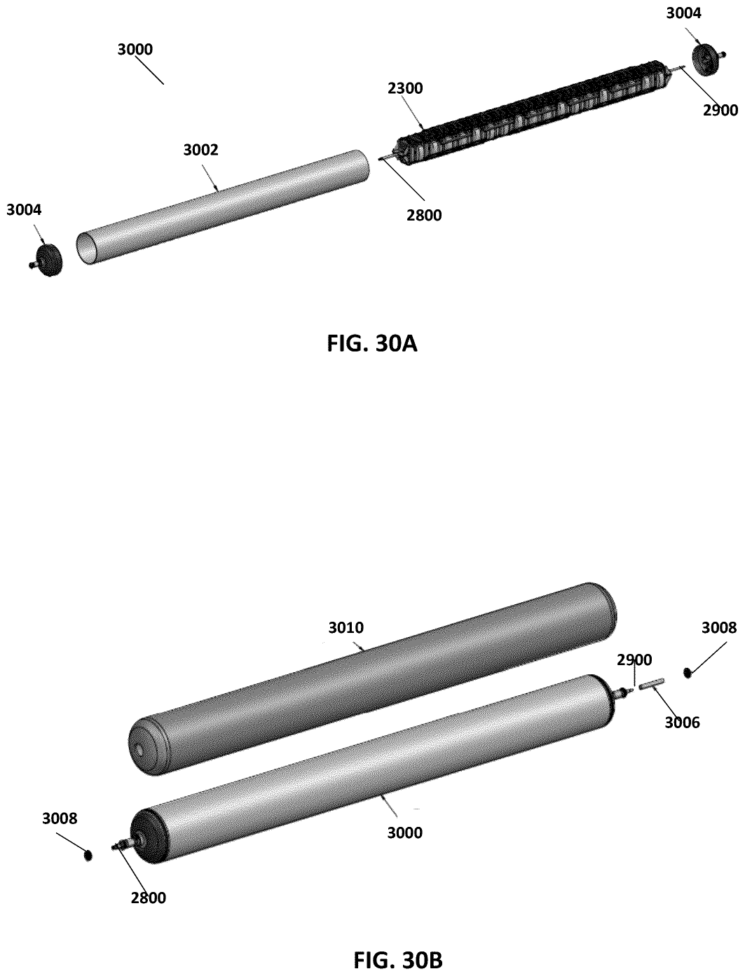

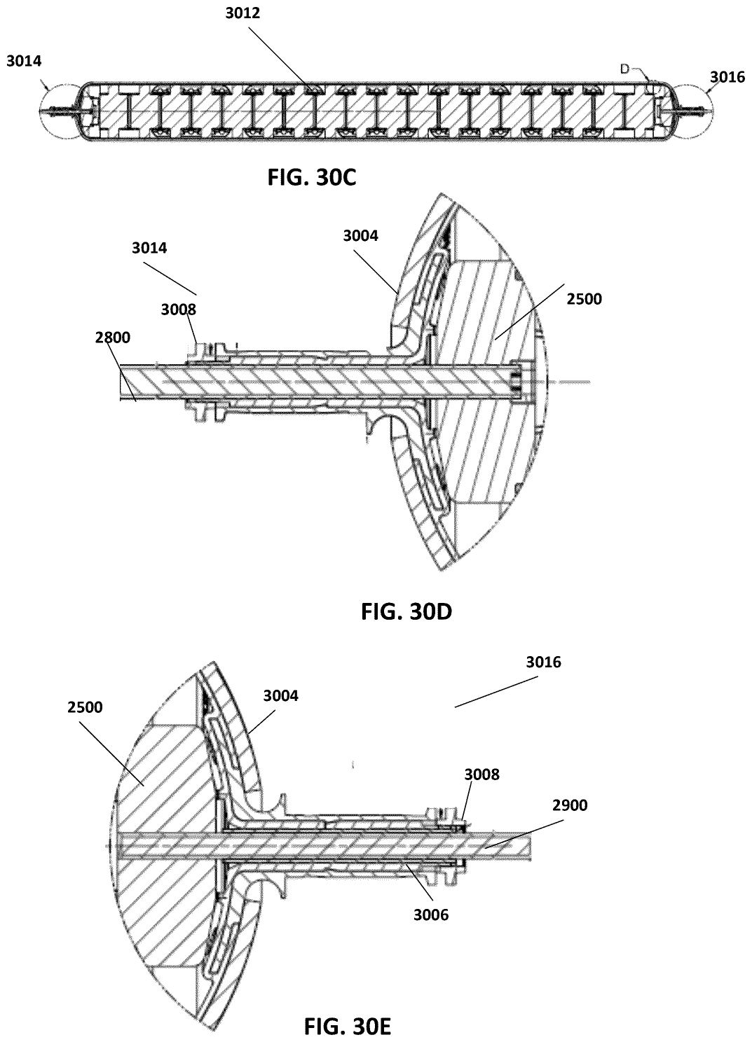

FIGS. 30A through 30E illustrates assembly of a battery structure according to some embodiments of the present disclosure. FIG. 30A illustrates assembly of a structure 3000. As shown in FIG. 30A, assembled cell train 2300 is inserted within a liner 3002. An end cap 3004 is inserted into liner on each side. As shown in FIG. 30A, cell train 2300 includes a feedthrough 2800 as illustrated in FIG. 28A on one side, for example the cathode side, and a feedthrough 2900 as illustrated in FIG. 29A on the opposite side, for example the anode side. End cap 3004 is inserted over feedthrough 2800 and another end cap 3004 is inserted over feedthrough 2900. End caps 3004 and assembled cell train 2300 can then be welded to liner 3002 to form structure 3000.

FIG. 30B illustrates the final assembly. Structure 3000 is wrapped with wrap 3010 and then structure 3000 is charged with electrolyte as has been discussed above. In some embodiments, wrap 3010 can be a composite material comprised of a matrix (resin) and fibers, for example fiberglass and epoxy or other such material.

As further show in FIG. 30B, a feedthrough fill sleeve 3006 is inserted over feedthrough 2900. As is further discussed below, the outer diameter of feedthrough 2900 is less than that of feedthrough 2800 but the end cap 3004 is the same on each side. Feedthrough fill sleeve 3006 is used so that the diameter of feedthrough 2900 and the outer diameter of feedthrough fill sleeve 3006 matches the diameter of feedthrough 2800. As is further illustrated, a feedthrough insulating ring 3008 is applied to each side. It should also be noted that a laser welding technique can be used to weld liner 3002 to assembled cell train 2300 and to both of caps 3004, which is discussed further below prior to the wrap 3010 and addition of electrolyte.

FIG. 30C illustrates the assembled battery structure 3012 absent wrap 3010. Area 3014 illustrated in FIG. 30C is illustrated in FIG. 30D while area 3016 is illustrated in FIG. 30E. As illustrated in FIG. 30D, feedthrough 2800 extends through cap 3004. Insulating ring 3008 is inserted over feedthrough 2800 and into end cap 3014. Bridge 2500 is also illustrated. Feedthrough 2800 is sealed against cap 3004, as is discussed in further detail below. Bridge 2500 is also illustrated in FIG. 30D, which may include strain relief as indicated in FIG. 25B. As discussed above, feedthrough 2800 provides a pressure relief function and may be coupled to the cathode side of assembled cell train 2300.

FIG. 30E illustrates area 3016 as indicated in FIG. 30C. As illustrated in FIG. 30E, feedthrough 2900 extends through cap 3004. A gap between feedthrough 2900 and cap 3004 allows for charging structure 3012 with electrolyte. After charging, feedthrough fill sleeve 3006 can be inserted between feedthrough 2900 and cap 3004, as is discussed below, and the combination can be sealed as discussed further below. Additionally, insulating ring 3008 is inserted over feedthrough 2900 and into cap 3004. Bridge 2500 is also illustrated in FIG. 30E, which may include strain relief as illustrated in FIG. 25B. Feedthrough 2900 may be coupled with the anode side of assembled cell train 2300.

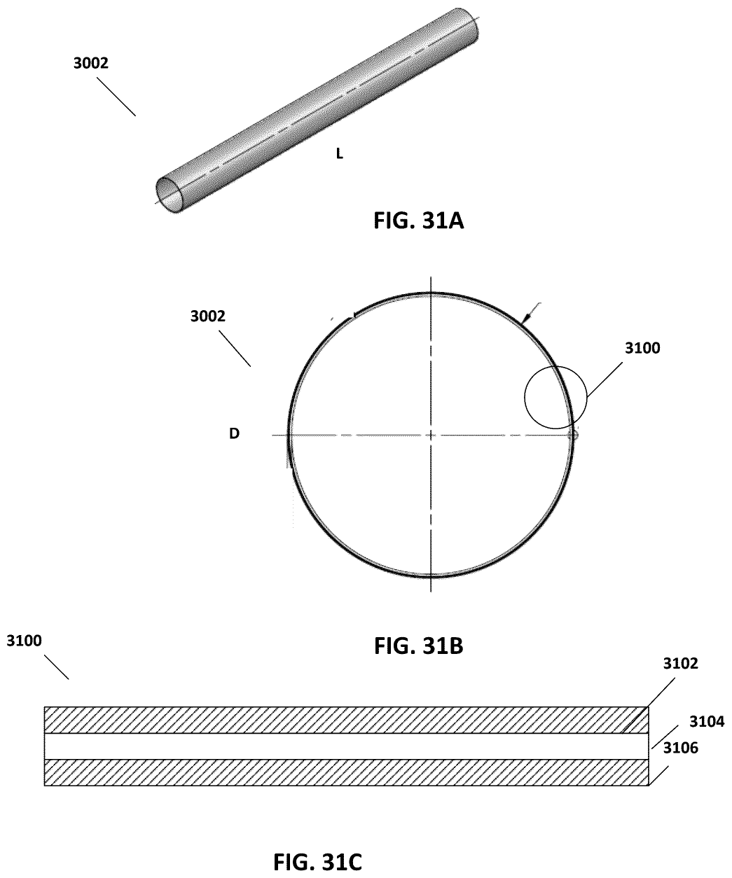

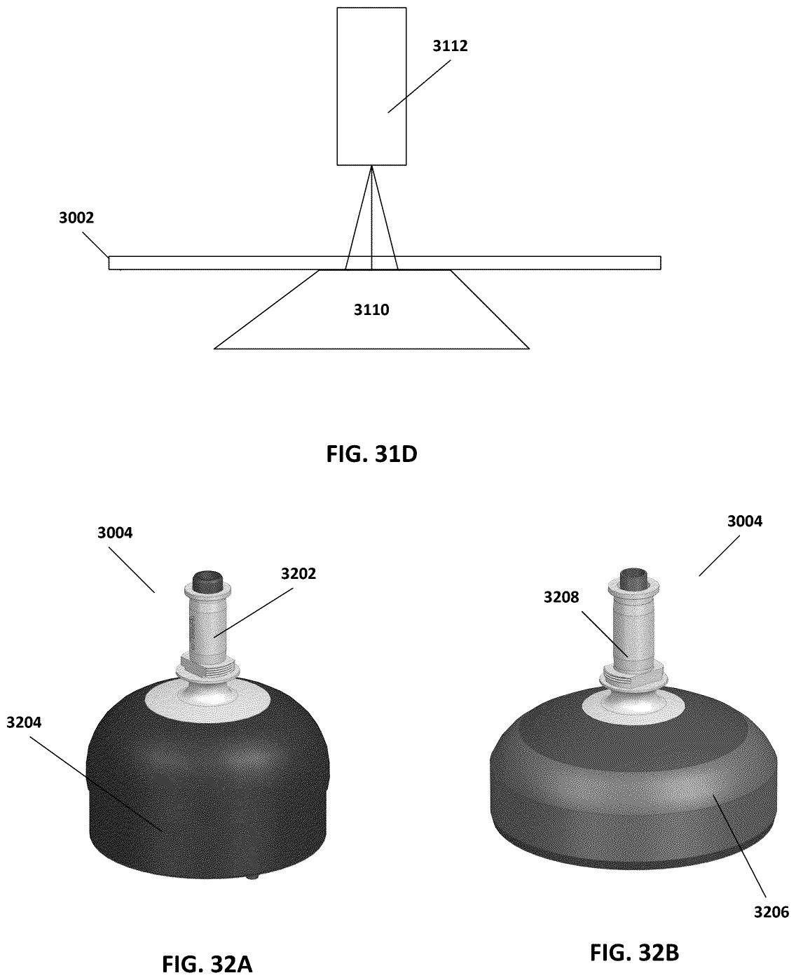

FIGS. 31A through 31D illustrate an example of liner 3002. As illustrated in FIG. 31A, liner 3002 is formed in a tube. FIG. 31B illustrates a cross sectional view of liner 3002. The inner diameter of liner 3002 is sufficient to receive assembled cell train 2300 and the diameter of end caps 3004. In particular, the diameters of cell train 2300, the inner diameter of liner 3002 and the outer diameter of end caps 3004 are configured so that end caps 3004 and assembled cell train 2300 tightly fit within liner 3002. Further, the length of liner 3002 can be arranged to extend beyond the length of construct 3012 during assembly.

Liner 3002 has the function of being as impervious to hydrogen transmission as possible. This characteristic can be achieved using a composite material structure as illustrated in FIG. 31C, which illustrates the area 3100 as illustrated in FIG. 31B. As illustrated in FIG. 31C, liner 3002 is formed from a layered material that includes an Ethylene Vinyl Alcohol (EVOH) layer 314 surrounded by polymer layers 3102 and 3106. Polymer layers 3102 and 3106 can be, for example, high-density polyethylene (HDPE) polyamide (PA), or polypropylene (PP). In one example, layers 3102 and 3106 can be HDPE. The EVOH 3104 provides a barrier to air, including hydrogen. Layers 3102, 3104, and 3106 are adhered to one another using an adhesive, or tie layer. The adhesive layers can, for example, be different grades of polyethylene, for example HDPE. Liner 3002.

FIG. 31D illustrates laser welding liner 3102 to structures such as end caps 3004 or the support structures of assembled cell train 2300. The HDPE that is used in the overmolding processes to form assembled cell train 2300 can be colored to absorb laser light from a laser 3112. The HDPE layers 3102 and the EVOH layers 3104 may be arranged to transmit the laser light from laser 3112. Consequently, liner 3002 can be laser welded to an underlining structure 3110 using laser light from laser 3112. In some examples, the HDPE used in assembled cell train 2300 is colored black while HDPE and EVOH layers in liner 3002 may be left natural (e.g. uncolored) to transmit the laser light.

FIGS. 32A and 32B illustrate examples of end caps 3004 according to some embodiments. FIG. 32A illustrated slip joint end cap 3004 onto which liner 3002 can be slipped into liner 3002 after liner 3002 has been appropriately trimmed and sized. As illustrated in FIG. 32A, end cap 3004 includes a barrel 3202 through which a feedthrough 2510 can be inserted and sealed. End cap 3004 further includes a base 3204 from which barrel 3202 extends that engages with liner 3002.

FIG. 32B illustrates an overmolded end cap 3004. Overmolded end cap 3004 as illustrated in FIG. 32B also includes a barrel 3208 and now integrally formed base 3206. Integrally formed base 3206 can be inserted fully into liner 3002, eliminating the need for pre-sizing of liner 3002. Further, overmolded end cap 3004 eliminates the clearance requirements resulting in the need to insulate barrel 3004 and its structure. Further, due to the overmolding process, the resulting feedthrough crimping to seal barrel 3208 against an inserted feedthrough 2510 is more reliable.

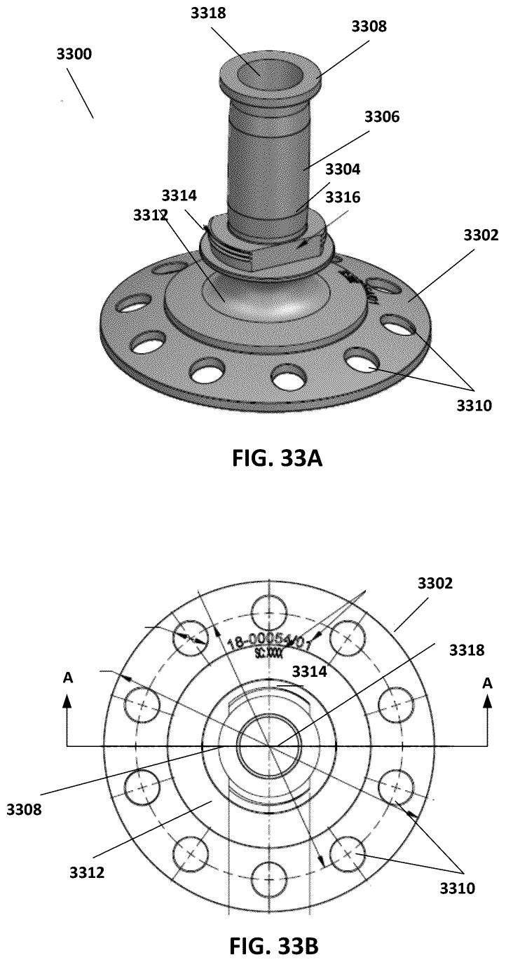

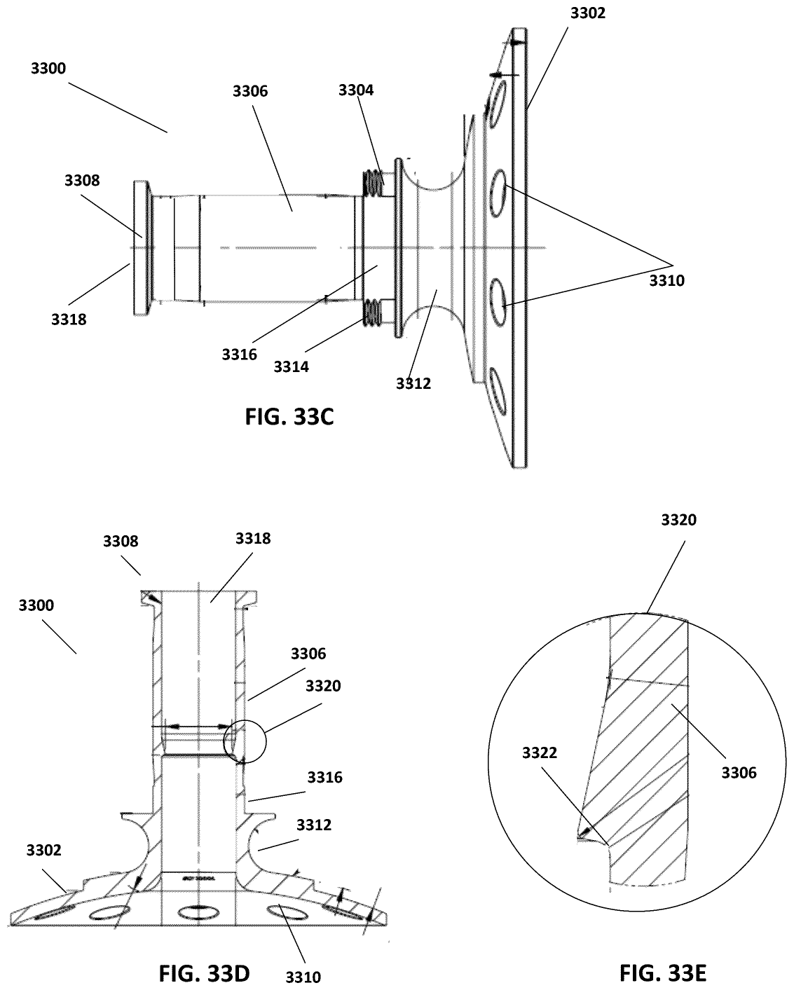

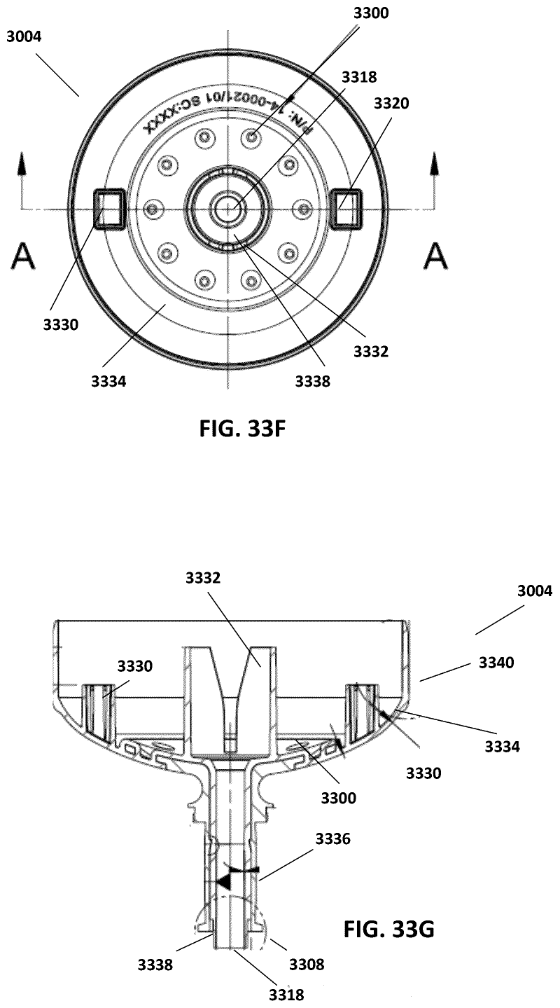

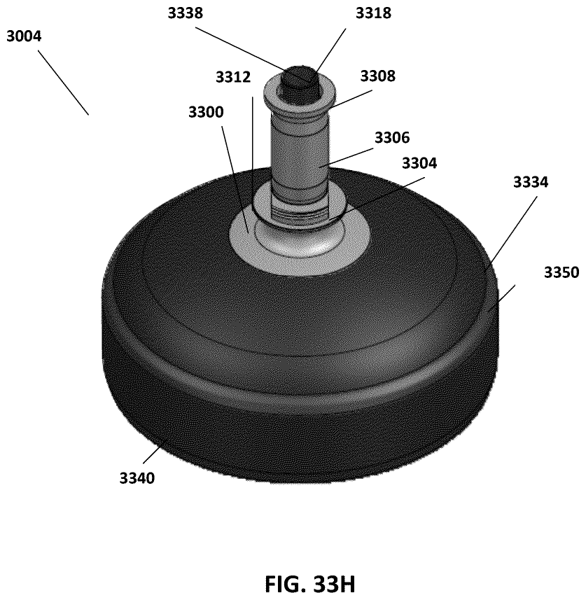

FIGS. 33A through 33H illustrate an example of the overmolded end cap 3004 as illustrated in FIG. 32B. FIG. 33A illustrates a polar boss 3300 according to some embodiments of the present disclosure. Polar boss 3300 can be formed from steel (e.g. SAE 1018) and may, in some cases, be plated with zinc or nickel. However, any material with sufficient strength can be used.

As illustrated in FIG. 33A, polar boss 3300 includes a base 3302, a chuck mount 3304, a barrel 3306, and a lip 3308 on top of barrel 3306. Base 3302 may be formed of a large diameter plate, which may have holes 3310 formed. A standoff 3312 may be formed between base 3310 and chuck mount 3304. Standoff 3312 also serves as a resin damn to protect mount 3302 from epoxy/resin during the winding process. Further, chuck mount 3304 may have a flat section 3316 and a threaded portion 3314 that allows for easy handling of polar boss 3300. Flat section 3316 may also be utilized to mount a strain gauge to monitor pressure in the pressure vessel. An opening 3318 extends through the center of polar boss (i.e. through barrel 3306 and out base 3302) through which a feedthrough 2510 can be extended.

FIG. 33B illustrates a view of polar boss 3300 looking into opening 3318 from the top of polar boss 3300. FIG. 33B further illustrates lip 3308, threaded portion 3314, standoff 3312, and base 3302 with holes 3310. FIG. 33C shows a side view of polar boss 3300, which also illustrates base 3302, holes 3310, standoff 3312, chuck mount 3304 with flat portion 3316 and threaded portion 3314, barrel 3306, lip 3308, and opening 3318.

FIG. 33D illustrates a cross-sectional view of polar boss 3300 along the direction A-A illustrated in FIG. 33B. FIG. 33D illustrates that opening 3318 extends through all of polar boss 3300. Lip 3308, barrel 3306, standoff 3312, and base 3302 are also illustrated in FIG. 33D. Further, a structure 3320 that is formed in barrel 3306 is also illustrated. Structure 3320 is further illustrated in FIG. 33E. As shown in FIG. 33E, a protrusion 3322 formed on the inner sidewall of barrel 3306 is formed. Protrusion 3322 will result, after overmolding, in a bump on the inner sidewall that can help prevent the downward flow of polymer during a crimping process to prevent delamination of the overmolded HDPE from the Polar Boss base 3302.

FIGS. 33F and 33G illustrate overmolding to form cap 3004 with polar boss 3300 as the substrate. In some embodiments, the overmolding can be HDPE and, as discussed above, can be black HDPE in order to facilitate laser welding as illustrated in FIG. 31D. In particular, the HDPE can include a carbon black or other additive of a specific weight percentage to facilitate laser welding and remain chemically compatible with the electrolyte.

FIG. 33F illustrates a view of the bottom of overmolded cap 3004. As is illustrated in FIG. 33F, overmolding 3318 can be provided inside of opening 3318. Further, overmolding can provide for sidewalls 3340 and 3334 that allow for cooperation with liner 3002. In some embodiments, there is a protrusion between sidewalls 3340 and 3334 which is trimmed away during a later operation, allowing for a smooth transition between liner 3002 and endcap 3004. Further, alignment structures 3330 can be formed. Structure 3332 can also be formed to help guide feedthrough 2510 through opening 3318. Additionally, structure 3336 that allows for containment of HDPE during the crimping process is also formed.

FIG. 33H illustrates the finished overmolded cap 3004 according to some embodiments of the present disclosure. As is illustrated in FIG. 33H, the overmolding 3350 leaves standoff 3312, barrel 3306, and lip 3308 exposed. Further, the overmolding 3338 is also provided in and extending from opening 3318. It should be noted that the diameter of opening 3318 is fixed. Consequently, as illustrated in FIG. 30B, the diameter of feedthrough 2800 and the combination of the diameters of feedthrough 2900 and fill sleeve 3006 are arranged to communicate with the diameter of opening 3318 and provide for a seal when barrel 3306 is crimped.

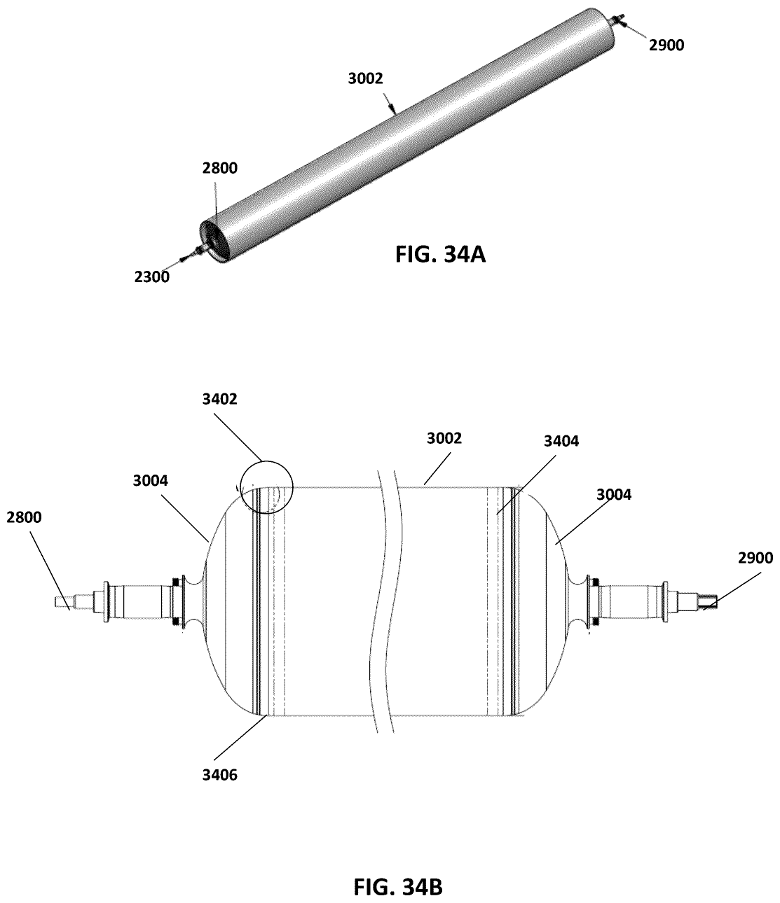

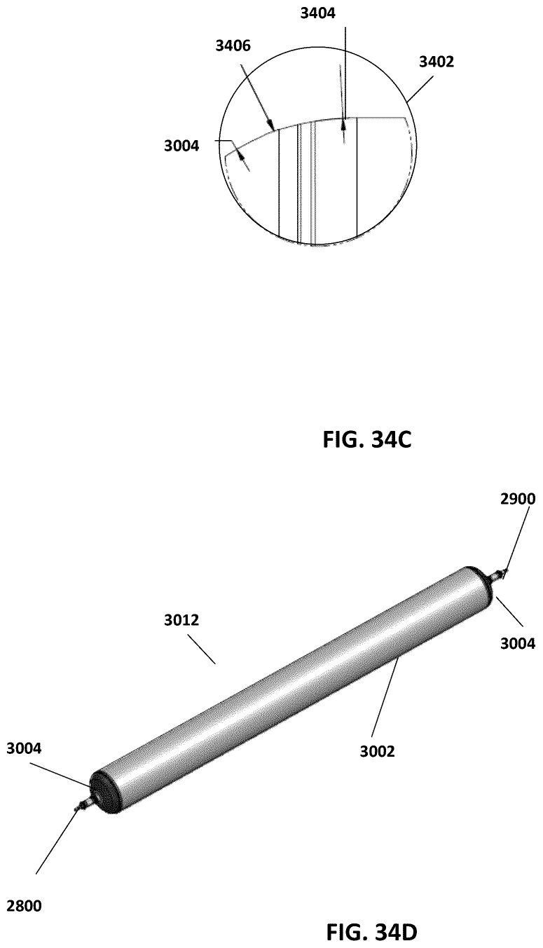

FIGS. 34A through 34D illustrates welding of liner 3002 to end caps 3004. As is illustrated in FIG. 34A, assembled cell train 2300 with caps 3400 are fully inserted into the tubular liner 3002. Feedthroughs 2800 and 2900 are extended through caps 3400 as is illustrated above. As is illustrated in FIG. 34B, weld 3404 is produced between liner 3002 and cap 3004. As is further illustrated in FIG. 34B, liner 3002 may be trimmed at trim 3406 to provide a clean surface to the resulting battery structure 3012 as illustrated in FIG. 34D. It should be noted that at this point welds to overmolded parts of assembled cell train 2300 may also be made at this stage of assembly.

FIG. 34C further illustrates area 3402 as indicated in FIG. 34A. FIG. 34C further illustrates the weld 3404 and trim 3406. As is further indicated in FIG. 30B, once the welding process is accomplished, battery structure 3012 as illustrated in FIG. 34D can be wrapped with structural wrap 3010 to complete the battery.

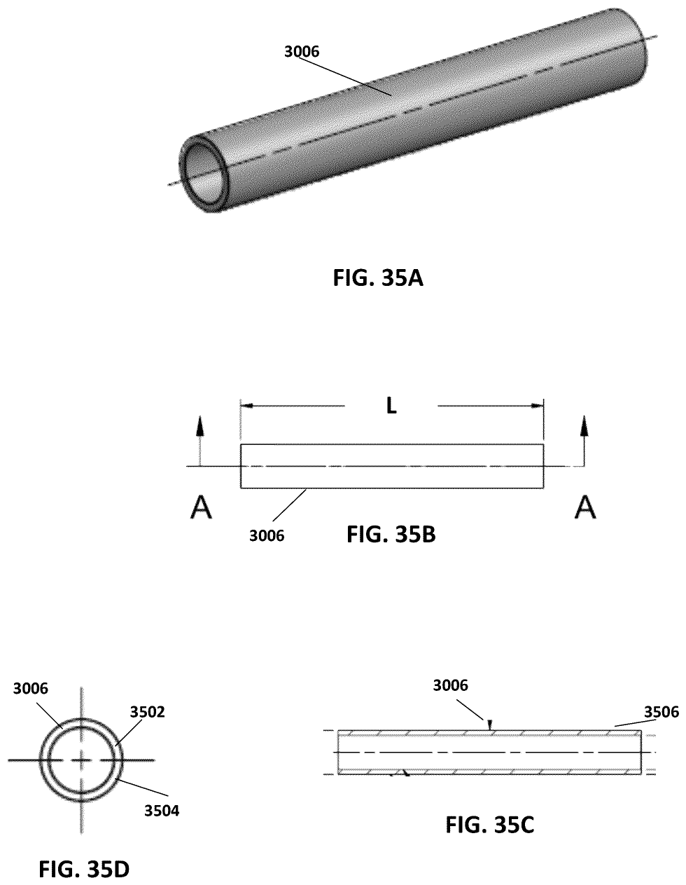

FIGS. 35A through 35D illustrate an example of feedthrough fill sleeve 3006 as illustrated in FIG. 30B. As was discussed above, feedthrough fill sleeve 3006 is inserted around feedthrough 2900 after battery structure 3012 has been charged with electrolyte through cap 3400 and around feedthrough 2900. Barrel portion 3306 can then be crimped around the combination of feedthrough fill sleeve 3006 and feedthrough 2900 to seal the battery structure 3012. Feedthrough fill sleeve 3006 can be formed of HDPE, for example.

As illustrated in the planar view illustrated in FIG. 35B, feedthrough fill sleeve 3006 has a length L. The length L of feedthrough fill sleeve 3006 is matched to the length of barrel portion 3306. FIG. 35C illustrates a cross section along the A-A direction and illustrates sidewall 3506 of feedthrough fill sleeve 3006. FIG. 35D illustrates a view along the length of feedthrough fill sleeve 3006 and indicates an inner diameter 3502 and outer diameter 3504. As discussed above, outer diameter 3504 is set to match the inner diameter of barrel portion 3306 of cap 3400. The inner diameter 3502 is set to match the outer diameter of feedthrough 2900. Consequently, when barrel portion 3306 is crimped, feedthrough 2900 is sealed.

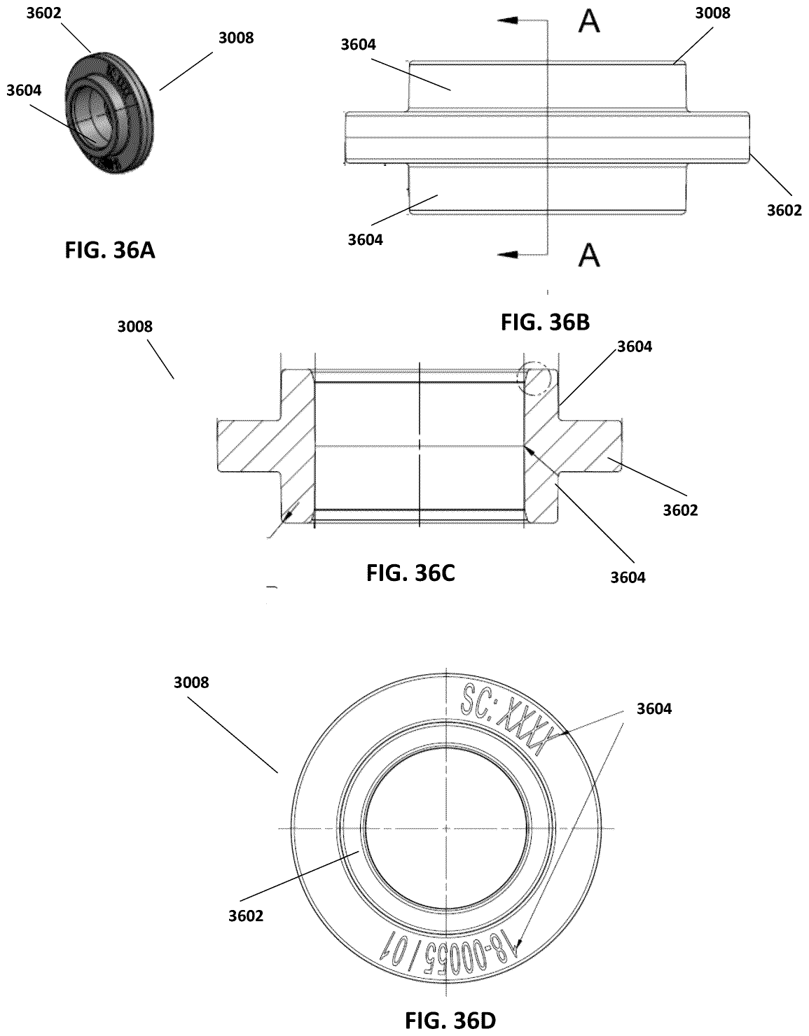

FIGS. 36A through 36D illustrates an example of feedthrough insulating ring 3008. Feedthrough insulating ring 3008 can insulate between feedthrough 2900 or feedthrough 2800 from cap 3400 as illustrated in FIG. 30B and can comply with a standard such as IEC 60644. Consequently, insulating ring 3008 can be formed of HDPE. As shown in FIG. 36A, HDPE includes a tubular portion 3604 and a lip portion 3602. The inner diameter of lip portion 3602 is sized to fit over the outer diameter of feedthrough 2800 or the outer diameter of feedthrough fill sleeve 3006. The outer diameter of feedthrough 2800 can be inserted into barrel portion 3306 of cap 3304 until lip 3602 fits against lip 3308 of cap 3304.

FIG. 36B illustrates a side view of feedthrough insulating ring 3008. Feedthrough illustrates tubular portion 3604 and lips 3602 as illustrated in FIG. 36A. FIG. 36C illustrates a cross-sectional view along the direction A-A as illustrated in FIG. 36B. As illustrated in FIG. 36B, tubular portion 3604 and lips 3602 are formed of a single, injection molded piece. FIG. 36D illustrates a planar view of feedthrough insulating ring 3008.

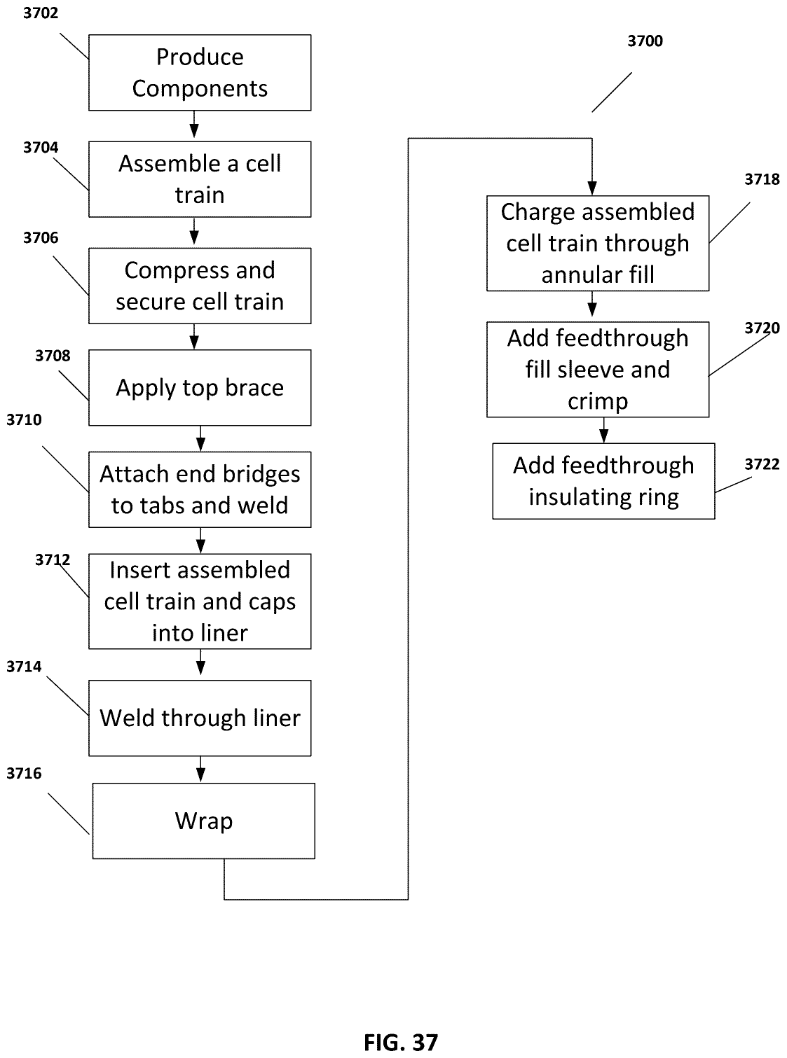

FIG. 37 illustrates a method 3700 for assembly of a battery using the components illustrated in FIGS. 12A to 36D according to some embodiments of the present disclosure. It should be understood that the order of steps presented in FIG. 37 can be performed in different orders.

Method 3700 beings at step 3702 with production and compilation of the components for producing the end battery. This includes the electrodes as described in FIGS. 12A through 14N, production of overmolded cell tray components as described in FIGS. 17A through 22F, production of split top braces 2310 as illustrated in FIGS. 24A through 24F, production of bridge components as described in FIGS. 25A through 29H, production of a liner as illustrated in FIGS. 31A through 31D, production of caps as described in FIGS. 32A through 33H, production of the feedthrough fill sleeve as illustrated in FIGS. 35A through 35C, and production of the feedthrough insulating ring as illustrated in FIGS. 36A through 36D.

In step 3704, the cell train 1600 is assembled as illustrated in FIGS. 15A through 16. In step 3706, cell train 1600 is compressed and secured with cell arms 2102 as is illustrated in FIGS. 22A through 22F to produce cell train 2200. In step 3708, top brace 2306 is attached as illustrated in FIG. 23B and in step 3710, end bridges are attached as illustrated in FIGS. 23A through 23E to produce assembled cell train 2300. In step 3712, assembled cell train 2300 with caps 3004 are inserted with liner 3002 as illustrated in FIGS. 34A through 34D. In step 3714, a laser welding process attaches liner 3002 to caps 3004 and welds to internal components of assembled cell train 2300 as illustrated in FIGS. 34A and 34C. In step 3716, the battery is wrapped with wrap 31010 as illustrated in FIG. 30B. In step 3718 assembled cell train 2300 while inside liner 3002 is charged with electrolyte and, in step 3720, feedthrough fill sleeve 3006 is inserted as illustrated in FIG. 30B and barrels 3208 are crimped to seal against feedthroughs 2510. In step 3722, feedthrough insulating ring 3008 is applied on each side and in step 3722.

For further clarity, the following aspects of embodiments of the present disclosure are provided. It should be understood that the invention should not be restricted according to these aspects, which are provided to further clarify these embodiments.

Aspect 1: A metal-hydrogen battery that comprises a bridgeless CPV superstack having a number K of units, each unit including a first layer and a second layer, wherein the first layer includes a number L/2 of intermediate anode-cathodes, and wherein the second layer includes an end anode and an end cathode separated by L/2−1 intermediate anode-cathodes; a pressure vessel that encloses the bridgeless CPV superstack; and electrolyte within the pressure vessel.

Aspect 2: The battery of Aspect 1, wherein each of the end anodes includes one or more layers of anode material that are connected with anode tabs.

Aspect 3: The battery of Aspects 1 or 2, wherein each of the end cathodes includes one or more layers of cathode material connected with cathode tabs and a separator material encasing the cathode material, with the separator material including wall wicks.

Aspect 4: The battery of any of Aspects 1-3, wherein each of the intermediate anode-cathodes includes an anode with one or more layers of anode material connected to one or more layers of cathode material by a metal sheet; and a separator material encasing the cathode material, with the separator material including wall wicks.

Aspect 5: The battery of any of Aspects 1-4, wherein the bridgeless CPV superstack further includes a first cell plate and a second cell plate, the first cell plate and the second cell plate on either side of the K units and connected by arms.

Aspect 6: The battery of Aspect 5, wherein the K units are compressed prior to connecting the first cell plate and the second cell plate with the arms.

Aspect 7: The battery of any of Aspects 1-6, wherein the end anodes include anode tabs and end cathodes includes cathode tabs, and further including an anode end bridge engaged with the anode tabs of each of the K units and a cathode end bridge engaged with the cathode tabs of each of the K units.

Aspect 8: The battery of Aspect 7, wherein each of the anode end bridge and the cathode end bridge includes a feedthrough conductor that extends through the pressure vessel.

Aspect 9: A method of providing a battery that comprise forming a bridgeless CPV superstack of K units by alternately stacking K first layers and K second layers each separated by a separator, wherein each first layer includes L/2 anode-cathode pairs and each second layer includes L/2−1 anode-cathode pairs, an end anode and an end cathode; enclosing the bridgeless CPV superstack into pressure vessel; and adding electrolyte into the pressure vessel.

Aspect 10: The method of Aspect 9, further including forming K end anodes, wherein each of the end anodes includes one or more layers of anode material connected with anode tabs.

Aspect 11: The method of any of Aspects 9-10, further including forming K end cathodes, wherein each of the end cathodes includes one or more layers of cathode material connected with cathode tabs and wherein a separator material encases the cathode material, with the separator material including wall wicks.

Aspect 12: The method of any of Aspects 9-11, further including forming K*(L−1) intermediate anode-cathodes, wherein each of the intermediate anode-cathodes includes an anode with one or more layers of anode material connected to one or more layers of cathode material by a metal sheet; and wherein a separator material encases the cathode material, with the separator material including wall wicks.

Aspect 13: The method of any of Aspects 9-12, wherein forming the stack of K units includes providing a first cell plate on which the K first layers and the K second layers are stacked; and providing and a second cell plate over the K first layers and the K second layers.

Aspect 14: The method of Aspect 13, wherein forming the stack of K units includes compressing between the first cell plate and the second cell plate; and connecting the first cell plate and the second cell plate with arms extending between the first cell plate and the second cell plate.

Aspect 15: The method of any of Aspects 12 or 13, wherein the K end anodes each includes anode tabs and the K end cathodes includes cathode tabs, and further includes engaging an anode end bridge with the anode tabs of each of the K units; and engaging a cathode end bridge engaged with the cathode tabs of each of the K units.

Aspect 16: The method of any of Aspects 12-15, wherein each of the anode end bridge and the cathode end bridge includes a feedthrough conductor that extends through the pressure vessel.

Aspect 17: A bridgeless CPV superstack that comprises K units, each unit including a first layer and a second layer, wherein the first layer includes a number L/2 of intermediate anode-cathodes, and wherein the second layer includes an end anode and an end cathode separated by L/2−1 intermediate anode-cathode.

Aspect 18: The bridgeless CPV superstack of Aspect 17, further including a first cell plate and a second cell plate separated by the K units.

Aspect 19: The bridgeless CPV superstack of Aspects 17 or 18, further including liners between the first cell plate and the K units and between the second cell plate and the K units.

Aspect 20: The bridgeless CPV superstack of any of Aspects 17-19, wherein the end anodes and the end cathodes each include tabs and further including a cathode end bridge coupled through tabs of the end cathodes and an anode end bridge coupled through tabs of the end anodes.

Aspect 21: A method of forming a bridgeless CPV superstack that comprises stacking K units, each unit including a first layer and a second layer, wherein the first layer includes a number L/2 of intermediate anode-cathodes, and wherein the second layer includes an end anode and an end cathode separated by L/2−1 intermediate anode-cathode.

Aspect 22: The method of Aspect 21, wherein stacking K units includes stacking the K units between a first cell plate and a second cell plate.

Aspect 23: The method of Aspect 21 or 22, further including providing liners between the first cell plate and the K units and between the second cell plate and the K units.

Aspect 24: The method of any of Aspects 21-23, wherein the end anodes and the end cathodes each include tabs and further including connecting a cathode end bridge through tabs of the end cathodes and connecting an anode end bridge through tabs of the end anodes.

Aspect 25: A metal-hydrogen battery that comprises an assembled cell train, the assembled cell train including an overmolded cell tray; a superstack having a number K of units, each unit including a first layer and a second layer, wherein the first layer includes a number L/2 of intermediate anode-cathodes, and wherein the second layer includes an end anode and an end cathode separated by L/2−1 intermediate anode-cathodes, and wherein each end cathode includes a cathode tab and each end anode includes an anode tab, the superstack being assembled on the overmolded cell tray; overmolded end plates separated by an overmolded cell plate being positioned over the superstack; and cell arms connecting the overmolded cell tray and the overmolded end plates and overmolded cell plate to compress the superstack; and a first bridge connected to all of the cathode tabs and a second bridge connected to all of the anode tabs.

Aspect 26: The battery of Aspect 25, wherein a separator is inserted between the end cathode and the anode of the intermediate anode-cathodes and between cathode material in the intermediate anode-cathodes and anode material.

Aspect 27: The battery of Aspect 25 or 26, wherein a first layer of separators is provided between the overmolded cell tray and the superstack and a second layer of separators is provided between the superstack and the overmolded end plates and overmolded cell plate.

Aspect 28: The battery of any of Aspects 25-27, wherein one or both of the first bridge and the second bridge includes a spring section to provide strain relief.

Aspect 29: The battery of any of Aspects 25-28, wherein the first bridge includes a burst pressure release feedthrough.

Aspect 30: The battery of any of Aspects 25-29, wherein the second bridge includes a fill feedthrough that allows for an annular fill.

Aspect 31: The battery of any of Aspects 25-30, further including a liner into which the assembled cell train is inserted.

Aspect 32: The battery of any of Aspects 25-31, wherein the liner is a tube that is formed of a material having a layer of Ethyl Vinyl Alcohol (EVOH) sandwiched between polymer layers of) that impedes the transport of hydrogen.

Aspect 33: The battery of any of Aspects 25-32, further including caps on each side of the assembled cell train, wherein the caps and the assembled cell train are laser welded to the liner.

Aspect 34: The battery of any of Aspects 25-33, further including an electrolyte that is applied through the annular fill.

Aspect 35: The battery of any of Aspects 25-34, further including a feedthrough fill sleeve applied over the fill feedthrough.

Aspect 36: The battery of any of Aspects 25-35, further including insulating rings.

Aspect 37: The battery of any of Aspects 25-36, further including a wrap around the liner and the caps.

Aspect 38: A method of producing a battery that comprises assembling components, the components including end anodes, end cathodes, intermediate anode-cathodes, overmolded cell tray, overmolded end plates, and overmolded cell plates; assembling a cell train, the cell train being formed by stacking the end anodes, the end cathodes, and the intermediate anode-cathodes on the overmolded cell tray to form a superstack having a number K of units, each unit including a first layer and a second layer, wherein the first layer includes a number L/2 of intermediate anode-cathodes, and wherein the second layer includes an end anode and an end cathode separated by L/2−1 intermediate anode-cathodes, and wherein each end cathode includes a cathode tab and each end anode includes an anode tab, the superstack being assembled on the overmolded cell tray, and placing overmolded end plates separated by an overmolded cell plate over the superstack; compressing the cell train and securing the overmolded cell tray to the overmolded end plates and overmolded cell plate with cell arms; applying a top brace to the cell train; applying bridges to the cell train to form an assembled cell train; inserting the assembled cell train with caps into a liner; welding the caps and the assembled cell train to the liner; wrapping over the liner and the caps; charging with electrolyte through an annular fill; adding a feedthrough fill sleeve; crimping feedthroughs on each of the bridges; and adding a feedthrough insulating ring.

Aspect 39: The method of Aspect 38, wherein the end cathodes and the cathodes of the intermediate anode-cathodes are separated from anode material with a separator.

Aspect 40: The method of Aspect 38 or 39, further including stacking a first layer of separators between the overmolded cell tray and the superstack and stacking a second layer of separators between the superstack and the overmolded end plates and overmolded cell plate.

Aspect 41: The method of any of Aspects 38-40, wherein the bridges includes a first bridge and a second bridge, wherein one or both of the first bridge and the second bridge includes a spring section to provide strain relief.

Aspect 42: The method of any of Aspects 38-41, wherein the bridges include a first bridge and a second bridge, and wherein the first bridge includes a burst pressure release feedthrough.

Aspect 43: The method of any of Aspects 38-42, wherein the second bridge includes a fill feedthrough that allows for an annular fill.

Aspect 40: The method of claim 38-43, wherein the liner is a tube that is formed of a material having a layer of Ethyl Vinyl Alcohol (EVOH) sandwiched between layers of polymer that impedes the transport of hydrogen.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

What is claimed is:

1. A metal-hydrogen battery, comprising:
a bridgeless CPV superstack having a number K of units, each unit including a first layer and a second layer, wherein the first layer includes a number L/2 of intermediate anode-cathodes, and wherein the second layer includes an end anode and an end cathode separated by L/2−1 intermediate anode-cathodes;
a pressure vessel that encloses the bridgeless CPV superstack; and
electrolyte within the pressure vessel.

2. The battery of claim 1, wherein each of the end anodes includes one or more layers of anode material that are connected with anode tabs.

3. The battery of claim 1, wherein each of the end cathodes includes one or more layers of cathode material connected with cathode tabs and a separator material encasing the cathode material, with the separator material including wall wicks.

4. The battery of claim 1, wherein each of the intermediate anode-cathodes includes an anode with one or more layers of anode material connected to one or more layers of cathode material by a metal sheet; and a separator material encasing the cathode material, with the separator material including wall wicks.

5. The battery of claim 1, wherein the bridgeless CPV superstack further includes a first cell plate and a second cell plate, the first cell plate and the second cell plate on either side of the K units and connected by arms.

6. The battery of claim 5, wherein the K units are compressed prior to connecting the first cell plate and the second cell plate with the arms.

7. The battery of claim 1, wherein the end anodes include anode tabs and end cathodes includes cathode tabs, and further including an anode end bridge engaged with the anode tabs of each of the K units and a cathode end bridge engaged with the cathode tabs of each of the K units.

8. The battery of claim 7, wherein each of the anode end bridge and the cathode end bridge includes a feedthrough conductor that extends through the pressure vessel.

9. A method of providing a battery, comprising:
forming a bridgeless CPV superstack of K units by alternately stacking K first layers and K second layers each separated by a separator, wherein each first layer includes L/2 anode-cathode pairs and each second layer includes L/2−1 anode-cathode pairs, an end anode and an end cathode;
enclosing the bridgeless CPV superstack into pressure vessel; and
adding electrolyte into the pressure vessel.

10. The method of claim 9, further including forming K end anodes, wherein each of the end anodes includes one or more layers of anode material connected with anode tabs.

11. The method of claim 9, further including forming K end cathodes, wherein each of the end cathodes includes one or more layers of cathode material connected with cathode tabs and wherein a separator material encases the cathode material, with the separator material including wall wicks.

12. The method of claim 9, further including forming K*(L−1) intermediate anode-cathodes, wherein each of the intermediate anode-cathodes includes an anode with one or more layers of anode material connected to one or more layers of cathode material by a metal sheet; and wherein a separator material encases the cathode material, with the separator material including wall wicks.

13. The method of claim 9, wherein forming the stack of K units includes
providing a first cell plate on which the K first layers and the K second layers are stacked; and
providing and a second cell plate over the K first layers and the K second layers.

14. The method of claim 13, wherein forming the stack of K units includes
compressing between the first cell plate and the second cell plate;
connecting the first cell plate and the second cell plate with arms extending between the first cell plate and the second cell plate.

15. The method of claim 14, wherein the K end anodes each includes anode tabs and the K end cathodes includes cathode tabs, and further includes
engaging an anode end bridge with the anode tabs of each of the K units;
and engaging a cathode end bridge engaged with the cathode tabs of each of the K units.

16. The method of claim 15, wherein each of the anode end bridge and the cathode end bridge includes a feedthrough conductor that extends through the pressure vessel.

17. A bridgeless CPV superstack, comprising:
K units, each unit including a first layer and a second layer, wherein the first layer includes a number L/2 of intermediate anode-cathodes, and wherein the second layer includes an end anode and an end cathode separated by L/2−1 intermediate anode-cathode.

18. The bridgeless CPV superstack of claim 17, further including a first cell plate and a second cell plate separated by the K units.

19. The bridgeless CPV superstack of claim 18, further including liners between the first cell plate and the K units and between the second cell plate and the K units.

20. The bridgeless CPV superstack of claim 18, wherein the end anodes and the end cathodes each include tabs and further including a cathode end bridge coupled through tabs of the end cathodes and an anode end bridge coupled through tabs of the end anodes.

21. A method of forming a bridgeless CPV superstack, comprising:
stacking K units, each unit including a first layer and a second layer, wherein the first layer includes a number L/2 of intermediate anode-cathodes, and wherein the second layer includes an end anode and an end cathode separated by L/2−1 intermediate anode-cathode.

22. The method of claim 21, wherein stacking K units includes stacking the K units between a first cell plate and a second cell plate.

23. The method of claim 22, further including providing liners between the first cell plate and the K units and between the second cell plate and the K units.

24. The method of claim 22, wherein the end anodes and the end cathodes each include tabs and further including connecting a cathode end bridge through tabs of the end cathodes and connecting an anode end bridge through tabs of the end anodes.

25. A metal-hydrogen battery, comprising:
an assembled cell train, the assembled cell train including
an overmolded cell tray;
a superstack having a number K of units, each unit including a first layer and a second layer, wherein the first layer includes a number L/2 of intermediate anode-cathodes, and wherein the second layer includes an end anode and an end cathode separated by L/2−1 intermediate anode-cathodes, and wherein each end cathode includes a cathode tab and each end anode includes an anode tab, the superstack being assembled on the overmolded cell tray;
overmolded end plates separated by an overmolded cell plate being positioned over the superstack; and
cell arms connecting the overmolded cell tray and the overmolded end plates and overmolded cell plate to compress the superstack; and
a first bridge connected to all of the cathode tabs and a second bridge connected to all of the anode tabs.

26. The battery of claim 25, wherein a separator is inserted between the end cathode and the anode of the intermediate anode-cathodes and between cathode material in the intermediate anode-cathodes and anode material.

27. The battery of claim 26, wherein a first layer of separators is provided between the overmolded cell tray and the superstack and a second layer of separators is provided between the superstack and the overmolded end plates and overmolded cell plate.

28. The battery of claim 25, wherein one or both of the first bridge and the second bridge includes a spring section to provide strain relief.

29. The battery of claim 25, wherein the first bridge includes a burst pressure release feedthrough.

30. The battery of claim 29, wherein the second bridge includes a fill feedthrough that allows for an annular fill.

31. The battery of claim 30, further including a liner into which the assembled cell train is inserted.

32. The battery of claim 31, wherein the liner is a tube that is formed of a material having a layer of Ethyl Vinyl Alcohol (EVOH) sandwiched between polymer layers of) that impedes the transport of hydrogen.

33. The battery of claim 32, further including caps on each side of the assembled cell train, wherein the caps and the assembled cell train are laser welded to the liner.

34. The battery of claim 32, further including an electrolyte that is applied through the annular fill.

35. The battery of claim 34, further including a feedthrough fill sleeve applied over the fill feedthrough.

36. The battery of claim 35, further including insulating rings.

37. The battery of claim 36, further including a wrap around the liner and the caps.

38. A method of producing a battery, comprising:
assembling components, the components including end anodes, end cathodes, intermediate anode-cathodes, overmolded cell tray, overmolded end plates, and overmolded cell plates;
assembling a cell train, the cell train being formed by stacking the end anodes, the end cathodes, and the intermediate anode-cathodes on the overmolded cell tray to form a superstack having a number K of units, each unit including a first layer and a second layer, wherein the first layer includes a number L/2 of intermediate anode-cathodes, and wherein the second layer includes an end anode and an end cathode separated by L/2−1 intermediate anode-cathodes, and wherein each end cathode includes a cathode tab and each end anode includes an anode tab, the superstack being assembled on the overmolded cell tray, and placing overmolded end plates separated by an overmolded cell plate over the superstack;
compressing the cell train and securing the overmolded cell tray to the overmolded end plates and overmolded cell plate with cell arms;
applying a top brace to the cell train;
applying bridges to the cell train to form an assembled cell train;
inserting the assembled cell train with caps into a liner;
welding the caps and the assembled cell train to the liner;
wrapping over the liner and the caps;
charging with electrolyte through an annular fill;
adding a feedthrough fill sleeve;
crimping feedthroughs on each of the bridges; and
adding a feedthrough insulating ring.

39. The method of claim 38, wherein the end cathodes and the cathodes of the intermediate anode-cathodes are separated from anode material with a separator.

40. The method of claim 38, further including stacking a first layer of separators between the overmolded cell tray and the superstack and stacking a second layer of separators between the superstack and the overmolded end plates and overmolded cell plate.

41. The method of claim 38, wherein the bridges includes a first bridge and a second bridge, wherein one or both of the first bridge and the second bridge includes a spring section to provide strain relief.

42. The method of claim 38, wherein the bridges include a first bridge and a second bridge, and wherein the first bridge includes a burst pressure release feedthrough.

43. The method of claim 42, wherein the second bridge includes a fill feedthrough that allows for an annular fill.

44. The method of claim 38, wherein the liner is a tube that is formed of a material having a layer of Ethyl Vinyl Alcohol (EVOH) sandwiched between layers of polymer that impedes the transport of hydrogen.
